(19) United States
(12) Patent Application Publication
(10) Pub. No.: US 2011/0212430 A1
(43) Pub. Date: Sep. 1, 2011

(54) TEACHING AND LEARNING SYSTEM

(76) Inventors: Donald E. Smithmier, Minneapolis, MN (US); Andrew J. Meyer, Plymouth, MN (US); Erik C. Jordan, Saint Paul, MN (US); Steve M. Anastasi, Lino Lakes, MN (US); Michael D. Selinker, Renton, WA (US); Anne Teeuwynn Woodruff, Sammamish, WA (US); Mark C. Flannery, Plymouth, MN (US)

(21) Appl. No.: 12/875,023

(22) Filed: Sep. 2, 2010

Related U.S. Application Data
(60) Provisional application No. 61/314,480, filed on Mar. 16, 2010.
(60) Provisional application No. 61/239,357, filed on Sep. 2, 2009.

(51) Int. Cl. G09B 5/00

(52) U.S. Cl. 434/322

(57) ABSTRACT

A teaching and learning system includes a data store and a server computing device. The server computing device is programmed to retrieve digital data from the data store and to generate and transfer digital data across a network to user computing devices associated with users. The digital data is configured to be interpreted by the user computing devices to display to the users an interactive web site, the web site including a plurality of learning packets. Each learning packet includes a title and multiple content sections. The title includes a text description of a topic associated with an academic topic. The multiple content sections include at least one content window, where each content window includes content having a content type selected by the author of the learning packet from a plurality of different available content types. The content of each content section includes information to teach the user about the topic identified in the title.

### CROSS REFERENCE TO RELATED APPLICATIONS

This application claims priority to U.S. Provisional Application No. 61/239,357, filed on Sep. 2, 2009, and entitled PEER TO PEER TEACHING AND LEARNING SYSTEM, and to U.S. Provisional Application No. 61/314,480, filed on Mar. 16, 2010, and entitled TEACHING AND LEARNING SYSTEM, the disclosures of which are incorporated by reference herein in their entireties.

### BACKGROUND

Education relating to academic topics is commonly provided through formal learning centered around traditional academic institutions. In an academic institution, a teacher or professor who has been formally educated in the particular topic is often assigned to educate a group of students who are interested in learning more about the topic. Formal learning, however, has various limitations, such as the limitation on the amount of time that a single teacher or professor can dedicate to training individual students. In addition, formal learning is often limited to traditional media, such as through formal lectures and written textbooks.

### SUMMARY

In general terms, the present disclosure is directed to a teaching and learning system for educating users on a variety of academic topics. Various aspects are described in this disclosure, which include, but are not limited to, the following aspects.

One aspect is a teaching and learning system including a data store and a server computing device. The data store encodes data therein. The server computing device is programmed to retrieve digital data from the data store and to generate and transfer digital data across a network to user computing devices associated with users, wherein the digital data is configured to be interpreted by the user computing devices to display to the users an interactive web site. The web site includes a plurality of learning packets, which are each authored by one or more of the users. The learning packets further include a title and multiple content sections. The title includes a text description of a topic, the topic being associated with an academic topic. Each of the multiple content sections include at least one content window and each content window includes content having a content type. The content type is selected by the author of the learning packet from a plurality of different available content types, wherein the content of each content section includes information to teach the user about the topic identified in the title.

Yet another aspect is a method of providing information to a third party educational system, the method comprising: storing units of information in computer readable storage media with a computing device, each unit of information being associated with different academic topics; associating at least some of the units of information with a course at an educational institution; receiving a request from a third party educational system, the request identifying the course; and sending data with the computing device, the data identifying at least some of the units of information that are associated with the course to the third party educational system for display of the data within the third party educational system.

A further aspect is a method of alerting a user of a teaching and learning system to the occurrence of an event, the teaching and learning system including information relating to a plurality of academic topics to educate consumers on the academic topics, the method comprising: generating and storing a subscription list for the user in computer readable storage media with a computing device, the subscription list including a plurality of items, each item identifying at least one of: a learning packet, a portion of a learning packet, and another user of the teaching and learning system; and upon occurrence of an event within the teaching and learning system, sending a notification with the computing device, the notification including information describing the event and including a link to at least one of the learning packet and a user profile.

Another aspect is a computer readable storage medium containing data defining a user interface, wherein when the data is interpreted with a processing device, the data causes the processing device to generate the user interface on a display device to educate a consumer on an academic topic, the user interface comprising: a first section including a first content window and a first discourse window, the first content window including a first content element provided by at least one author and relating to the academic topic, the first discourse window configured to receive and display first discourse elements relating to the first content element when the first discourse elements are provided by any one or more of the author, the consumer, and another consumer; and a second section including a second content window and a second discourse window, the second content window including a second content element provided by the at least one author and relating to the academic topic, the second discourse window configured to receive and display second discourse elements relating to the second content element when the second discourse elements are provided by any one or more of the author, the consumer, and another consumer.

A further aspect is a method of rewarding users for use of a teaching and learning system, the method comprising: storing a point value in computer readable storage media with a computing device, the point value being associated with a user; receiving input from the user to generate a learning packet, the learning packet including information relating to an academic topic to teach a consumer about the academic topic; and upon completion of generating the learning packet, increasing the point value associated with the user in the computer readable storage media with the computing device.

Another aspect is a method of performing a search for information relating to an academic topic, the method comprising: receiving a search query with a computing device, the search query including one or more search terms; determining whether each of the one or more search terms are in a predetermined set of terms; and if each of the one or more search terms is in the predetermined set of terms, executing the search query to identify and provide relevant search results with the computing device.

### BRIEF DESCRIPTION OF THE DRAWINGS

FIG. 1 is a block diagram of an example teaching and learning system.

FIG. 2 is a schematic block diagram illustrating an architecture of an example computing device of the learning system shown in FIG. 1.

FIG. 3 is a schematic block diagram of an example learning system server of the learning system shown in FIG. 1.

FIG. 4 is a schematic block diagram of an example data store of the learning system shown in FIG. 1.

FIG. 5 is a schematic block diagram of an example learning packet of the learning system shown in FIG. 1.

FIG. 6 is a screenshot of an example dashboard page of the learning system shown in FIG. 1.

FIG. 7 is a screenshot of an example packets page of the learning system shown in FIG. 1.

FIG. 8 is a screenshot of another example packets page.

FIG. 9 is a screenshot of an example collections page of the learning system shown in FIG. 1.

FIG. 10 is a screenshot of an example settings page of the learning system shown in FIG. 1.

FIG. 11 is another screenshot of the example settings page shown in FIG. 10.

FIG. 12 is another screenshot of the example settings page shown in FIG. 10.

FIG. 13 is a screenshot of an example public profile page of the learning system shown in FIG. 1.

FIG. 14 is a screenshot of an example learning packet editor page of the learning system shown in FIG. 1.

FIG. 15 is another screenshot of the example learning packet editor page shown in FIG. 14.

FIG. 16 is another screenshot of the example learning packet editor page shown in FIG. 14.

FIG. 17 is another screenshot of the example learning packet editor page shown in FIG. 14.

FIG. 18 is another screenshot of the example learning packet editor page shown in FIG. 14.

FIG. 19 is another screenshot of the example learning packet editor page shown in FIG. 14.

FIG. 20A is a first portion of a screenshot of an example author's public view page of the learning system shown in FIG. 1.

FIG. 20B is a second portion of the screenshot shown in FIG. 20A.

FIG. 21A is a first portion of a screenshot of an example consumer public view page of the learning system shown in FIG. 1.

FIG. 21B is a second portion of the screenshot shown in FIG. 21A.

FIG. 22A is a first portion of another screenshot of the consumer public view page shown in FIG. 21, and further illustrating an example collections window.

FIG. 22B is a second portion of the screenshot shown in FIG. 22A.

FIG. 23 is a screenshot of an example collections page of the learning system shown in FIG. 1.

FIG. 24A is a first portion of another screenshot of the consumer public view page shown in FIGS. 21A and 21B, and further illustrating an example feedback window.

FIG. 24B is a second portion of the screenshot shown in FIG. 24A.

FIG. 25A is a first portion of another screenshot of the consumer public view page shown in FIGS. 21A and 21B, and further illustrating an example search results window.

FIG. 25B is a second portion of the screenshot shown in FIG. 25A.

FIG. 26 is a screenshot of an example search results page of the learning system shown in FIG. 1.

FIG. 27 is a screenshot of the consumer public view page shown in FIGS. 21A and 21B, and further illustrating an example media bucket window.

FIG. 28 is a screenshot of the example media bucket window shown in FIG. 27.

FIG. 29 is a screenshot of an example login page of the learning system shown in FIG. 1.

FIG. 30 is a screenshot of an example search page of the learning system shown in FIG. 1.

FIG. 31 is a screenshot of an example search results page of the learning system shown in FIG. 1.

FIG. 32 is a screenshot of an example user profile page of the learning system shown in FIG. 1.

FIG. 33 is a screenshot of an example packets page of the learning system shown in FIG. 1.

FIG. 34 is a screenshot of another example packets page.

FIG. 35 is a screenshot of an example consumer public view page of the learning system shown in FIG. 1.

FIG. 36 is a screenshot of an example section view page of the learning system shown in FIG. 1.

FIG. 37 is a screenshot of an example event feed page of the learning system shown in FIG. 1.

FIG. 38 is a screenshot of an example page of an example event listener of the learning system shown in FIG. 1.

FIG. 39 is a screenshot of an example event feed page of another example event listener of the learning system shown in FIG. 1.

FIG. 40 is a screenshot of an example course page of an example third-party educational system of the learning system shown in FIG. 1.

FIG. 41 is a screen shot of an example home page of the learning system shown in FIG. 1.

FIG. 42 is a screen shot of an example leader board page of the learning system shown in FIG. 1.

FIG. 43 is a screen shot of an example of a user's public profile page of the learning system shown in FIG. 1.

FIG. 44 is another screen shot of the example public profile page shown in FIG. 43.

FIG. 45 is another screen shot of the example public profile page shown in FIG. 43.

FIG. 46 is another screen shot of the example public profile page shown in FIG. 43.

FIG. 47 is a screen shot of an example reputation score window of the learning system shown in FIG. 1.

FIG. 48 is a screen shot of an example portion of a learning packet page of the learning system shown in FIG. 1.

FIG. 49 is a screen shot of an example recommendation details window of the learning system shown in FIG. 1.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

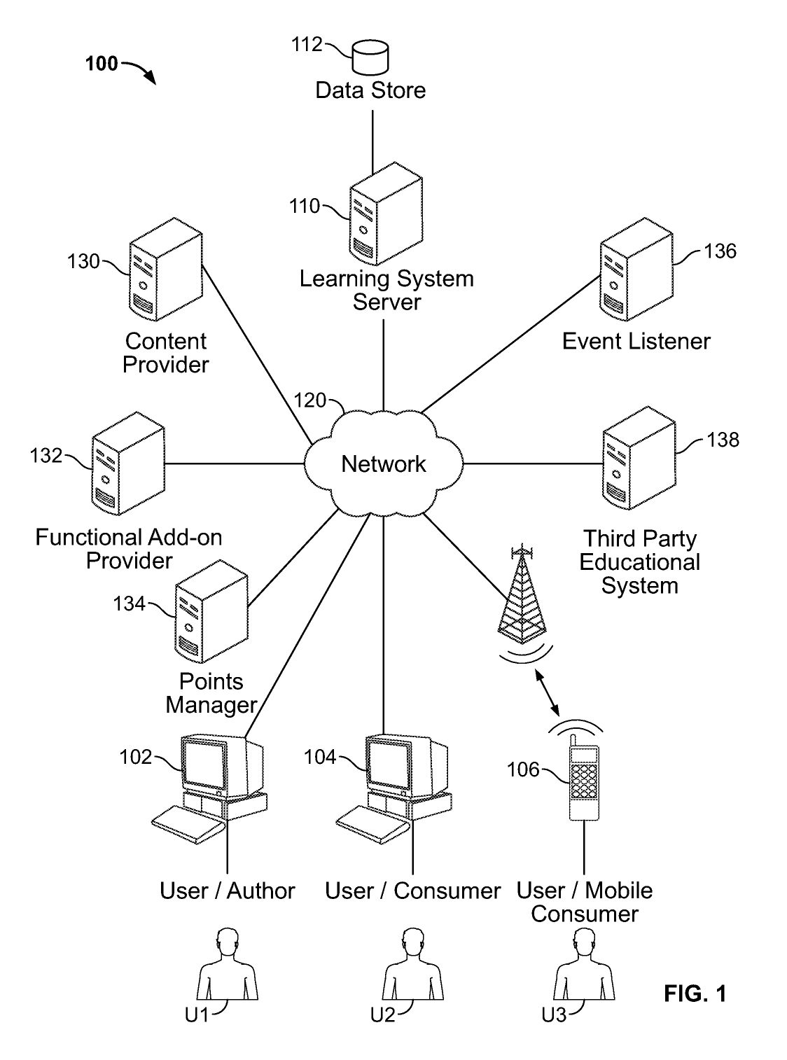

FIG. 1 is a block diagram of an example teaching and learning system 100 (“learning system 100”) for implementing aspects of the present disclosure. One example embodiment includes computing devices 102, 104, and 106 and server 110 including data store 112. In this example, system 100 is configured to communicate across network 120. Some embodiments also include, or are configured to interface with, a content provider 130, a functional add-on provider 132, a points manager 134, an event listener 136, and a third-party educational system 138. Other possible embodiments include more or fewer devices than those depicted in FIG. 1.

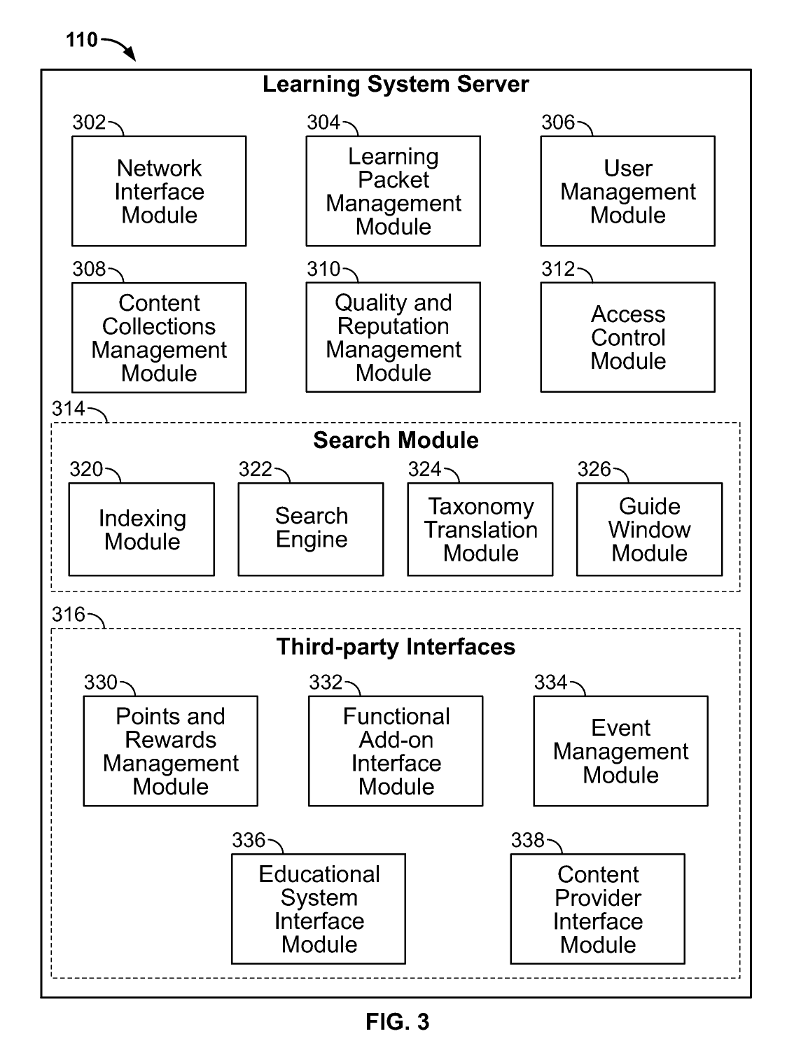

Computing devices 102, 104, and 106 interface with a user to allow the user to interact with server 110 across network 120. Computing devices 102, 104, and 106 can be any one of a variety of devices capable of processing data instructions and communicating digital data across network 120. Several examples of possible computing devices 102, 104, and 106 include a personal computer, a cell phone, a personal digital assistant (PDA), a mobile device such as a smart phone (such as the Blackberry® smart phone and the iPhone® smart phone). As discussed in more detail with reference to FIG. 3, computing devices typically include at least a processor, memory, and a communication device.

The illustrated example shows system 100 including three computing devices 102, 104, and 106. In this example, computing devices 102 and 104 are personal computers, while computing device 106 is a smart phone. Other embodiments can include more or fewer computing devices. In particular, some embodiments include many more computing devices, such as hundreds, thousands, or more, which can interface with hundred, thousands, or more users. Computing devices 102, 104, and 106 can communicate with network 120 in a variety of ways, such as through a wired connection or through a wireless access point.

Computing device 102 operates to interface with user U1, who has contributed content to learning system server 110. Accordingly, user U1 is referred to as an author. Computing device 104 operates to interface with user U2, who views the existing content of learning system server 110. Accordingly, user U2 is referred to as a consumer. Computing device 106 operates to interface with user U3, who also views existing content of learning system server 110. Accordingly, user U3 is referred to as a consumer. More particularly, since user U3 is utilizing a mobile smart phone to access learning system server 110, user U3 is referred to as a mobile consumer. Additionally, some users of system 100 are both authors and consumers.

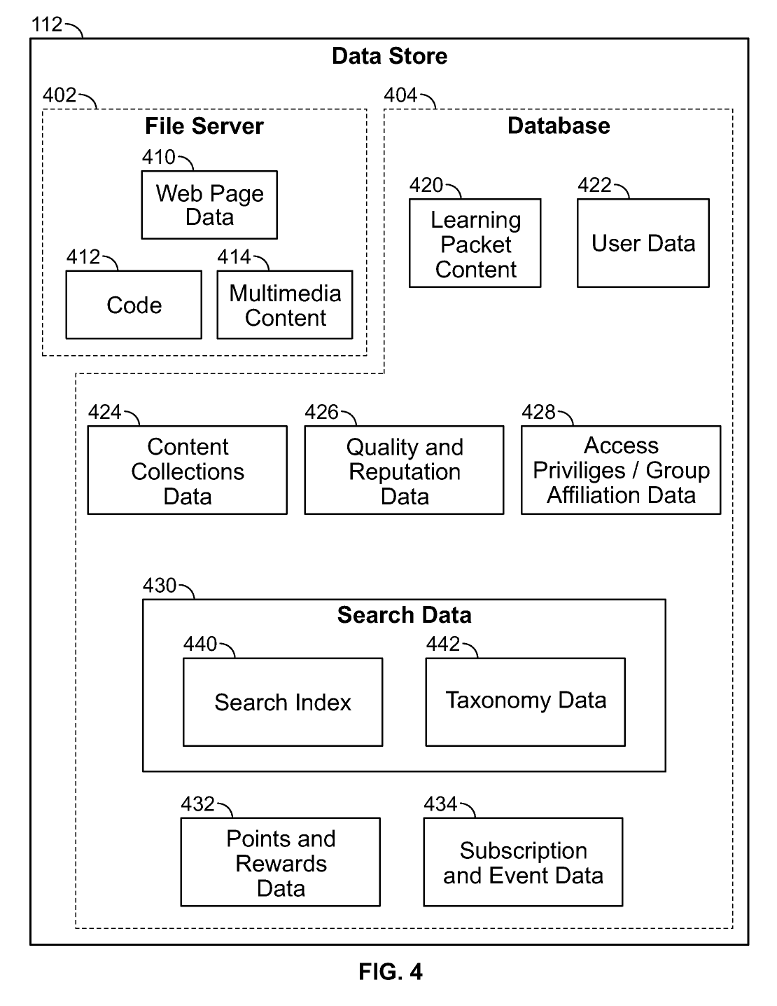

Learning system server 110 is a computing device that includes or is capable of data communication with data store 112 and network 120. Example of server 110 and data store 112 are illustrated and described with reference to FIGS. 3-4. Data store 112 can be located local to learning system server 110, or data store 112 can be accessible across network 120. In some embodiments, data store 112 includes one or more additional servers. An example of a possible data store 112 is Amazon® Simple Storage Service.

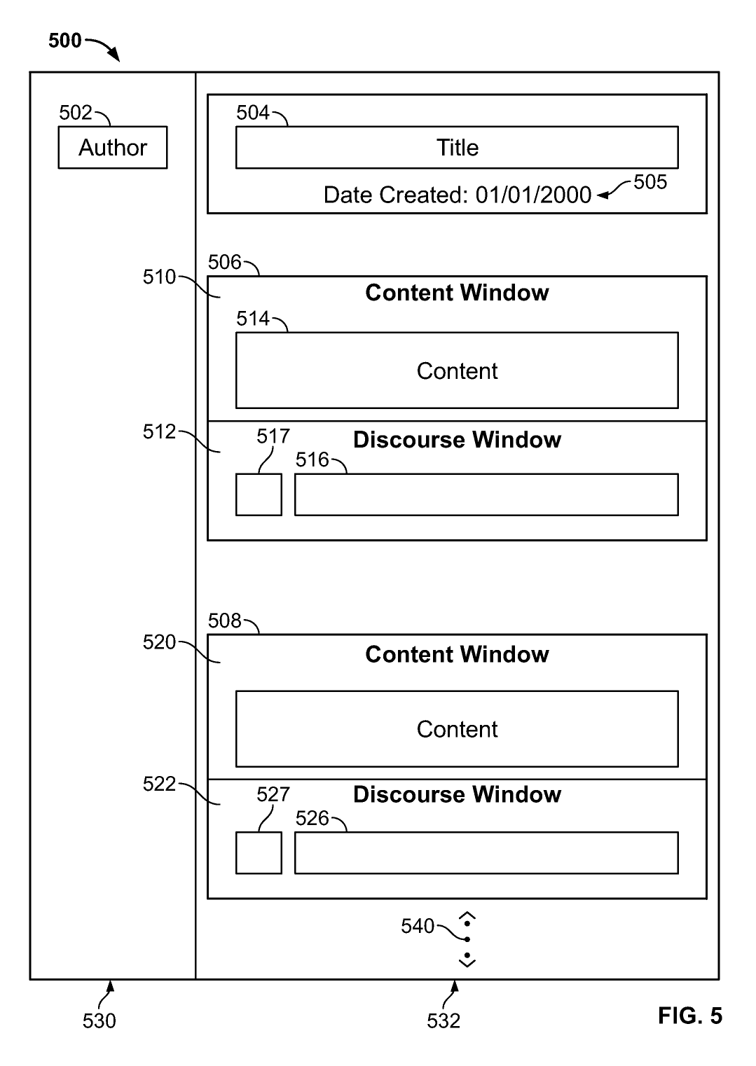

In some embodiments, learning system server 110 generates and stores data in units referred to herein as learning packets, and provides access to the learning packets across network 120. In some embodiments a learning packet is a compilation of data relating to a particular topic, such as an academic topic. The topic is identified, for example, by a title that is associated with the learning packet. Each learning packet includes content contributed by one or more authors. The content also relates to the topic identified by the title. Several examples of content include a written text-based explanation relating to the topic, a video presentation relating to the topic, or a graphic (e.g., an image, graph, chart, diagram, etc.) related to the topic. Other embodiments include other types of content, as discussed herein or combinations of types of content. In some embodiments, a learning packet further includes discourse that may be provided by either the author or the consumer, or both. The discourse is typically closely associated with a particular portion of the content. An example of a learning packet is illustrated and described herein with reference to FIG. 5.

Network 120 is a communication network capable of communicating digital data between computing devices. An example of network 120 is a wide area network, such as the Internet. Another example of network 120 is a local area network. In some embodiments, network 120 is a combination of multiple networks.

Communication across network 120 typically conforms to one or more standard data communication protocols. Examples of several of these protocols include the Internet Protocol (IP), Transmission Control Protocol (TCP) (or collectively as TCP/IP), Hypertext Transfer Protocol (HTTP), File Transfer Protocol (FTP), Simple Object Access Protocol (SOAP), or other known protocols.

In addition to user computing devices 102, 104, and 106 and server 110, some embodiments further include, or interface with, third-party systems. Examples of third-party systems include content provider 130, functional add-on provider 132, points manager 134, event listener 136, and third-party educational system 138. Although systems 130, 132, 134, 136, and 138 are referred to as “third-party” systems, in other possible embodiments one or more of these systems are provided by the learning system server 110, or the owner or operator of the learning system server 110. Further, in some embodiments, one or more of the functions performed by one of learning system server 110 or systems 130, 132, 134, 136, or 138 are performed by a single computing device, or are alternatively performed by multiple computing devices (e.g., distributed across multiple computing devices or performed by a computer cluster).

Content provider 130 is a system that provides content to learning system server 110, such as for inclusion in a learning packet. An example of a content provider is a web site that provides multimedia content, such as video, audio, or graphics. In some embodiments, interfacing with a content provider 130 is performed by content provider interface module 338, shown in FIG. 3.

Functional add-on provider 132 is a system that provides functional modules to learning system server 110 to provide enhanced capabilities to the learning system. An example of a functional module is a whiteboard application that permits users to collaborate on a shared space. In some embodiments, interfacing with a functional add-on provider 132 is performed by functional add-on module 332, shown in FIG. 3.

Points manager 134 is a system that manages points earned through the learning system. In some embodiments, points manager 134 allows users to obtain rewards by redeeming accumulated points. As one example, a user receives points for authoring a learning packet. The points can then be redeemed through the points manager 134 to purchase merchandise. In some embodiments, interfacing with a points manager 134 is performed by points and rewards management module 330, shown in FIG. 3.

Event listener 136 is a system that receives notifications from learning system server 110. An example of an event listener 136 is an event feed aggregator. An example of a notification is a message that states that a learning packet has been updated. In some embodiments, interfacing with an event listener 136 is performed by event management module 334, shown in FIG. 3. In some embodiments, notifications are automatically generated by learning system server 110 upon the occurrence of an event.

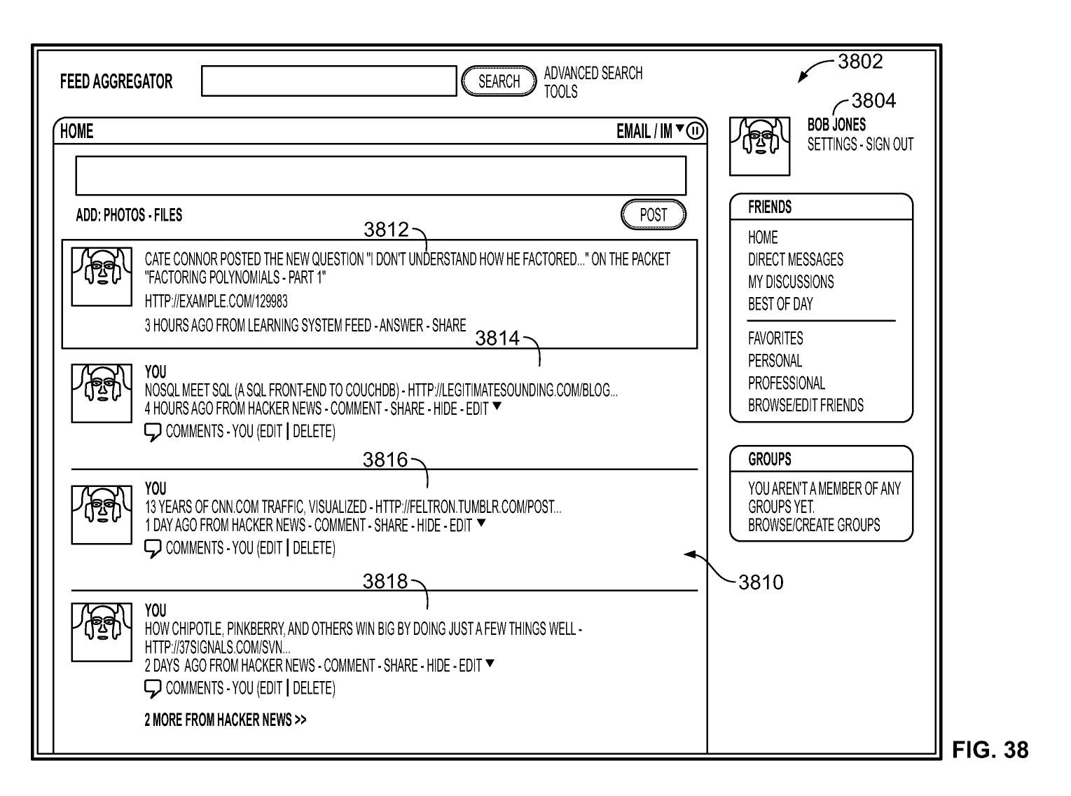

Another possible example of an event listener 136 is, for example, a third party social networking system in which users can post information. An example is illustrated and described in more detail with reference to FIG. 39 herein. In this example, notifications from learning system server 110 are sent in response to a request from a user to post information to the third-party social networking system, rather than being automatically generated by learning system server 110. In some embodiments, however, some notifications can also be generated automatically and communicated to the third-party social networking system.

Third-party educational system 138 is, for example, a system that is utilized by or provided by an educational institution in association with the institution's courses or curriculum. An example of a third-party educational system 138 is the Blackboard® educational system provided by Blackboard, Inc. In some embodiments, interfacing with an educational system 138 is performed by educational system interface module 336, shown in FIG. 3.

More or fewer systems or devices are included in other possible embodiments of system 100 than those depicted in FIG. 1. As a further example, some embodiments of learning system 100 include a third party payment processing system. The payment processing system can be used to receive and process payments from users. An example of a payment processing system is the Paypal™ payment processing system.

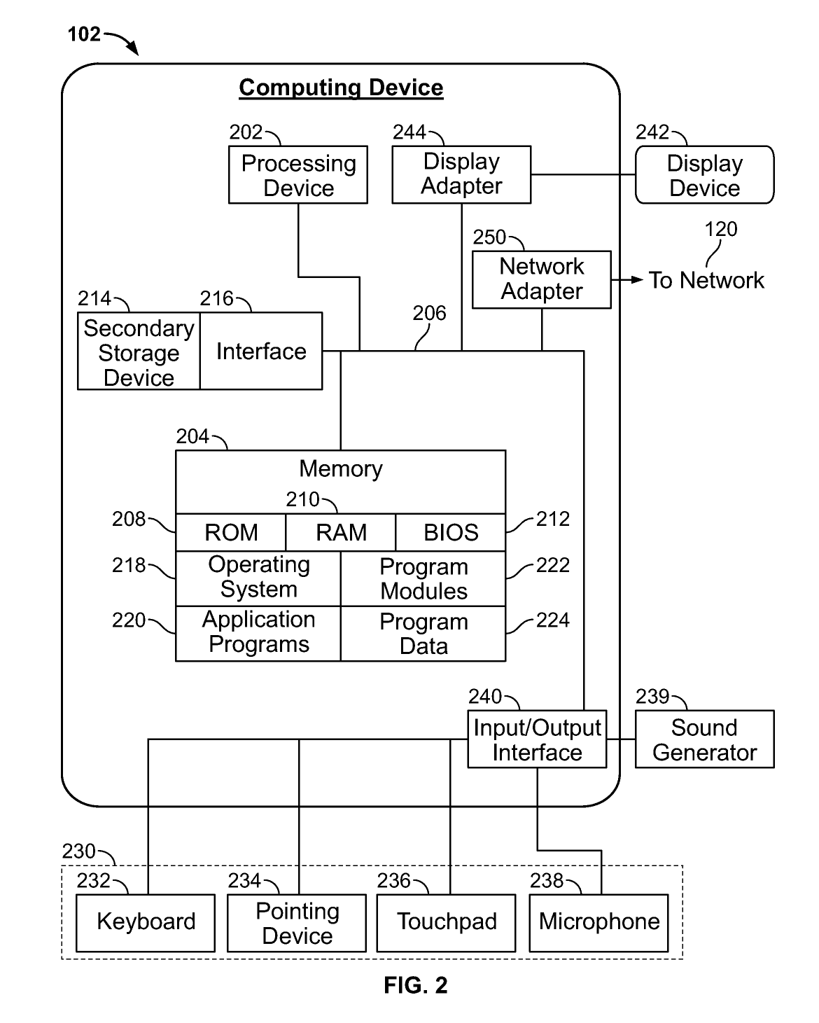

FIG. 2 is a schematic block diagram illustrating an architecture of an example computing device 102. Although described herein as an example of the author's computing device 102, the computing device shown in FIG. 2 is also an example of a suitable architecture for computing devices 104, 106, and/or server 110, and/or systems 130, 132, 134, 136, and 138. In one example, computing device 102 is a personal computer. Other embodiments include other computing devices 102, such as a tablet computer, a smart phone, a personal digital assistant (PDA), or other device configured to process data instructions.

Computing device 102 includes, in some embodiments, at least one processing device 202 and memory 204. A variety of processing devices 202 are available from a variety of manufacturers, for example, Intel Corporation or Advanced Micro Devices, Inc. In some embodiments, the processing device 202 is configured to perform one or more methods or operations as defined by instructions stored in memory.

Computing device 104 also includes, in some embodiments, at least one memory device 204. Examples of memory 204 include read-only memory 208 and random access memory 210. Basic input/output system 212, containing the basic routines that act to transfer information within computing device 102, such as during start up, is typically stored in read-only memory 208. Memory device 204 can be a part of processing device 202 or can be separate from processing device 202.

In this example, computing device 102 also includes system bus 206 that couples various system components including memory 204 to processing device 202. System bus 206 is one of any number of types of bus structures including a memory bus, or memory controller; a peripheral bus; and a local bus using any of a variety of bus architectures.

In some embodiments, computing device 102 also includes secondary storage device 214 for storing digital data. An example of a secondary storage device is a hard disk drive. Secondary storage device 214 is connected to system bus 206 by secondary storage interface 216. Secondary storage devices 214 and their associated computer readable media provide nonvolatile storage of computer readable instructions (including application programs and program modules), data structures, and other data for computing device 102.

Although the exemplary architecture described herein employs a hard disk drive as a secondary storage device, other types of computer readable media are included in other embodiments. Examples of these other types of computer readable media include magnetic cassettes, flash memory cards, digital video disks, Bernoulli cartridges, compact disc read only memories, digital versatile disk read only memories, random access memories, read only memories, or other memory devices.

A number of program modules can be stored in secondary storage device 214 or memory 204, including operating system 218, one or more application programs 220, other program modules 222, and program data 224. In some embodiments, program modules include data instructions that are stored in computer readable media (such as computer readable storage media). The data instructions, when executed by the processing device 202, cause the processing device 202 to perform one or more of the methods, operations, or functions described herein.

One example of an application program 220 is a browser software application. A browser software application operates to communicate according to known data communication protocols across network 120. For example, in some embodiments the browser software application requests web page data from learning system server 110, interprets the data according to a protocol, such as HTML, and causes display device 242 to display the web page data to the user. The browser software application can also receive inputs from the user, such as through one or more input devices 230, and transfer data associated with the inputs to server 110. Several examples of browser software applications include the Internet Explorer®, Firefox®, and Chrome® browsers.

In some embodiments, a user provides inputs to the computing device 102 through one or more input devices 230. Examples of input devices 230 include keyboard 232, pointing device 234 (such as a mouse or trackball), touchpad 236 (or a touch sensitive display), and microphone 238. Other embodiments include other input devices 230. Input devices 230 are often connected to the processing device 202 through input/output interface 240 that is coupled to system bus 206. These input devices 230 can be connected by any number of input/output interfaces, such as a parallel port, serial port, game port, or a universal serial bus. Wireless communication between input devices and interface 240 is possible as well, and includes infrared, BLUETOOTH® wireless technology, 802.11a/b/g/n wireless communication, cellular communication, or other radio frequency communication systems in some possible embodiments.

Output devices are included in some embodiments, such as a sound generator 239 (including a speaker, head phones, or the like), for generating sounds that can be heard by a user.

In some embodiments, a display device 242, such as a monitor, liquid crystal display device, projector, or touch screen display device, is also connected to system bus 206 via an interface, such as display adapter 244. In addition to display device 242, the computing device 102 can include various other peripheral devices, such as a printer, a digital camera, a digital camcorder, or other devices.

When used in a local area networking environment or a wide area networking environment (such as the Internet), computing device 102 is typically connected to network 120 through a network interface or adapter 250. Other possible embodiments use other communication devices. For example, some embodiments of computing device 102 include a modem for communicating across network 120.

Computing device 102 typically includes at least some form of computer-readable media. Computer readable media include any available media that can be accessed by computing device 102. By way of example, computer-readable media include computer readable storage media and communication media.

Computer readable storage media includes volatile and nonvolatile, removable and non-removable media implemented in any device configured to store information, such as computer readable instructions, data structures, operating systems 218, application programs 220, program modules 222, program data 224, or other data. Memory 204 is an example of computer readable storage media. Computer readable storage media includes, but is not limited to, read-only memory 208, random access memory 210, electrically erasable programmable read only memory, flash memory or other memory technology, compact disc read only memory, digital versatile disks or other optical storage, magnetic cassettes, magnetic tape, magnetic disk storage or other magnetic storage devices, or any other medium that can be used to store the desired information and that can be accessed by computing device 102. In some embodiments, computer readable storage media includes computer non-transitory media.

Communication media typically embodies computer readable instructions, data structures, program modules or other data in a modulated data signal such as a carrier wave or other transport mechanism and includes any information delivery media. The term “modulated data signal” refers to a signal that has one or more of its characteristics set or changed in such a manner as to encode information in the signal. By way of example, communication media includes wired media such as a wired network or direct-wired connection, and wireless media such as acoustic, radio frequency, infrared, and other wireless media. In some embodiments, communication media is transitory media. Combinations of any of the above are also included within the scope of computer readable media.

FIGS. 3 and 4 illustrate examples of learning system server 110 and an associated data store 112 that is utilized by learning system server 110. FIG. 3 is a schematic block diagram of an example learning system server 110. FIG. 4 is a schematic block diagram of an example data store 112.

The example learning system server 110, shown in FIG. 3, includes network interface module 302, learning packet management module 304, user management module 306, content collections management module 308, quality and reputation management module 310, access control module 312, search module 314, and third-party interfaces 316. The example search module 314 includes indexing module 320 search engine 322, taxonomy translation module 324, and guide window module 326. Examples of third-party interfaces 316 include points and rewards management module 330, functional add-on module 332, event management module 334, educational system interface module 336, and content provider interface module 338. Other embodiments include more or fewer modules than those illustrated in FIG. 3.

The example data store 112, shown in FIG. 4, includes file server 402 and database 404. The example file server 402 includes web page data 410, code 412, and multimedia content 414. The example database 404 includes learning packet content 420, user data 422, content collections data 424, quality and reputation data 426, access privileges/group affiliation data 428, search data 430, points and rewards data 432, and subscription and event data 434. In this example, search data 430 includes search index 440 and taxonomy data 442.

Database 404 is, for example, one or more computer readable storage media devices that store data in an organized manner, such as in logically related files, records, or tables. The relationships between data are sometimes referred to herein as “associations” between the data. Any one of a variety of techniques can be used to associate the data within database 404. Several examples include B-trees, hashes, and linked lists.

An example of learning system server 110 is described below with reference to FIG. 3 and the example data store 112, shown in FIG. 4.

Learning system server 110 is, for example, a computing device such as shown in FIG. 2, which is in data communication with network 120. In some embodiments, learning system server 110 includes multiple computing devices.

Network interface module 302 operates to communicate with network 120, such as to send and receive data with computing devices 102, 104, 106 and third-party systems 130, 132, 134, 136, and 138 according to one or more communication protocols. For example, network interface module 302 receives requests from computing devices 102, 104, and 106, and sends web page data to the computing device in response. The computing device receives the web page data, such as through a browser software application, and displays the web page data to the user. In some embodiments, network interface module 302 utilizes data stored in file server 402, such as web page data 410, code 412, and multimedia content 414. Some modules of learning system server 110 cooperate with network interface module 302 to communicate data across network 120.

Learning packet management module 304 performs operations to manage units of data, referred to herein as learning packets, within learning system server 110. For example, in some embodiments learning packet management module 304 performs operations to allow a user to author a new learning packet, operations to allow a user to edit an existing learning packet, operations to store learning packets (such as within data store 112), and operations to display learning packets to a user (such as by transferring learning packet data to a user's computing device). Other operations and methods are discussed herein that can be performed by learning packet management module 304. An example of a learning packet is illustrated and described below with reference to FIG. 5. Typically, learning packets include content (such as text, images, video, or other content) contributed by an author that relates to a particular topic, and is designed to train other users on that topic. Data for learning packets is typically stored in learning packet content 420 of data store 112.

In some embodiments, words stored within learning system 100 are filtered, such as to remove or suppress inappropriate language. For example, some embodiments of learning system 100 include a list of inappropriate words. If a user enters a word that is on the list, the word is determined to be an inappropriate word. Once identified, the word can be deleted and replaced with another word or symbol (e.g., asterisks) that will be displayed in its place. In some embodiments the word is tagged as inappropriate and selectively displayed by the learning system in the various pages described herein depending on the user's age, the user's filter settings, or other criteria. In addition to filtering text, some embodiments also provide filtering of other information types, such as video, audio, etc. Inappropriate language or media can be replaced by a sound (e.g., a beep) or lack of sound (e.g., silence), a notice informing the user that a portion of the media has been removed due to a terms of use violation, etc. In some embodiments users can select a control on the user interface to report inappropriate media.

Each learning packet is typically associated with a unique learning packet identifier, which is stored in learning packet content 420. Each learning packet is assigned a learning packet identifier when created. As one example, each learning packet is assigned the next available consecutive number (e.g., 1, 2, 3, 4, etc.), which can be used to identify the learning packet within system 100, and particularly within database 404. Other embodiments include other identifiers. For example, in some embodiments each learning packet is assigned a unique URL that serves as the learning packet identifier. An example of the URL is the URL of the system, followed by the author's name, and followed by an identifier. For example: www.example.com/authorname/learningpacket1.html. In another possible embodiment, learning packets are identified by other identifiers, such as a Universally Unique Identifier (UUID).

User management module 306 performs operations to manage users of learning system server 110. For example, user management module 306 stores data for each user in user data 422 of data store 112. Examples of possible user data include the user's name, password, contact information (e.g., residence address, business address, e-mail address, telephone numbers, etc.), date of birth, academic credentials, academic honors, group memberships, associations with organizations, specialty areas, level of education, or other user data. Additionally, user data can also include information or statistics relating to the user's activity within learning system 100 (e.g., number of learning packets authored, number of learning packets accessed, or other usage data or statistics as discussed herein).

In an example embodiment, all data gathered by learning system server 110 relating to such user data is carefully managed according to a clearly defined privacy policy. For example, during a user registration process, the privacy policy is presented to the user, which clearly defines the scope of data that will be collected about the user and the potential uses of that information. The user is then prompted to affirmatively agree to the policy before any such data associated with a particular user is gathered.

Content collections management module 308 performs operations, for example, that allow users to define and store content collections, and to access such content collections. Content collections are described in more detail herein. Content collections management module 308 stores content collections data 424 in database 404.

Quality and reputation management module 310 performs operations to manage quality and reputation data within learning system server 110. In some embodiments, learning system server 110 performs operations to associate quality and/or reputation scores with users and/or learning packets (or portions of learning packets). For example, in some embodiments, users of learning system 100 are associated with a reputation score, and learning packets are associated with a quality score. Such quality and reputation scores can then be used by learning system 100 for various purposes, such as to encourage users to create high-quality learning packets, to encourage users to engage in high quality discourse, to encourage users to utilize learning system 100 more frequently, or to enable learning system server 110 to provide improved functionality, such as to direct users to high quality content or to provide more relevant search results. Additional uses of quality and reputation data are discussed herein. In some embodiments, quality and reputation management module 310 stores quality and reputation data 426 in data store 112.

Access control module 312 manages access privileges for learning system 100. In some embodiments, access control module 312 stores access privileges/group affiliation data 428 in data store 112. Such data is used by access control module 312 to determine, for example, whether a user should be permitted access to requested data or areas of learning system 100. For example, in some embodiments learning system 100 allows the creation of a group, including a set of users that are members of the group. In some embodiments, groups are private, such that content associated with the group is not publicly available to members outside of the group. In some embodiments, groups are public. Examples of possible groups include sets of users that belong to an educational institution, class, educational major or emphasis, business, club, non-profit organization, study group, or other set of users that share a common interest or characteristic. In some embodiments, a group can have a separate group page within the learning system 100. The group page can be similar to a user's public profile page, for example, except that the information on the page is about the group, rather than a particular user. In another possible embodiment, the group page is customizable, and can include a variety of information, such as a group calendar, group documents (e.g., a syllabus, homework assignments, etc.), group links, previews of group learning packets, etc. In some embodiments the group page includes a discourse window that permits users of the group to communicate with each other. In some embodiments, learning packets can be imported into a private group environment associated with a group, where private discourse can occur relating to the learning packet. In some embodiments, learning packets that begin as private learning packets available only to members of the group, can be released to the rest of the learning system community, to make the learning packet public. In some embodiments the transfer of a learning packet into a private group setting requires the payment of a fee.

Search module 314 performs operations to permit users to search through data within learning system 100. In this example, search module 314 includes indexing module 320, search engine 322, taxonomy translation module 324, and guide window module 326. Indexing module 320 generates a search index 440 of the search data 430 stored in data store 112. In one example embodiment, search index 440 is an inverted index of terms contained within learning system 100. Other data is also stored and indexed by indexing module 320 in some embodiments.

Search engine module 322 is provided to perform searches across search index 440, such as to provide a list of search results in response to a search query. A search query can include, for example, one or more keywords, one or more tags, etc.

Taxonomy translation module 324 is provided in some embodiments to provide a uniform set of words that is used by learning system 100. For example, many words in the English language have multiple forms or multiple synonyms that all have the same or essentially the same meaning. As one example, the word “math” can also be written as “mathematics” and is synonymous with words such as “arithmetic.” In some embodiments, taxonomy translation module 324 utilizes taxonomy data 442 of search data 430 (that is stored in data store 112) to provide a uniform set of words to be used within learning system 100. An example of taxonomy data 442 is the Classification of Instructional Programs (e.g. the third revision published in 2000) that was originally developed by the U.S. Department of Education's National Center for Education Statistics. Other examples of taxonomy data include Bloom's Taxonomy originally published by Benjamin Bloom with subsequent revisions, variations, and addenda by various authors, such as A Taxonomy for Learning, Teaching, and Assessing: A Revision of Bloom's Taxonomy of Educational Objectives by D. R. Krathwohl and L. W. Anderson (2001).

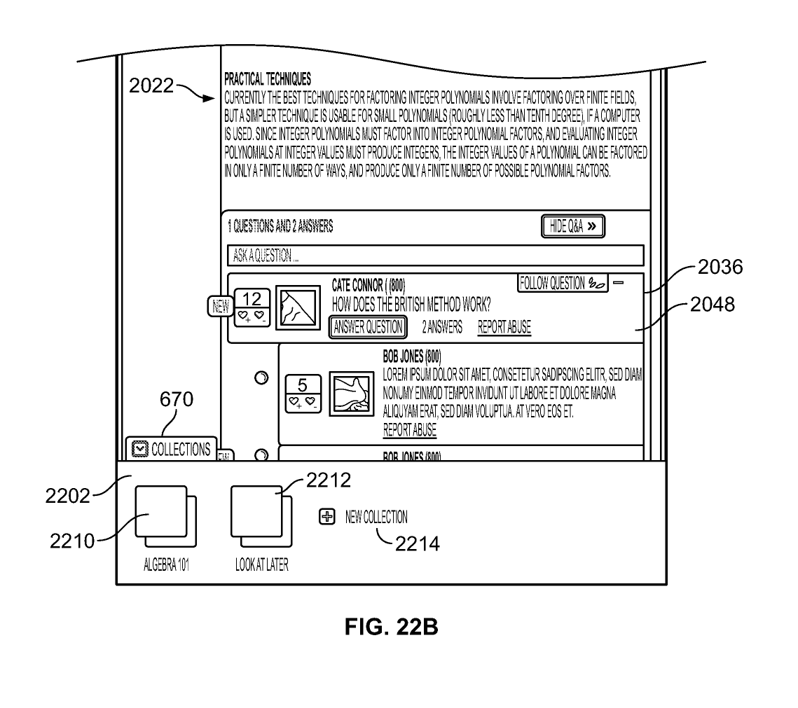

Guide window module 326 performs operations to guide a user to desired content within learning system 100. For example, in some embodiments, when a search is performed by a user, a guide window is generated by guide window module 326 to show the user the location of search results within one or more learning packets. As another example, a guide window is used in some embodiments to guide the user through new information within learning system 100, such as notifications or events. Guide window module 326 is described in more detail herein, such as in FIG. 25, along with examples of guide windows generated by the guide window module 326.

Third-party interfaces 316 are provided in some embodiments to allow third-party systems (e.g. 130, 132, 134, 136, and 138, shown in FIG. 1) to interact with learning system server 110. Several examples of possible third-party interfaces include points and rewards management module 330, functional add-on module 332, event management module 334, educational system interface module 336, and content provider interface module 338.

Points and rewards management module 330 operates to manage points and rewards within learning system 100, and in some embodiments to interface with a third-party points manager 134 (shown in FIG. 1). In some embodiments, learning system provides incentives to users by rewarding users for activity within learning system 100 by awarding points to the users for such activity. In another possible embodiment, points manager 134 provides a marketplace where points can be exchanged for tangible or intangible merchandise. As just one example, points manager 134 is a school store. Points accumulated by a user can be redeemed by the user to purchase merchandise at the school store, such as books, supplies, clothing, food, or a variety of other products. In yet another embodiment, learning system 100 permits users to exchange points with each other. For example, if a consumer (such as user U2, shown in FIG. 1) finds a learning packet created by an author (such as user U1, shown in FIG. 1) be particularly helpful in learning about a particular topic, learning system 100 allows the consumer to give the author some or all of the points that the consumer has accumulated in return.

Alternatively, in some embodiments points are required to be paid in order to view a learning packet. Other examples of points and rewards management module 330 are described herein. In some embodiments, points and rewards management module 330 stores points and rewards data 432 in data store 112. In some embodiments, points have a cash value.

In another possible embodiment, points can be used by quality and reputation management module 310 as at least one factor in generating a user's reputational score. In some embodiments, the reputational score acts as a status symbol within the learning system community, where users with a greater reputational score may be seen as having a greater status than users having a lesser reputational score. In some embodiments reputational scores are tied to one or more particular subjects. For example, if a user is an expert in the subject of Biology, the reputational score can be tied to the subject of Biology. In some embodiments, a user can have multiple reputational scores, each score being associated with a different subject. For example, an expert in Biology may not be an expert in music, and therefore the same user may have a low reputational score in music.

Functional add-on module 332 provides an interface with functional add-on provider 132 (shown in FIG. 1) to allow third parties to provide additional features and functionality within learning system 100. Examples of functional add-ons are described in more detail herein.

Event management module 334 performs operations to allow users to be notified when certain events occur within learning system 100. In some embodiments, event management module 334 utilizes subscription and event data 434 stored within data store 112. For example, in some embodiments learning system 100 allows users to subscribe to an author, a learning packet, or portion of a learning packet so that the subscribing user can be notified when information within the subscription has been added or updated. When a user has subscribed to content within learning system 100, the user is also sometimes referred to herein as “following” that content. If the user is subscribed to a particular author, for example, a notification is generated by event management module 334 when that author adds or updates content within learning system 100. The event management module 334 is also used, in some embodiments, to generate an event feed where users can view notifications based on their subscriptions. Additional examples are described herein.

Educational system interface module 336 performs operations to interface with a third-party educational system 138 (shown in FIG. 1). An example of a third-party educational system 138 is a web-based software application provided by an academic institution that provides content associated with courses offered by the academic institution. For example, a third-party educational system 138 may provide course information including a syllabus, a listing of reading assignments or homework to be completed during the course, links to quizzes or examinations that can be taken online, or other information relating to a course. In some embodiments, learning system 100 interfaces with such an educational system 138 to enhance the capabilities of the educational system. Examples are described herein.

Content provider interface module 338 performs operations that enable learning system server 110 to incorporate content provided by a third-party content provider 130 (shown in FIG. 1). Examples of content providers 130 are websites that store one or more types of multimedia content (e.g. text, images, videos, etc.) such as YouTube®, Flickr®, etc. Content provider interface module 338 enables learning system 100 to link to or otherwise receive content provided by such content providers 130. Additional examples are provided herein.

In some embodiments, learning system 100 is configured to support multiple tenants, such as to interact with multiple educational institutions or other organizations. In some embodiments, data within data store 112 is segregated, to maintain a separation between the users and content of one tenant, and the users and content of another tenant. For example, in some embodiments data is associated with an identifier of the tenant to which it belongs. In another possible embodiment, data for one tenant is stored on one data store 112, and data for another tenant is stored in another data store 112. In another possible embodiment, data store 112 is physically or logically partitioned. In some embodiments, multiple learning systems 100 are provided, a first learning system being associated with a first tenant, and a second learning system being associated with a second tenant. More than two tenants are included in some embodiments.

FIG. 5 is a schematic block diagram of an example learning packet 500. In this example, learning packet 500 includes author identification 502, title 504, timestamp 505, section 506, and section 508. Section 506 includes content window 510 and discourse window 512. Section 508 includes content window 520 and discourse window 522. Content window 510 includes content 514, and discourse window 512 includes discourse 516. Content window 520 includes content 524, and discourse window 522 includes discourse 526. In this example, learning packet 500 also includes a sidebar 530 and a main window 532.

In the example user interface illustrated in FIG. 5, learning packet 500 includes a particular arrangement of the various parts of the learning packet 500 when displayed on display device 242 of computing device 102. The example arrangement is as follows. Learning packet 500 includes a sidebar 530 and a main window 532. Sidebar 530 is displayed along a side of the learning packet 500, such as along a left side of the learning packet. In this example, author identification 502 is provided within sidebar 530. Other or additional information is displayed in sidebar 530 in some embodiments. Main window 532 is displayed adjacent to sidebar 530, such as immediately to the right of sidebar 530. Typically, main window 532 has a width that is significantly larger than sidebar 530. Main window 532 includes title 504, timestamp 505, and one or more sections 506, 508. Title 504 is typically displayed at or proximate to the top of learning packet 500 so as to be prominently displayed within main window 532. Timestamp 505 is displayed near to the title and above the sections. Sections 506, 508 are typically vertically arranged within main window 532, such that section 506 is arranged directly below title 504 and section 508 is arranged directly below section 506. Additional sections can be included below section 508 as indicated by arrow 540. In some embodiments a scroll bar is displayed by a browser software application along a right side of learning packet 500 to allow a user to scroll down to portions of learning packet 500 that are not initially visible upon display of the learning packet 500. This discussion of an example arrangement is only one example of a possible arrangement of a learning packet 500. Other embodiments include other arrangements. Further details of some of the many possible arrangements are provided herein.

Author identification 502 is provided to identify the author (e.g., user U1, shown in FIG. 1) of the learning packet 500. In one example, the author identification 502 displays the name (i.e., first and last) of the author. In another example, the author identification 502 displays the username of the author. In other possible embodiments, the author identification 502 displays another code, identification number, symbol, picture, video, or other text or multimedia identifier. Further, some embodiments include combinations of these. The author identification 502 is typically stored in learning packet content 420 of data store 112 and associated with the learning packet 500. In some embodiments, two or more users can collaboratively generate a learning packet 500. In some embodiments, each of the multiple authors is identified with author identification 502.

Title 504 is provided to concisely identify a topic of the learning packet 500. The topic of the learning packet is typically written by the author. In some embodiments, the topic identifies a purpose of the learning packet, to assist consumers, as well as system 100, in knowing what outcome should be expected upon review of the learning packet. In some embodiments, the title 504 is a textual description of the topic. The title is preferably relatively short, such as being composed of a quantity of words in a range from about 2 to about 10 words. In another possible embodiment, the number of characters of the title is in a range from about 8 to about 64 characters. Other embodiments include more or fewer words or characters. Some embodiments include a title and one or more subtitles. The title 504 is typically stored in learning packet content 420 of data store 112 and associated with the learning packet 500. As discussed herein, tags or keywords are also associated with a learning packet in some embodiments.

Timestamp 505 is also provided in some embodiments to display relevant time data. For example, in some embodiments, timestamp 505 displays the date that the learning packet was first created. Timestamp 505 can also or alternatively display other dates, such as the most recent date that the learning packet 500 was updated by the author, the most recent date that discourse was posted on the learning packet 500, or the most recent date that some other activity occurred with respect to the learning packet 500.

In some embodiments, learning packet 500 includes one or more sections. In some embodiments learning packets include two or more sections, such as sections 506 and 508 shown in FIG. 5.

In this example, section 506 includes a content window 510 and a discourse window 512. Content window 510 includes content 514. Discourse window 512 includes discourse 516 relating to content 514. In some embodiments, content window 510 includes a title bar. Some embodiments include additional information within content window 510.

In some embodiments, content 514 is information provided by the author that forms at least part of the initial content of the learning packet 500 and is related to the topic identified by title 504. Content 514 can take a variety of different forms. One example of content 514 is text (e.g., a series of ASCII characters), such as a written description providing additional information relating to the topic of the learning packet 500. In some embodiments the text includes markup, such as HTML tags, to enhance the text or define the arrangement or organization of information within content window 510. Other embodiments include other markup or interpretable code, such as extensible markup language (XML), JavaScript, or other markup.

Another example of content 514 is an image. Some possible image file formats include: joint photographic experts group (JPEG) format, exchangeable image file format (EXIF), tagged image file format (TIFF), raw image format (RAW), portable network graphics (PNG) format, graphics interchange format (GIF), bitmap file format (BMP), portable bitmap (PBM) format, flash video (FLV or F4V), or other digital file formats.

Another example of content 514 is a video. In some embodiments, a video player software application installed on the computing device 104 of computing device 104 operates to play the video. Some of the possible video file formats include: 3GP, Advanced Systems Format (ASF), Windows Media Video (WMV), Audio Video Interleave (AVI), QuickTime (MOV), Moving Picture Experts Group (MPEG), RealMedia (RM), or other digital video formats.

Content 514 can be of a wide variety of other formats, such as one of a variety of document formats, one of a variety of audio formats, etc. In some embodiments, content 514 is a file attachment. Some additional examples are discussed herein. In some embodiments content 514 is only one of a plurality of possible content types, while in other embodiments content 514 can include a combination of possible content types (e.g., text and an image). In some embodiments, content window 510 includes only a single content element 514. In some embodiments, content 514 in content window 510 cannot be provided or edited by a consumer (user U2), and can only be provided or edited by the author (or authors) of the learning packet (user U1).

In some embodiments, section 508 also includes discourse window 512. Discourse window 512 is a window configured to display discourse 516. Discourse window 512 is, for example, a region within learning packet 500 where the content 514 of content window 510 can be discussed. Discourse window 512 is configured to receive and display information provided by either the author (user U1, shown in FIG. 1) or a consumer (user U2, shown in FIG. 1).

In some embodiments, learning system server 110 is configured to receive questions from one or more consumers (user U2) relating to content 514 of content window 510, and to display those questions as a part of discourse 516. Answers can then be subsequently entered and displayed as an additional part of discourse 516. In some embodiments answers can only be provided by the author (user U1). In other embodiments, answers can be provided by either the author or a consumer. In this way the discourse section provides a region where a back and forth dialog can occur regarding the content 514. For example, discourse window 512 provides a region where the content 514 can be challenged, questioned, or clarified.

In some embodiments discourse 516 is provided as text (such as ASCII text), or text with markup (such as HTML or XML). Discourse 516 within discourse window 512 can take a variety of different formats in other possible embodiments. For example, in some embodiments discourse 516 includes comments relating to content 514. In some embodiments, discourse 516 is provided in another or additional form, such as a video form, audio form, graphical form (e.g., through a whiteboard module), or a variety of other forms.

In some embodiments, each element of discourse provided by a user is associated with an identifier 517 of the user who provided the element. For example, if discourse 516 is a question submitted by user U2, the user's name or other identifier 517 is displayed adjacent to the discourse 516. Multiple elements of discourse can be included in discourse window 512, such as submitted by multiple different users.

In some embodiments, learning packet 500 includes multiple sections, such as a second section 508. Some embodiments include two or more sections. In this example, section 508 is arranged vertically below section 506 within main window 532. The example section 508 includes a content window 520 including content 524, and a discourse window 522 including discourse 526. In some embodiments, content window 520 includes a title bar. Some embodiments include additional information within content window 520.

In the example shown in FIG. 5, section 508 is proximate to section 506, but is also visually distinct from section 508. Similar to content window 510, the content 524 contained within content window 520 is related to the topic of title 504, such that both content windows 510 and 520 relate to the same subject. However, content 524 is different from content 514. In some embodiments content 524 is of a different type of content than content 514, such as one being a text description of the topic while the other is a video relating to the topic. Additional examples are provided herein.

Similar to discourse window 512, discourse window 522 contains discourse 526 relating to content 524. In some embodiments, discourse window 522 does not contain discourse regarding content 514, and similarly discourse window 512 does not contain discourse regarding content 524. In this way, each content window 510 is associated with its own discourse window 512 or 522, where discourse can occur regarding that content.

In some embodiments, discourse 516, 526 is identified directly within content window 510. For example, in some embodiments a graphical element is displayed (such as a flag, an insertion mark, a star, etc.) within content window 510, 520 to indicate that discourse is available for the content 514, 524. (Discourse that is displayed in this way may be referred to as being “in-line” with the content.) In some embodiments the graphical element is then selectable by a user. Once selected, the display of learning packet 500 is updated to show discourse 516, 526 associated with the graphical element. As an example, content 514 includes a text description of how to factor a polynomial. If a user has a question regarding the fourth sentence of the description, the user can identify a location within content 514 (such as, at the end of the fourth sentence). The learning packet 500 is then updated to show a graphical element at the end of the fourth sentence. When the graphical element is selected, the question (and any additional discourse that has been received) is displayed, such as in a pop-up window, in discourse window 512, etc. In some embodiments discourse is provided in the margins, or a text or graphical element is shown to identify the presence of the discourse (e.g., “3Q's and 2A's” to indicate that there are three questions and two answers in the discourse associated with the adjacent content).

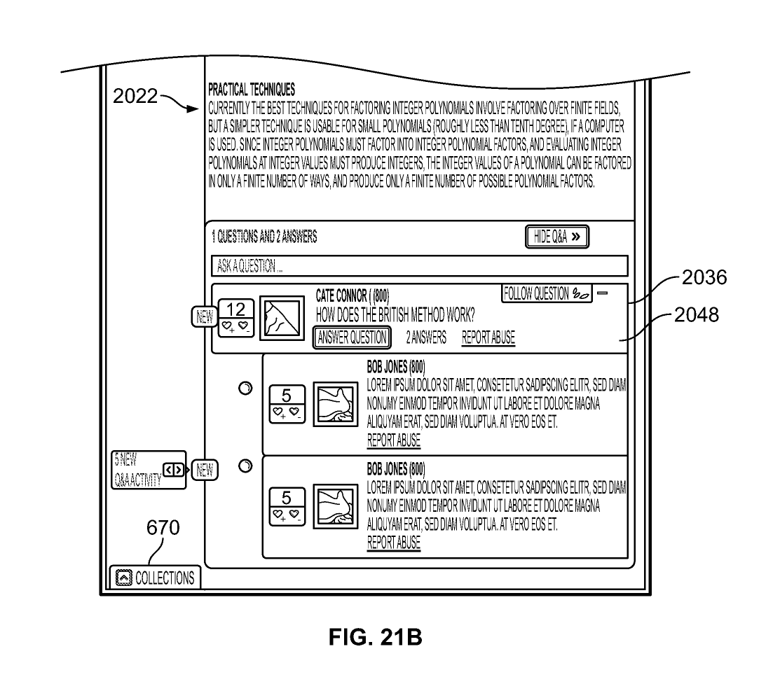

Other embodiments can utilize other learning packet structures. For example, in some embodiments, the learning packet sections include content windows but may not include discourse windows. As one example of this, a learning packet can include one or more sections including content windows, followed by a single discourse window. The single discourse window provides a location for discourse relating to the entire packet, rather than a single content window. As another possible embodiment, however, a learning packet can include the sections as illustrated in FIG. 5, and further include an additional packet discourse window. Discourse windows can also be provided on other pages, such as a user's public profile page, a collections page (e.g., FIG. 23), etc.

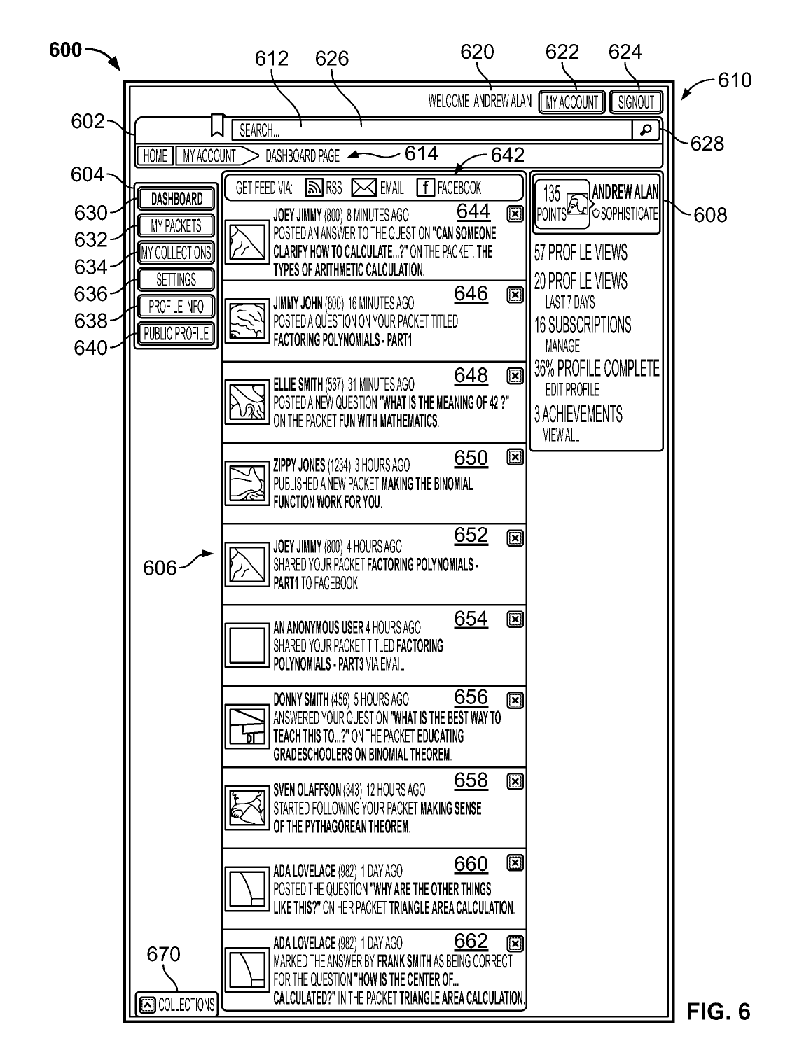

Various aspects will now be described with reference to FIGS. 6-40, which illustrate an example implementation of a learning system 100 by way of various exemplary screenshots. The screenshots show examples of how data generated by and transmitted from learning system server 110 to one of the computing devices 102, 104, or 106 is interpreted and displayed on the associated display device 242 (shown in FIG. 2), and accordingly how the data is viewed by the user U1, U2, or U3.

In some embodiments, when a user first accesses learning system 100, a login prompt is displayed to the user. An example of a login prompt is a prompt that requests a username and a password. If the user has not previously registered with learning system 100, a registration control is provided which the user can select to begin a registration process. During the registration process, the user is prompted, for example, to enter the user's name and to select a password. In some embodiments additional information is requested from the user. After the user has registered and logged in, a dashboard page 600, such as shown in FIG. 6 is displayed to the user. In other possible embodiments, users are permitted to access certain sections of learning system 100 without requiring the user to login, in which case another page, such as a home page, can be first displayed to a user upon access to learning system 100.

FIGS. 6-12 illustrate various pages generated by the example user management module 306, through which information about a particular user's account is received from and displayed to the user.

FIG. 6 is a screenshot of an example dashboard page 600, such as generated by learning system server 110 (shown in FIG. 1). In this example, dashboard page 600 includes header 602, navigation window 604, event feed 606, and user statistics window 608.

Header 602 includes account controls 610, search bar 612, and location display 614. In some embodiments, header 602 is displayed across the top of dashboard page 600 where it is easily accessible to the user. Header 602 provides convenient access to commonly features, such as to allow the user to navigate within learning system 100, find desired content, adjust account settings, etc. In some embodiments, header 602 is also included in other pages as discussed herein.

In this example, account controls 610 are provided to allow the user to control the account that is currently logged in. Adjacent to account controls 610, user display 620 displays the name (e.g., “Andrew Alan”) of the user that is currently logged in. Account controls include selectable controls 622 and 624. Selectable control 622 can be selected by the user to access the user's account information within learning system 100. For example, when selectable control 622 is selected, learning system 100 displays dashboard page 600, from which the user can navigate to any of the other account pages by selecting one of the navigation controls from navigation window 604. Selectable control 624 can be selected by the user to indicate a desire to log out from learning system 100.

Search bar 612 is provided to allow a user to enter search criteria. Search bar 612 includes a text entry field 626, and a selectable control 628 to execute the search. Search bar 612 is described in more detail with reference to FIG. 25.

Location display 614 displays to the user an indication of the user's current location within learning system 100. In this example, the location display 614 shows that the user is in the “My Account” section of learning system 100, and is at the “Dashboard Page.” As the user navigates throughout learning system 100, the location display 614 updates to provide an indication to the user of the user's current location.

Navigation window 604 is displayed, for example, within a left sidebar of dashboard page 600. Navigation window 604 includes selectable controls that allow a user to navigate among the various pages associated with the user's account. In one example, navigation window 604 includes dashboard control 630, packets control 632, settings control 634, profile information control 638, and a public profile control 640.

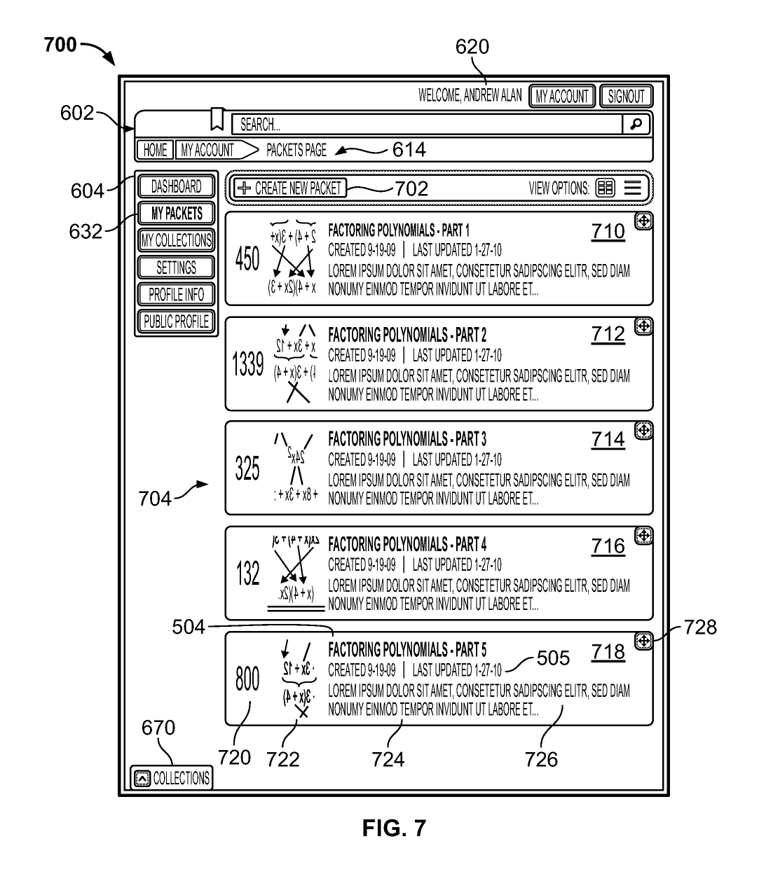

In some embodiments, the navigation control that is associated with the currently displayed page is displayed in a different format from the other navigation controls to indicate that that page is currently displayed. For example, dashboard control 630 appears to be depressed and has a different color from the other controls of navigation window 604. This indicates that dashboard page 600 is currently displayed. When another settings page (e.g., 700, 900, 1000, or 1200, shown in FIGS. 7, 9, 10, and 12) is displayed, dashboard control 630 can be selected to return to dashboard page 600.

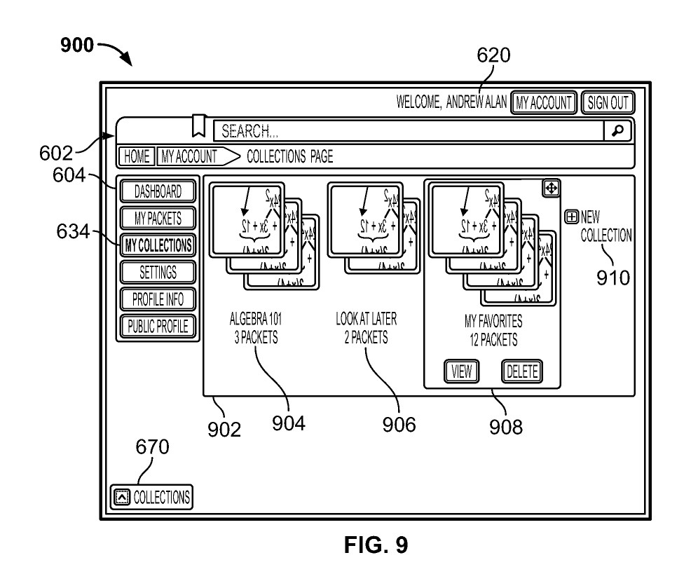

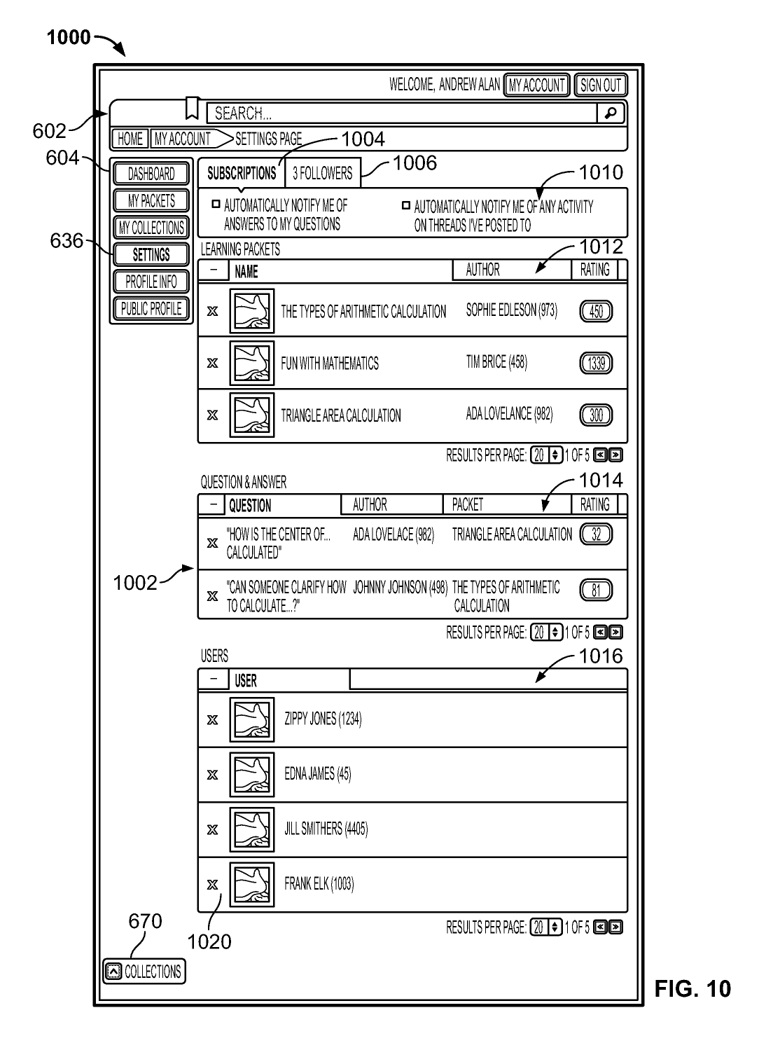

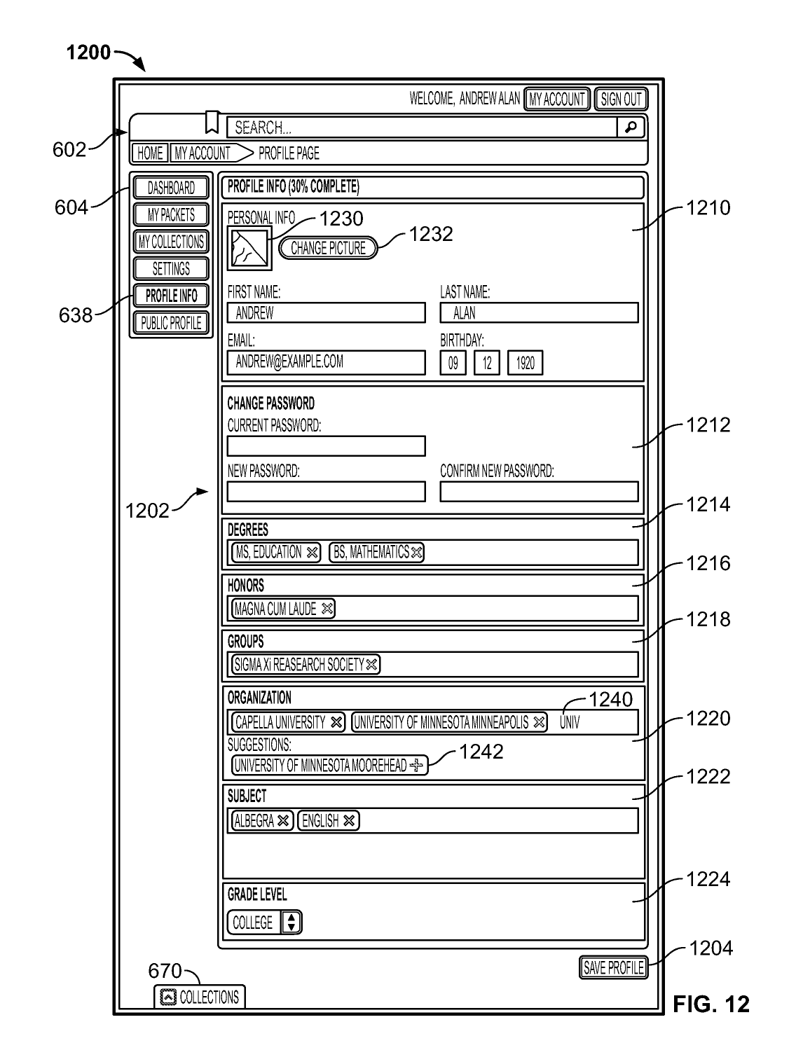

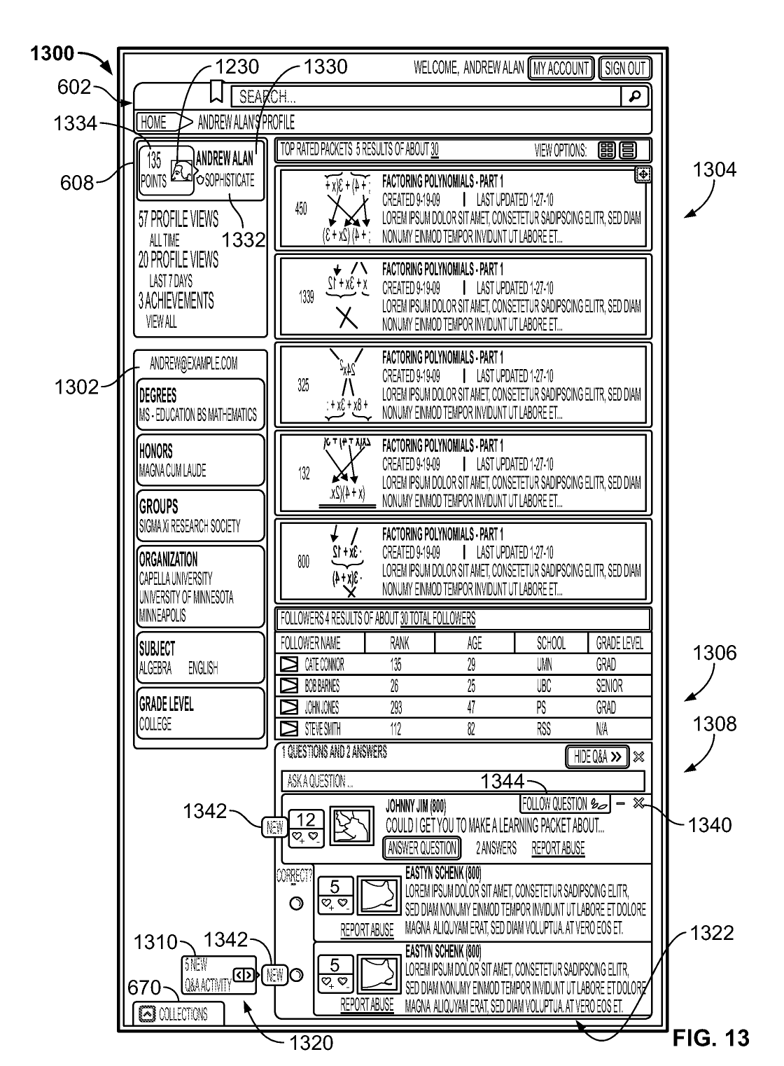

Packets control 632 can be selected to cause learning system 100 to display packets page 700 (shown in FIG. 7). Collections control 634 can be selected to cause learning system 100 to display collections page 900 (shown in FIG. 9). Settings control 636 can be selected to cause learning system 100 to display settings page 1000 (shown in FIG. 10). Profile information control 638 can be selected to cause learning system 100 to display profile page 1200 (shown in FIG. 12). Public profile control 640 can be selected to cause learning system 100 to display the users public profile page 1300 shown in FIG. 13.

The primary content of the example dashboard page 600 is the event feed 606, which displays a list of recent notifications that have been received based on the user's subscription settings. The user's subscriptions can be managed, for example, by selecting settings control 636 to navigate to settings page 1000 (shown in FIG. 10) and selecting the subscriptions tab. Once subscriptions have been defined, the event management module 334 (shown in FIG. 3) monitors learning system 100 for updates to any content to which the user has subscribed. If an update is detected, a notification is generated. The notification is then displayed to the user as part of event feed 606.

Some users may prefer to obtain notifications through a third-party event listener 136 (shown in FIG. 1). To do so, a user can select one of selectable controls 642 to indicate the way that the user would like to receive the notifications. Several examples include an RSS feed, an e-mail message, or a third-party system, such as the Facebook® system. Once the selectable control 642 has been selected, learning system server prompts the user for any additional information required, and then begins providing notifications through event management module 334 (shown in FIG. 3) to the associated event listener 136 (shown in FIG. 1).

Notifications are displayed in event feed 606 in notification windows (e.g., 644, 646, 648, 650, 652, 654, 656, 658, 660, and 662). In some embodiments, notifications are displayed in reverse chronological order such that the newest notification is at the top and the oldest notifications at the bottom. In some embodiments only a quantity of the most recent notifications are displayed in event feed 606. In some embodiments an identifier of the user that generated the notification is included in the notification, such as the user's name, a thumbnail image of the user, or an image provided by the user. Further, some embodiments sort notifications within event feed 606 into multiple categories, such as according to the user who caused the generation of the notification, according to a type of notification, according to the learning packet associated with the notification, or a variety of other possible categories. Some embodiments include search, filter, and/or sort controls to provide added flexibility and to provide more relevant information to the user.

Various aspects of the example learning system 100 are illustrated by the exemplary notifications shown in the event feed, which will now be described in more detail. In this example, a first notification is displayed in notification window 644. The notification states that a user, Joey Jimmy, has posted an answer to a question within the packet that is being followed by the current user (shown in user display 620). A second notification in notification window 646 states that a user, Jeannie John has posted a question on a learning packet that is authored by the current user. The next notification in notification window 648 indicates that a user, Ellie Smith, has posted a new question on a packet that the current user is followed. The following notification in notification window 652 indicates that the user, Joey Jimmy, has shared a learning packet that was written by the current user, to a third-party system, such as a Facebook® system account. The next notification in notification window 654 states that an anonymous user has shared a packet written by the current user with someone via e-mail. Notification window 656 includes a notification that states that a user, Donny Smith, has answered a question that was written by the current user. The notification in notification window 658 states that a user, Sven Olaffson, and started following a packet written by the current user. The notification in notification window 660 indicates that a user, Ada Lovelace, has posted a question to a packet that the current user is following. Notification window 662 includes a notification relating to a question that is being followed by the current user. More specifically, the notification indicates that the author of the associated learning packet as marked an answer provided by the user, Frank Smith, as being the correct answer to the question.

Some embodiments include subscription controls within event feed 606 that allow the user to modify current subscriptions. For example, a subscription control is displayed adjacent each element in the event feed. In some embodiments, upon selection of the subscription control, the item (e.g., learning packet, portion of learning packet, or user) that is associated with the element is removed from the user's subscription list. In another possible embodiment, upon selection of the subscription control, the subscription is updated to remove the type of notification from the subscription list. For example, a single subscription can be associated with various types of notifications that are sent upon the occurrence of different events. For example, a notification can be sent when a learning packet is updated, when a new question is posted, when an answer to a question is posted, when the author of the learning packet obtains a new achievement within the learning system, or a wide variety of other possible notifications. If a user no longer wants to receive a certain type of notification, the user can select the subscription control to stop receiving notifications associated with that type of notification (e.g., to no longer be notified when new questions are posted for a learning packet, etc.). In another possible embodiment, selection of the subscription control causes learning system 100 to display a window or page where the subscription settings can be adjusted. In some embodiments, notifications are generated upon the occurrence of an event in learning system 100. Examples of events include the following: a followed learning packet has been modified by author, a followed learning packet has a new question, a followed author published a learning packet, a followed author asked a question, a followed author answered a question, a followed author ranked an answer as best, a followed question has a new answer, a followed question has an answer marked as best, a user's own learning packet has a new follower, a user's own learning packet has been shared (e.g., within learning system 100 or through a third-party system, third-party post is sent, a third-party share is sent, an e-mail share is sent, an author selected the user's answer as the best answer, the user was tagged, a learning packet was tagged, another user's learning packet linked to the user's learning packet. Other embodiments include more or fewer events that trigger notifications.

User statistics window 608 provides information and statistics about the current user. For example, user statistics window 608 shows the user's name, system achievements that have been awarded (e.g., a “sophisticate” badge), the user's reputational score (e.g., 135 points), the number of times the user's profile has been viewed, the number of times the user's profile has been recently viewed, the current number of subscriptions, the percentage of the users profile has been completed, and the number of system achievements that have been awarded. Other embodiments include other user statistics.

Some embodiments include collections tab 670 that can be selected by a user to cause learning system 100 to display the user's collections. Examples of collections are described herein. Collections can be managed through collections page 900, shown in FIG. 9.

FIG. 7 is a screenshot of an example packets page 700. Packets page 700 displays a list of the packets that have been authored by the current user (620). In this example, packets page 700 includes header 602 (including location display 614, user display 620), navigation window 604 (including selectable control 632), and collections tab 670. In addition, packet page 700 further includes create new packet control 702 and learning packet list 704.

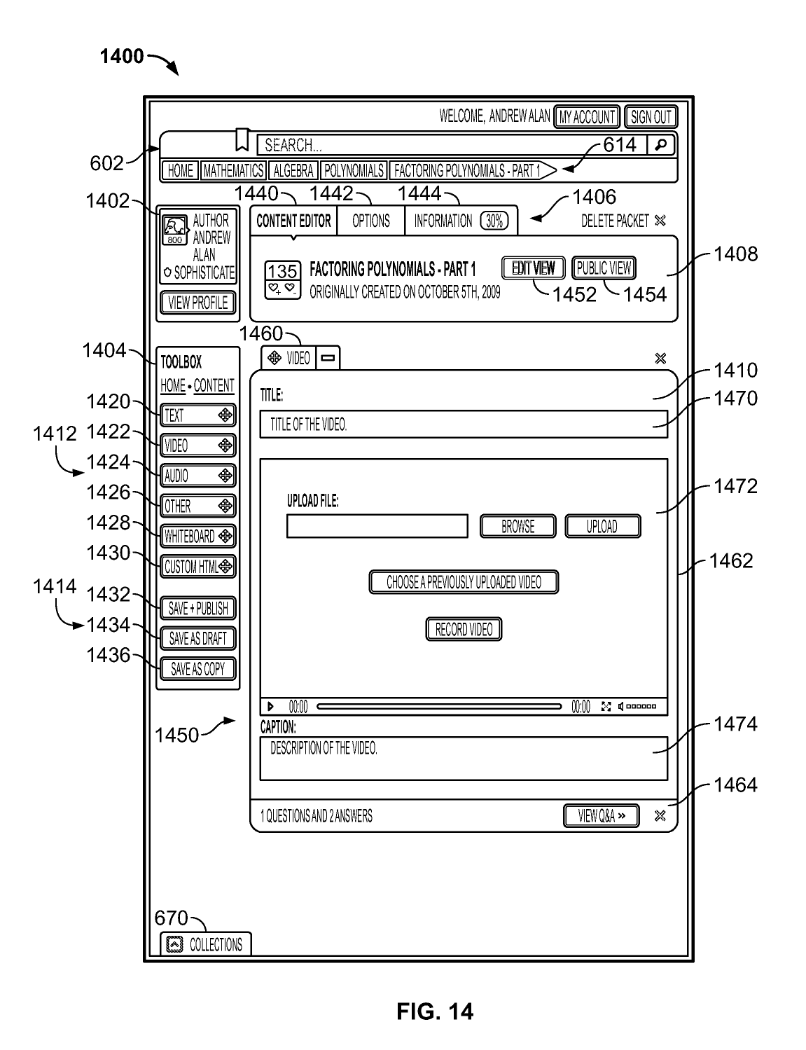

When a user wants to create a new learning packet, create new packet control 702 can be selected to initiate the creation of a new learning packet. Upon selection of the create new packet control 702, learning packet management module 304 initiates the creation of a new learning packet, such as shown in FIG. 14.

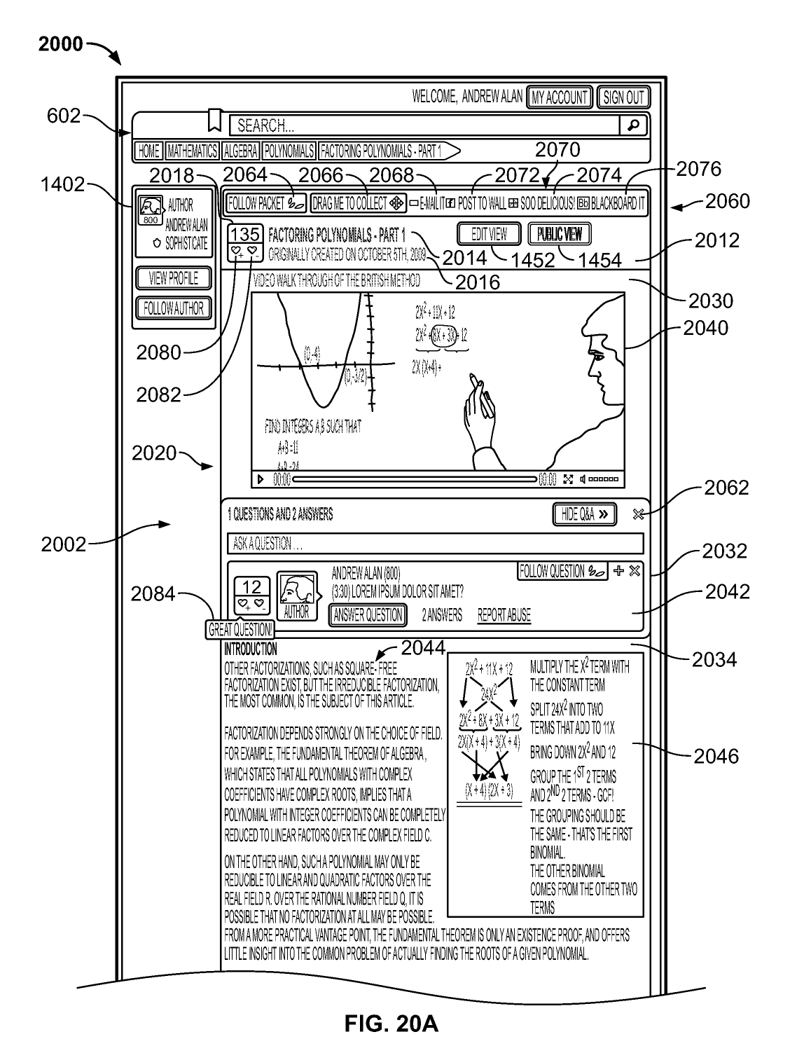

Learning packets that have already been created are displayed in learning packet list 704. In this example, the user (620) has already authored five learning packets. A brief summary of each learning packet is displayed in the associated summary windows 710, 712, 714, 716, and 718, which can be selected by the user to view the associated learning packet, such as shown in FIG. 20.

Various information about each learning packet can be displayed in summary windows 710, 712, 714, 716, and 718. In this example, the information includes a quality score 720, a thumbnail image 722, and a brief description 724. Quality score 720 is, for example, a score assigned to the learning packet by the quality and reputation management module 310, shown in FIG. 3. The score is computed, for example, to provide an indication of the relative quality of the learning packet, as compared to other learning packets within learning system 100. Brief description 724 includes, for example, the title 504 of the learning packet, one or more timestamps 505, and a selection 726 of the content of the learning packet. In some embodiments, the arrangement of summary windows within learning packet list 704 can be rearranged by selecting a move icon 728 associated with the desired summary window and dragging the summary window to the desired location within learning packet list of 704.

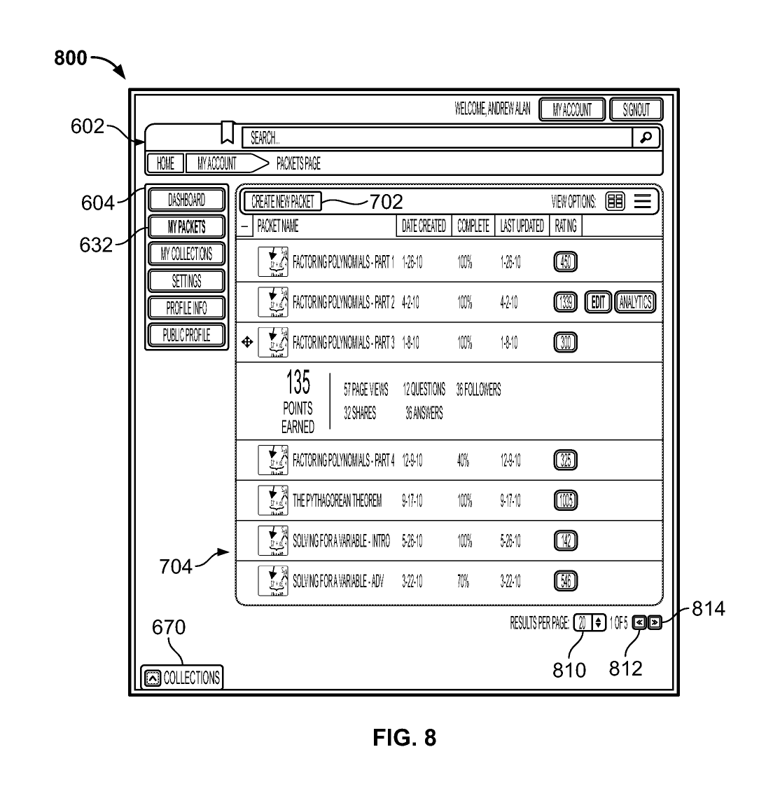

FIG. 8 is a screenshot of another example packets page 800. Similar to packets page 700, packets page 800 also includes a create new packet control 702 and learning packet list 704. In this example, the learning packet list 704 displays a different set of information for each learning packet in the list, such as a name or title of the learning packet, date of creation of the learning packet, percent completion of the learning packet, date of last update of the learning packet, and rating of the learning packet. Upon selection of a summary window, the summary window expands to display additional information, such as the number of points that have been earned with the learning packet, number of times the learning packet has been viewed, number of times the learning packet has been shared with others, number of questions that have been asked, number of answers that have been entered, and the number of users that are following the learning packet.

Learning packet list 704 also includes sort bar 802 that allows the learning packet list to be sorted in various orders. For example, sort bar 802 can be selected to sort the packets in various orders, such as alphabetically by name, chronologically by date of creation, by percent of completion, chronologically by date of last update, or by a rating or score associated with the learning packet.

In some embodiments the number of packets shown per page can be adjusted with pull-down list 810. Navigation between multiple pages is accomplished using navigation buttons 812 and 814.

FIG. 9 is a screenshot of an example collections page 900. In this example, collections page 900 includes header 602, navigation window 604 (including selectable control 634), and collections window 902. Collections window 902 includes previously defined collections 904, 906, and 908, as well as new collection creation control 910. In some embodiments, collections are managed by content collections management module 308 (shown in FIG. 3), which stores links to such collections in content collections data 424 and associates the collections with the user who defines them.

In some embodiments, collections page 900 allows the user to view and manage the user's learning packet collections, or to make new learning packet collections. Collections provide a way for users to store links to selected learning packets so that they can be quickly and easily located again in the future. In addition, collections allow users to store the links to the learning packets in logical groups. For example, a collection may include links to a group of learning packets all relating to a similar topic, such as a class that the user is taking, or a particular topic within a class, or another topic of interest to the user. Collections can also be used to store links to a set of favorite learning packets that have been found, store links to a set of learning packets that the user would like to review in more detail in future time, or for a variety of other purposes.

In this example, the user (620) has previously defined three collections of learning packets, including algebra 101 collection 904, look at later collection 906, and favorites collection 908. Each of the three user-defined collections includes a set of learning packets. For example, algebra 101 collection 904 includes three learning packets, look at later collection 906 includes to packets, and favorites collection 908 includes 12 packets.

New collections can also be defined by the user by selecting new collection creation control 910. For example, when the new collections creation control 910 is selected be content collections management module 308 (shown in FIG. 3) performs operations to generate a new collection and receives input from the user to define the content of the collection. More specifically, in some embodiments, content collections management module 308 prompts the user to provide a name and description for the collection, and then to identify one or more learning packets to be associated with the new collection. The user can identify learning packets in a variety of different ways, such as by browsing and selecting the desired learning packets, providing an identifier (URL, learning packet ID number, etc.) of the learning packet, or performing a search to find the learning packet.

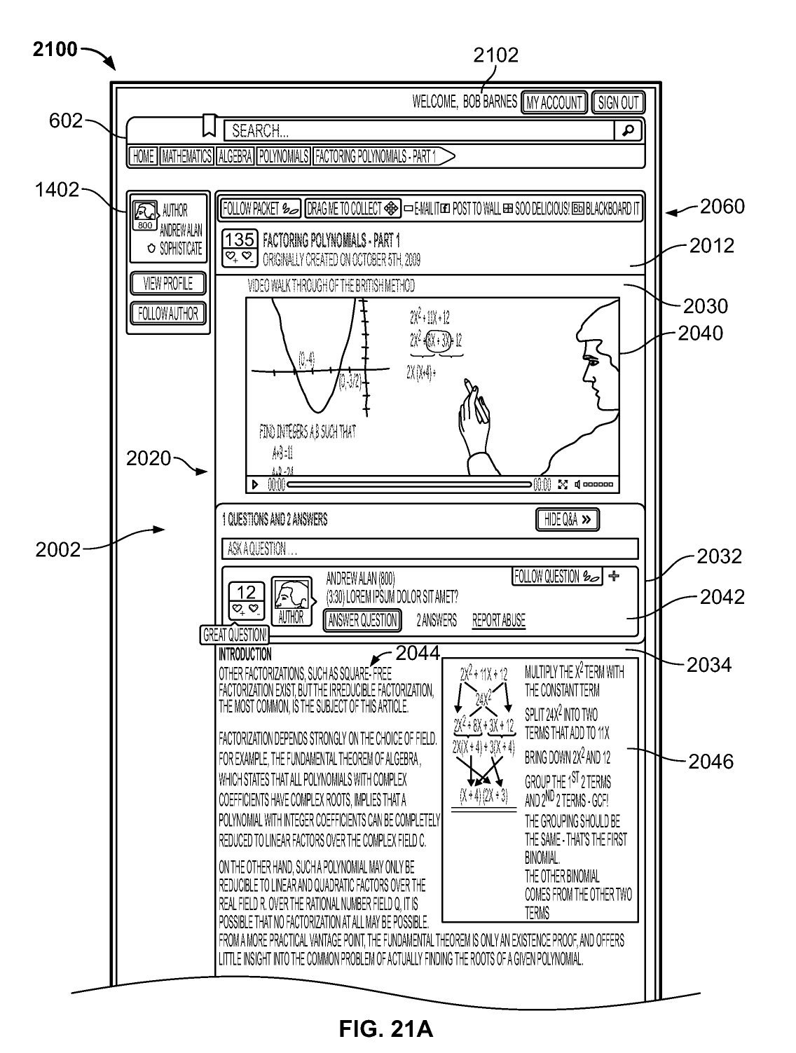

As discussed in more detail herein, collections are also accessible, in some embodiments, through collections tab 670 that appears toward the bottom of various pages within learning system 100. An example collections window is shown in FIG. 22.

FIG. 10 is a screenshot of an example settings page 1000. In this example, settings page 1000 includes header 602, navigation window 604 (including selectable control 636), collections tab 670, and settings window 1002. In some embodiments, information within settings window 1002 is segmented onto separate displays, which can be toggled by selecting the respective tab, such as tabs 1004 or 1006.

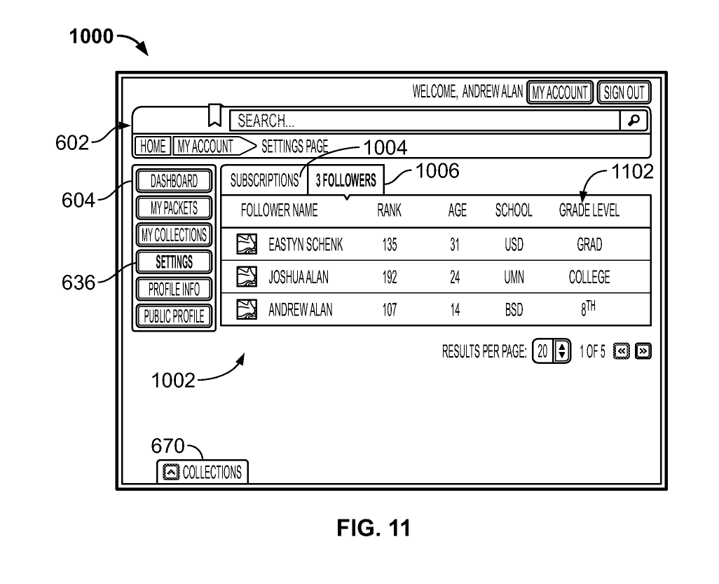

In this example, two tabs are provided. Tab 1004 can be selected to display and manage subscription information. Tab 1006 can be selected to view a list of people that have subscribed to the current user. FIG. 10 shows settings page 1000 when the subscriptions tab 1004 is selected, while FIG. 11 shows settings page 1000 when the followers tab 1006 is selected.

When the subscriptions tab 1004 is selected, settings window 1002 displays various subscription settings and permits the user to update and manage such subscriptions. In this example, settings window 1002 includes automatic subscription options 1010, learning packet subscription list 1012, question and answer subscription list 1014, and user subscription list 1016. In some embodiments, subscriptions are stored in subscription and event data 434. Alternatively, or in addition, subscriptions can be stored in user data 422.

In some embodiments, learning system 100 includes options to permit a user to automatically subscribe to certain content. To do so, the user selects the desired option from automatic subscription options 1010, for example. In this example, automatic subscription options include an option to automatically notify the current user of answers to questions that have been asked by the current user, and an option to automatically notify the current user of any activity on threads that the user has posted to. Other embodiments include other automatic notifications or automatic notification options.

In this example, subscriptions are segmented into different types of subscriptions, based upon the scope of the subscription. For example, some embodiments allow a user to subscribe to particular users, in which case the current user will be notified when an event occurs within the learning system 100 involving that user, such as the publication of a new learning packet; updating of an existing learning packet; providing a comment, question, answer, or other form of discourse within learning system 100; obtaining a new achievement, recognition, or score within the learning system 100; beginning to follow another user; using a functional add-on; updating the user's personal profile; or a wide variety of other possible events. Some embodiments allow a user to subscribe to individual learning packets, in which case the current user will be notified when an event occurs involving that learning packet. Examples of learning packet events include the updating of the learning packet by the author, the posting of a new question or answer within a learning packet, a change in quality rating or score of the learning packet, or a variety of other possible events. Further, in some embodiments portions of a learning packet can be followed by a user without following an entire learning packet. For example, if a user submits a question on a given learning packet, the user can subscribe to the question (either through the automatic subscription option 1010 or by manually subscribing to the question) so that the user is notified when another user has posted an answer to the question. This allows the current user to be notified only when the particular information of interest is provided, without bothering the user with notifications that are less likely to be of interest to the user, such as when another question is posted on the learning packet, or when the learning packet in general has been updated, etc.

In the example illustrated in FIG. 10, subscriptions are shown in three sections: learning packet subscription list 1012, question and answer subscription list 1014, and user subscription list 1016. The learning packet subscription list 1012 shows the set of learning packets that the user is currently subscribed to. For example, the current user is subscribed to three learning packets, as represented by the three lines shown in subscription list 1012. Each line of the subscription list displays information about the subscription, such as a name of the learning packet, an author of the learning packet, and a rating of the learning packet.

The question and answer subscription list 1014 shows the set of questions within one or more learning packets that the user is currently subscribed to. For example, the current user is subscribed to two questions in two different learning packets represented by the two lines shown in subscription list 1014. Each line of the subscription list displays information about the subscription, such as the question that is being followed, the author of the question, and the name/title of the learning packet that the question is in.

The user subscription list 1016 shows the set of users that the user is currently subscribed to. For example, the current user is subscribed to four users, represented by the four lines shown in subscription list 1016. Each line of the subscription list displays information about the subscription, such as the name of the user that is being followed, and the rating of that user within learning system 100.

If a user desires to cancel a subscription, a cancel button 1020, displayed adjacent to each subscription line in the subscription list, can be selected to delete the subscription from the respective subscription lists 1012, 1014, or 1016. Other subscription management features are provided in other embodiments.

FIG. 11 is another screenshot of the example settings page 1000, in which a followers tab 1006 is selected to show a list of followers 1102 of the current user. In this example, settings page 1000 includes header 602, navigation window 604 (including selectable control 636), collections tab 670, and settings window 1002.

Followers tab 1006 is selected to show list of followers 1102. List of followers 1102 displays the set of users that are following the current user. For example, the current user has three followers, as represented by the three lines shown in list of followers 1102. Each line of the list of followers 1102 displays information about the user that is following the current user, such as the name of the user, the rank of the user, the age of the user, the school that the user is associated with, and the educational level of the user. Other embodiments display other information about the users.

Some embodiments permit an author to control who can be a follower of the author's content. For example, in some embodiments access control module 312 (shown in FIG. 3) of learning system 100 sends a follow authorization request to a user when another user indicates a desire to follow that user's content. The user can then accept or decline the request, and following commences only if the user accepts the request. In other words, event management module 334 operates to send notifications to a following user only if the following user has been authorized to receive such notifications from the user whose content is to be followed.

FIG. 12 is a screenshot of an example profile page 1200. In this example, profile page 1200 includes header 602, navigation window 604 (including selectable control 638), collections tab 670, profile information window 1202, and save profile control 1204. Profile information window includes personal information section 1210, password section 1212, education section 1214, honors or awards section 1216, group affiliations section 1218, organizational affiliations section 1220, subjects section 1222, and educational level section 1224.

Profile page 1200 is configured to receive personal information from a current user and to display that information to the user. In some embodiments, information entered into profile page 1200 is stored in user data 422 (shown in FIG. 4) by user management module 306 (shown in FIG. 3).

In some embodiments, profile page 1200 is similar to or the same as a page that is initially provided to a new user during a registration process to obtain personal information about the user. In order to ensure that all personal information provided by a user is only used for purposes that the user has consented to, all personal information is carefully managed and controlled according to a clearly defined privacy policy.

Some examples of personal information stored by learning system 100 are shown in FIG. 12. Personal information section 1210 includes personal information, such as image 1230, first and last name, e-mail address, and date of birth. Image 1230 is, for example, a picture of the user, or another image provided by or selected by the user to be associated with the user's profile. Image 1230 is displayed in various pages, such as at least some of those discussed herein, and adjacent to content or notifications relating to that user. To select or change the image, the user can select control 1232 to initiate a change personal image operation. Upon selection of the control 1232, the user is prompted to identify a desired image or photograph to serve as the personal image in learning system 100. Other personal information can be entered or adjusted by typing the information into the respective field of personal information section 1210.

Password section 1212 permits a user to change passwords, such as by entering the current password and then entering a desired new password. In some embodiments the new password must be entered twice, so that learning system 100 can compare the entries and confirm that the two entries match. If they do not match, the user is prompted to re-enter the password.

Education section 1214 contains information about the educational level of the user, such as a list of degrees that have been achieved (i.e., Master of Science in Education, Bachelor of Science in Mathematics, etc).

Honors or awards section 1216 contains information about the honors or awards that the user has obtained, such as being on the Dean's List, having graduated with honors (e.g., magna cum laude), or having achieved another honor or award.

Group affiliations section 1218 contains information about the user's group affiliations. Examples include a membership in an honor society; membership in a trade, industry, or academic association; or other group affiliations.

Organizational affiliations section 1220 contains a list of organizational to which the user is associated. Examples of organizations include academic institutions that the user has attended or graduated from, academic institutions that the user teaches at or has taught at in the past; companies that the user has worked for, or other educational affiliations.

Subjects section 1222 contains a list of subjects or topics that the user is most interested in. In another possible embodiment, subjects section 1222 contains a list of subjects that the user is considered to be an expert in (or considers himself or herself to be an expert in).

Educational level section 1224 includes a drop-down menu from which the user can select the highest level of education that has been achieved by that user.

In some embodiments, information entered into one or more of personal information sections 1214, 1216, 1218, 1220, 1222, and 1224 are required to conform to a predefined taxonomy, such as defined by taxonomy data 442 (shown in FIG. 4). As one example, the current user viewing profile page 1200 would like to add an additional organization to organizational affiliations section 1220. As shown, the user has begun typing the name of the organization into the section, and has typed “Univ.” As text is being entered, taxonomy translation module 324 (shown in FIG. 3) utilizes search data 430 (shown in FIG. 4) including search index 440 and taxonomy data 442 to suggest possible entries. In the illustrated example, taxonomy translation module 324 has found one possible match (“University of Minnesota Moorhead”) and has generated a suggestion control 1242 to show that possible match. If the suggestion control 1242 contains the correct entry, the user can select suggestion control 1242 to select that entry. Upon selection of the suggestion control, the entry is input into the field for that section. In some embodiments, learning system 100 requires entries into at least some fields to be selected from a predefined set of possible entries defined by taxonomy data 442. In other embodiments, if an entry cannot be found within taxonomy data 442, the user can manually enter the information.

In some embodiments, the taxonomy translation module 324 provides the advantage that certain information entered into learning system 100 conforms to a standard set of language defined by taxonomy data 442. This provides various benefits, such as improved searching capabilities. For example, if a user searches for all users that have attended a particular school, the search results provided by learning system 100 are improved by having a uniform name for the school (e.g., University of Minnesota), rather than allowing each user to manually enter different variations of the name (e.g., U of MN, U of M, University of MN, etc.). Although described here with reference to the profile page 1200, similar data entry techniques are used in other areas of learning system 100 as well, such as to increase uniformity of data entry from the various users of learning system 100. In some embodiments the transformation from a user's manual entry to the standardized form of that entry is performed automatically, without requiring the user to select the correct transformation from a list of possible entries. The standardized form is then stored in computer readable storage media for subsequent use by learning system 100.

In some embodiments, additional information is included in personal profile page 1200. Several examples include a biography of the author, a URL to the author's personal (or professional) web page, a third-party URL or username (e.g., Twitter, Facebook®, etc.).

After data has been entered or modified, save profile control 1204 is selected to save the changes to computer readable storage media.

FIG. 13 is a screenshot of an example public profile page 1300. In one example, the public profile page 1300 can be accessed by selecting the public profile control 640 (such as shown in FIG. 6). In some embodiments each user has a public profile page 1300 in learning system 100. The example shown in FIG. 13 illustrates a current user's view of his or her own public profile page 1300. However, it is recognized that other users can similarly view the public profile page 1300.

In this example, public profile page 1300 includes header 602, user statistics window 608, profile window 1302, top packets list 1304, followers list 1306, discourse window 1308, guide window 1310, and collections tab 670. Other embodiments include other windows and data in public profile page 1300. In some embodiments information is arranged on page 1300 in multiple columns, such as including a left (or right) sidebar 1320 and a main window 1322.

Left sidebar 1320 includes user statistics window 608, profile window 1302, guide window 1310, and collections tab 670. Main window 1322 includes top packets list 1304, followers list 1306, and discourse window 1308. Other embodiments include other arrangements of windows and data.

In some embodiments, user statistics window 608 includes one or more of the following examples: user name 1330, a recognition region 1332 for display of graphical representations or text descriptions of user achievements within learning system 100, the user's image 1230, a user rating 1334, and statistics 1336. Examples of user statistics 1336 include number of profile views, number of recent profile views, number of achievements attained or awards earned within learning system 100, a number of learning packets authored, a number of points that have been earned, a total number of views for all learning packets authored, or a wide variety of other statistics. In some embodiments, learning system 100 includes various achievements that can be obtained by users that are not generally publicized or likely to be expected by the users. Such achievements are sometimes referred to herein as Easter egg achievements. In some embodiments the user is further awarded for obtaining the achievement, such as by increasing the user's point score, displaying an achievement badge for the user, providing a monetary award, providing a coupon or gift card redeemable for products, merchandise, or services, etc.

Profile window 1302 displays information from the user's personal profile, such as provided by the user with profile page 1200 (shown in FIG. 12) and stored in user data 422 (shown in FIG. 4).

Top packets list 1304 is a list of packets that have been authored by the user. In this example, only a selection of the top rated packets is shown. The top packets list 1304 includes, for example, a separate line for each learning packet identified. Each line includes information about each learning packet, such as a quality score, a thumbnail image, a title, a timestamp (e.g., the date of creation, the date of last update, etc.), a brief description or portion of the content, a number of followers, an indication of the quantity of discourse (e.g., number of questions asked, number of comments posted), or other information.

Followers list 1306 is a list of some or all of the users that are following the user. In this example, each follower is identified on a separate line. Each line includes information about the respective user, such as the user's image, name, rank, score, points, age, school, grade level, affiliations, organizations, or other information about the user.

Discourse window 1308 is provided in some embodiments to provide a region for a verbal exchange of ideas, such as relating to that particular user. For example, discourse window 1308 is a region where another user can post a question for that user, such as a request for the user to create a learning packet on a particular topic. In another example, discourse window 1308 is a region where another user can post a comment (e.g., “keep up the good work”), a recommendation, (e.g., “a real expert in environmental engineering,” “I highly recommend his learning packet on calculus for anyone that has taken the course but wants a refresher,” “I purchased his learning packet titled ‘summary of advanced thermodynamics—chapter 2’ and found the discussion of heat transfer to be very helpful in studying for the final exam”), or even a critique (e.g., “his learning packets are disorganized and unhelpful”).

In some embodiments, the user identified in user statistics window 608 is permitted to edit information appearing in public profile page 1300. For example, if the user wants to remove a question or comment, the user can delete the comment by selecting the delete button 1340. However, in some embodiments certain content cannot be edited by the user, such as to preserve another user's ability to criticize or critique the user. For example, in some embodiments only the personal profile information can be edited, such as through profile page 1200 (shown in FIG. 12).

Guide window 1310 is provided in some embodiments to guide the user through new content in public profile page 1300 (or other pages of learning system 100), or distributed among multiple pages. Guide windows are discussed in more detail herein.

In some embodiments, new content is emphasized in public profile page 1300 (or other pages of learning system 100), such as with new content flags 1342. In one embodiment, new content is any content that has been recently added (e.g., content added in the past day, week, month, year, etc.) In another embodiment, new content is any content that has been added since the user last accessed learning system 100, or since the user has last viewed the respective page (e.g., public profile page 1200).

In some embodiments, discourse provided in discourse window 1308 can be followed. To do so, the follow control 1344 is selected, such as to subscribe to a particular question, or to subscribe to the entire discourse window 1308.

FIGS. 14-19 illustrate an example of a learning packet creation module, such as provided in some embodiments by the learning packet management module 304 (shown in FIG. 3). The learning packet creation module guides the user through the creation of a new learning packet. Subsequent editing and updating of a learning packet is also performed through the learning packet creation module in some embodiments.

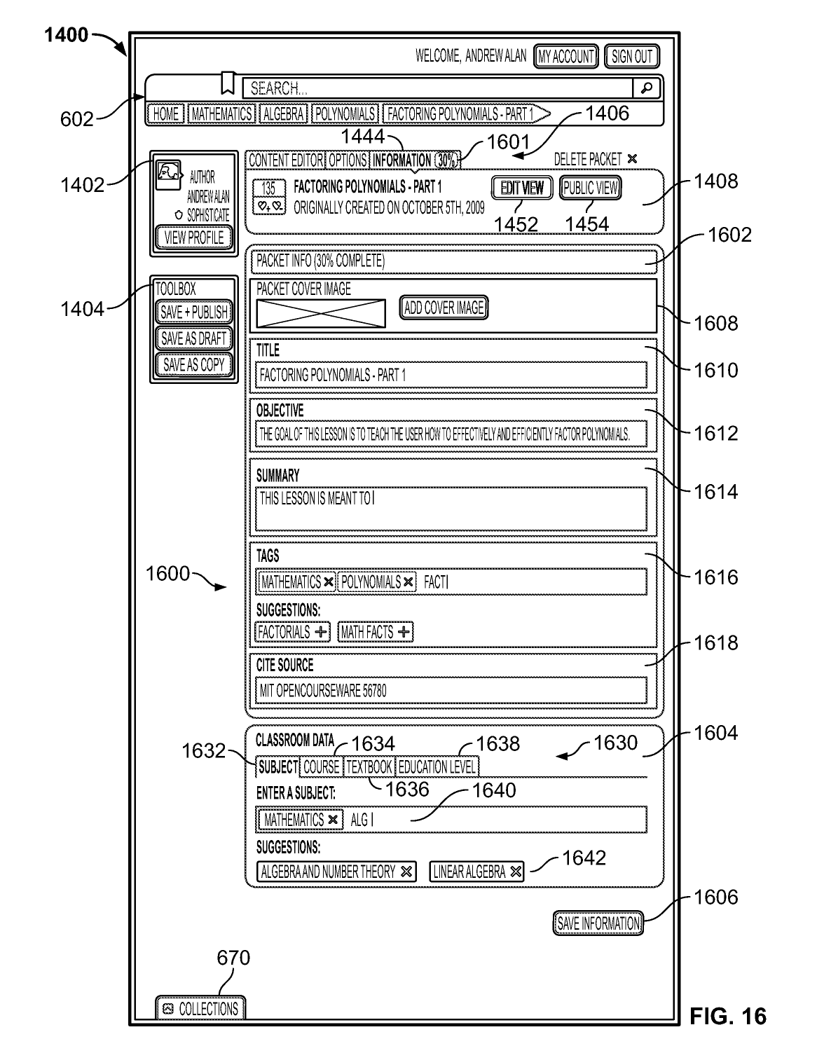

To create a new learning packet in learning system 100, a user needs to first indicate a desired to create the new learning packet. In one embodiment, the user can initiate the creation of a new learning packet through packets page 700 (shown in FIG. 7). More specifically, the user selects the create new packet control 702 to initiate a learning packet editor, such as shown in FIG. 14. In some embodiments, the learning packet editor first prompts the user to enter a title for the new learning packet. Further, in some embodiments, the learning packet editor prompts the user to classify the learning packet, such as by entering information about the subject or topic to which the learning packet pertains. In some embodiments, the learning packet editor first displays an information window 1600 (described in more detail herein with reference to FIGS. 16-19), which receives the title and other information about the learning packet from the user. The learning packet editor then proceeds to receive additional information from the user to generate the learning packet, as discussed in more detail below.

FIG. 14 is a screenshot of an example learning packet editor page 1400. In this example, learning packet editor page 1400 includes header 602, author information window 1402, toolbox 1404, navigation tabs 1406, title bar 1408, and content section 1410. Toolbox 1404 includes pallet controls 1412, such as text control 1420, the video control 1422, audio control 1424, other control 1426, whiteboard control 1428, and custom HTML control 1430; and storage controls 1414, such as save and publish control 1432, save as draft control 1434, and save as copy control 1436. Navigation tabs 1406 include content editor tab 1440, options tab 1442, and information tab 1444. Title bar 1408 includes edit view control 1452 and public view control 1454. An example of content section 1410 is a video content section, including position control 1460, content region 1462, and discourse region 1464. The example content region 1462 includes title field 1470, video selection field 1472, and description field 1474.

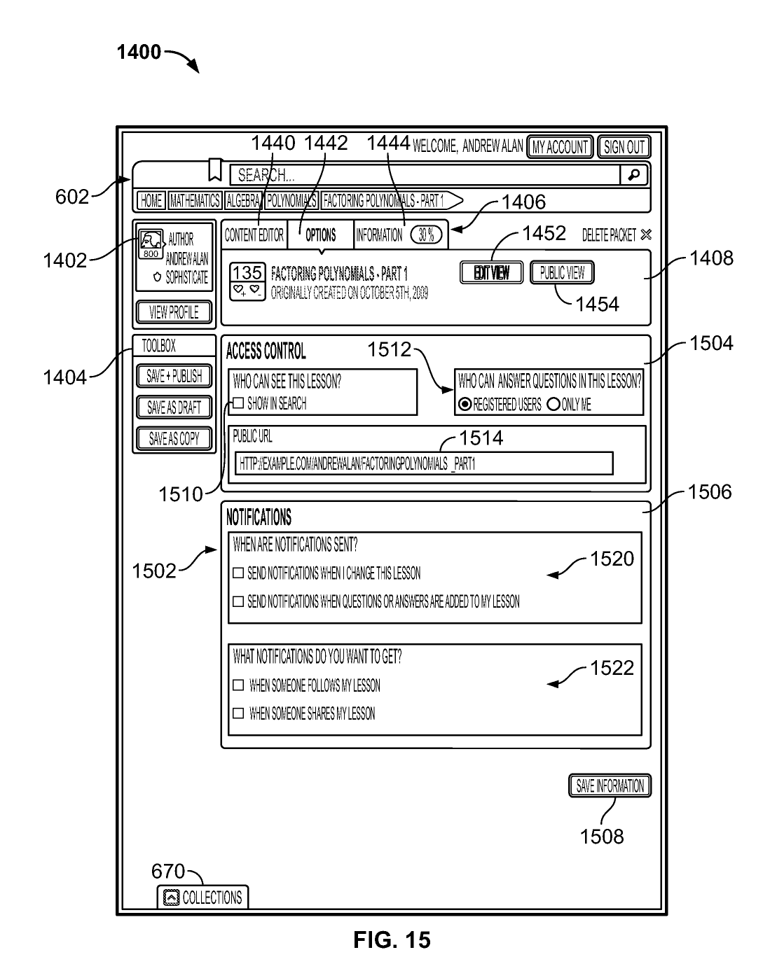

The example shown in FIG. 14 illustrates the learning packet editor page 1400 when the content editor tab 1440 is selected. FIG. 15 illustrates the learning packet editor page 1400 when the options tab 1442 is selected. FIGS. 16-19 illustrate the learning packet editor page 1400 when the information tab 1444 is selected.

With continued reference to FIG. 14, author information window 1402 displays information about the author of the learning packet. In some embodiments, multiple users can collaborate to create a learning packet. For example, in some embodiments author information window 1402 includes an invite additional author button, which when selected, allows the current user to identify one or more additional authors that are permitted to use the learning packet editor page 1400 to collaborate on the creation of the learning packet. The invitation is then sent to the identified users. If those users consent to being added as an author of the learning packet, those users are added to the author information window 1402. In some embodiments, a control is also provided in author information window 1402, which is linked to the author's public profile page. The control can be selected to view the author's respective personal profile page to view additional information about that author.

In some embodiments, learning packet editor page 1400 includes toolbox 1404 which provides various tools that assist an author in the creation of a new learning packet. In this example, toolbox 1404 is displayed within a sidebar of learning packet editor page 1400, such as the left sidebar. Toolbox 1404 includes content section, pallet controls 1412, and storage controls 1414.

Content section pallet controls 1412 can be selected by a user to insert a content section associated with the selected control into content editor window 1450. Examples of content section pallet controls 1412 include text control 1420, video control 1422, audio control 1424, other control 1426, whiteboard control 1428, and custom HTML control 1430.

In the example shown in FIG. 14, the author has already selected video control 1422, to insert video section 1410 into content editor window 1450. In some embodiments, the content section pallet controls 1412 can be selected, and upon selection, the associated content section is inserted below any existing content in content editor window 1450. In some embodiments, content sections, such as video section 1410 include a position control 1460 that allows the user to adjust the position of the section within content editor window 1450. For example, position control 1460 can be selected with a pointer to drag and drop the video section 1410 to a desired position within content editor window 1450, such as above or below other sections. In another possible embodiment, content section pallet controls 1412 can be selected with a pointer to drag and drop the associated section to a desired position within content editor window 1450 directly. Subsequent position changes can be made using position control 1460.

Text control 1420 can be used to insert a text section into content editor window 1450. A text section is configured to receive text-based content. For example, in some embodiments text section provides a text editor that receives input from the user to define the text-based content. In some embodiments, the text editor includes controls that allow the user to define formatting of the text (e.g. font size, font color, font style (bold, italics, underline, etc.), paragraph spacing, line spacing, indentation, outline bullet format, hyperlinks, etc.). In some embodiments, the text section will only receive text inputs for inclusion in the content of the text section. However, in other possible embodiments, text section allows additional content types to be inserted in addition to text content, such as one or more images. The text content is stored in learning packet content 420 (shown in FIG. 4).

In addition to text sections, some embodiments further include text templates. Text templates can be inserted into a text section, for example, to further assist in the creation of a content element of a learning packet. An example of a text template is a set of headings, such as arranged in an outline form, that guide the user to enter text below each heading. Text templates are used in some embodiments to incorporate commonly used text or paragraphs. Another example of a text template is a form that can be subsequently completed by the user to complete the definition of the content element. In some embodiments, a user (e.g., an administrator, or group moderator, etc.) can specify that a certain template must be used when defining a content element to increase uniformity within a set of content sections or set of learning packets. In some embodiments, text templates are automatically included in text section templates.

Video control 1422 can be used to insert a video section 1410 into content editor window 1450, such as shown in FIG. 14. In this example, video section 1410 includes content region 1462 and discourse region 1464.

Referring briefly back to the example learning packet 500 shown in FIG. 5, content region 1462 is provided to define content 514 to be displayed within content window 510 of the learning packet 500. Discourse region 1464 is provided for discourse 516 of discourse window 512 of the learning packet 500.

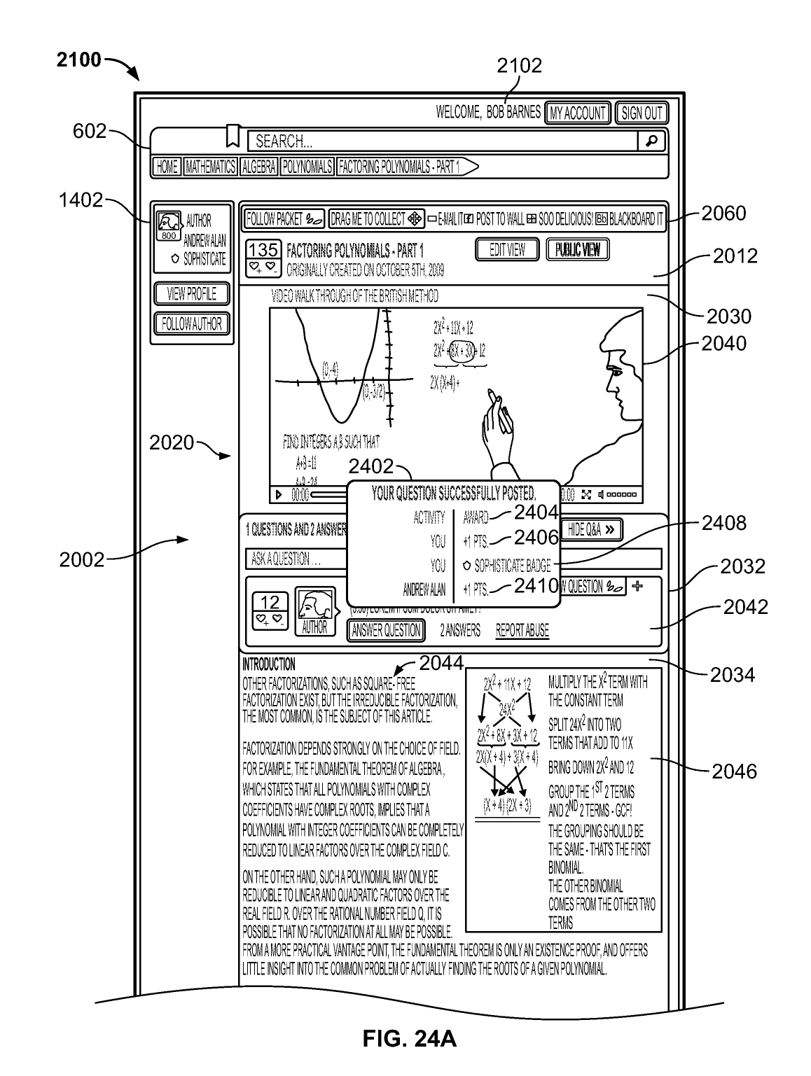

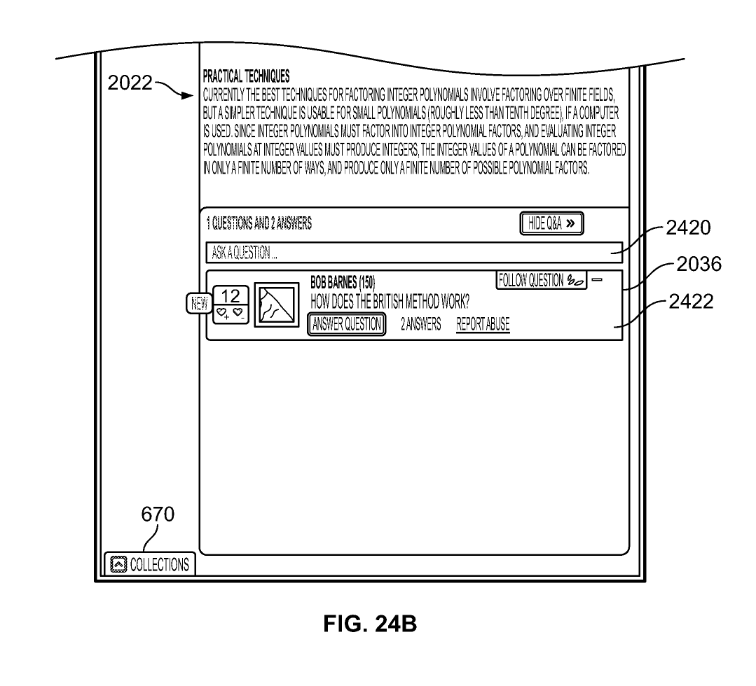

Returning to the example shown in FIG. 14, content region 1462 includes title field 1470, video selection field 1472, and description field 1474. A brief title for the video is provided into title field 1470. Video selection field 1472 is used to identify and upload a video. For example, the user can identify a video by browsing and identifying a video file, and then uploading the video file to learning system 100. In another possible embodiment, the user can select a previously uploaded video, such as from media bucket window 2702, illustrated and described herein with reference to FIGS. 27-28. In another possible embodiment, a video recording module is provided to allow a user to record a new video, such as through a video camera connected to the users computing device (e.g., one of input devices 230, shown in FIG. 2). In some embodiments, the video recording module is provided by a third-party, such as functional add-on provider 132 (shown in FIG. 1). A brief description of the video can be provided into description field 1474. The video content (including the associated title and brief description) is then stored in learning packet content 420 (shown in FIG. 4). Another possible embodiment includes a screen capture tool that operates to capture a user's screen as the user is manipulating it. Sound can also be recorded at the same time. For example, the screen capture tool can be used to capture screen shots of a user's screen while the user is drawing on a tablet computer. The resulting video can then be stored as content, along with an audio recording, if audio was also recorded.

Discourse region 1464 is initially a placeholder where future discourse will be displayed in the learning module. However, after the learning module has been published, discourse region 1464 can provide a brief summary of the discourse, such as when the user is editing the learning packet using the learning packet editor shown in FIG. 14. The example illustrates one possible embodiment of how such discourse can be summarized in discourse region 1464, such as by showing the number of questions that have been asked or the number of answers that have been received. A selectable control is provided to allow the author to view the discourse, if desired.

Audio control 1424 can be used to insert an audio section into content editor window 1450. An audio section is configured to receive audio content. In some embodiments, the audio section includes an audio recorder that permits the user to make a new audio recording, such as through microphone 238 connected to the users computing device. In some embodiments, the audio recorder and the third-party recorder, such as provided by functional add-on provider 132. Audio content is then stored in learning packet content 420 (shown in FIG. 4

Although audio and video may be initially stored in audio or video formats, some embodiments include an audio-to-text transcription engine to transcribe audio into a text format that can be stored by learning system 100, and associated with the learning packet. The text allows learning system to perform keyword searches of the audio and video content to identify content that may be relevant to a search query, for example. Accordingly, the text is indexed within data store 112 in some embodiments. Identification of text in other content types can also be performed, and the text then indexed in data store 112. For example, text within images or slide shows can be identified using optical character recognition software.

Other types of content can be provided through other control 1426, in some embodiments. Some further examples of possible content types include a file attachment window that an author can use to upload various files (worksheets, handouts, readings, etc.) for the consumer to download and consume; an images window where the author can upload multiple pictures; a flash cards window for generating and displaying graphical representations of flash cards; a graph window for graphing mathematical concepts, which may or may not be interactive; and a drawing or painting window for drawing diagrams or other images.

Some embodiments of the learning packet editor include additional tools, such as for providing content in other forms. One example of this is illustrated by whiteboard control 1428, which can be used to insert a whiteboard section into content editor window 1450. The whiteboard section provides a whiteboard tool that can be inserted into a learning packet. In one example, the whiteboard tool is a program that permits the author to graphically illustrate concepts being taught in the learning packet 500. In some embodiments, whiteboard tool is a collaborative tool they can be used by multiple authors.

Whiteboard control 1428 illustrates an example in which a functional add-on (a whiteboard tool) can be provided by a third-party, such as a functional add-on provider 132 (shown in FIG. 1). In some embodiments, the functional add-on is a plug-in that can be installed or configured to operate within learning system 100 by the user. Upon installation or configuration, the functional add-on tool is available within toolbox 1404 for use by the user during the creation of learning packet. In some embodiments, the plug-in includes a link to functional add-on provider 132 that provides the features, functionality, and content that will be displayed within the learning packet 500.

A wide variety of functional add-ons can be provided by third parties that conform to a functional add-on protocol of learning system 100. As another possible example, suppose that an author is creating a learning packet on the topic of geography, and more specifically regarding the names and locations of the 50 states of the United States. A third-party can develop a functional add-on that allows an author to insert a map as content into a learning packet. Further, the functional add-on may provide interactive capabilities, such as to allow the user to zoom in or out of the map, or to pan up, down, or sideways on the map. The functional add-on can be associated with the functional add-on provider 132 which maintains the content (map images), and supplies the content to learning system 100 whenever the learning packet 500 is viewed by a consumer. Another possible example of a functional add-on is a simulation add-on for simulating mathematical or real-world data.

Yet other possible embodiments include other functional add-ons, such as an animation tool for modeling or simulating physical movement (e.g., a swinging pendulum in gravity, movement of a mass coupled to a spring), a tool for graphically depicting chemical reactions or interactions, or a wide variety of other possible functional add-ons. In some embodiments the functional add-ons include interactive components, such as to allow a user to click on a graphical element and move it, to adjust a variable, or to provide other input into the functional add-on. An endless variety of functional add-ons are possible, in addition to those specifically discussed herein.

Another possible example of a content section palette control, is custom HTML control 1430, which is provided to allow a user to insert a custom HTML section into content editor window 1450. The custom HTML section is configured to receive text-based content including markup conforming to a markup standard, such as hypertext markup language. Other embodiments utilize other markup or code standards, such as extensible markup language, JavaScript, etc. Content entered into the custom HTML section is interpreted and displayed within the learning packet 500 according to the standard.

Other embodiments include more or fewer content section palette controls. In some embodiments, the set of content section palette controls displayed in learning packet editor page 1400 are customizable by the user. Various other possible content section controls are provided in other embodiments. An example of another possible content section control is an assessment control associated with an assessment section. The assessment section provides a content section for containing an assessment, such as a multiple choice quiz, an essay test, a short answer test, or other quiz, test, examination, or assessment. Another example of a content section is a slide show section, having a slide show section control associated with it. The slide show section can display a slide deck provided by the user, such as a PowerPoint® slide show.

Storage controls 1414 are provided to allow the user to save the learning packet to learning packet content 420 (shown in FIG. 4), and to control publication of the learning packet. In this example, storage controls 1414 include save and publish control 1432, save as draft control 1434, and save as copy control 1436. Save and publish control 1432 is selected to save the learning packet to computer readable storage media, and to publish the learning packet on learning system 100. Publication of a learning packet 500, typically means that the learning packet becomes available to others within learning system 100, other than the author or authors. In some embodiments, upon publication of a learning packet, the content of the learning packet becomes searchable, and is included within search index 440 (shown in FIG. 4). Also, in some embodiments, upon publication of the learning packet, event management module 334 evaluates the content of the learning packet and the names of the authors of the learning packet and compares this with subscription and event data 434 to determine whether any notifications should be sent to alert one or more users to the publication of the learning packet.

Alternatively, the author is provided with save as draft control 1434 if the user is not ready to publish the learning packet, but does wish to save the content of the learning packet to computer readable storage media.

Some embodiments also include save as copy control 1436. Save as copy control 1436 permits the user to create a new learning packet based on a previously created learning packet. This is useful, for example, if the user wants to make another learning packet that is similar to a previously created learning packet (e.g., part two of a series of learning packets on a given topic). Upon selection of save as copy control 1436, the user is prompted to enter a new title for the learning packet, and the new learning packet is then saved in computer readable storage media.

In some embodiments, after content, such as a video, has been provided to learning system 100, learning system 100 evaluates the content to determine whether any subsequent processing of the content is desired. For example, in some embodiments, content is processed to reduce file sizes or to convert a file type to a standard file type utilized by learning system 100. The processed data is then stored in computer readable storage media, such as within learning packet content 420.

Title bar 1408 displays, for example, a title of the learning packet. The title of the learning packet identifies one or more topics to be addressed by the content of the learning packet. In some embodiments, the title bar 1408 includes a title input field in which the user can enter or edit the title of the learning packet.

Some embodiments also include edit view control 1452 and public view control 1454. Edit view control 1452 is selected to display the learning packet in the editing view, utilizing learning packet editor page 1400 (currently shown in FIG. 14). Public view control 1454 is selected to display the public view of the learning packet, such as shown in FIG. 20, to allow the user to see approximately how the learning packet will appear to a consumer.

FIG. 15 is a screenshot of the example learning packet editor page 1400 (shown in FIG. 14) after selection of the options tab 1442 of navigation tabs 1406. In this example, learning packet editor page 1400 includes header 602, author information window 1402, toolbox 1404, navigation tabs 1406 (including options tab 1442), title bar 1408, and options window 1502. Options window 1502 includes access control window 1504, notifications window 1506, and save information control 1508.

Options window 1502 is used to receive options settings from the author of the learning packet created through the content editor shown in FIG. 14. In this example, the options settings include access control settings that can be defined within access control window 1504, and notification settings that can be defined within notifications window 1506.

In some embodiments, access control settings are stored as access privileges/group affiliation data 428 in data store 112 (shown in FIG. 4). The access control settings are then used by access control module 312 to determine whether or not a given consumer should be allowed to access the learning packet.

In this example, access control settings include a selectable control 1510, selectable control 1512, and text field 1514.

Selectable control 1510 allows the user to specify whether or not the learning packet should be shown in search results, such as when a keyword search is performed through header 602. If a learning packet cannot be located through a search, in some embodiments the learning packet is only accessible to those that are given the public URL to the learning packet, such as by the author of the learning packet. Such a learning packet is sometimes referred to as a private learning packet. If selectable control 1510 is set to allow the learning packet to be identified in search results, the learning system will index the learning packet within search index 440 (shown in FIG. 4) upon publication of the learning packet. Such a learning packet is sometimes referred to as a public learning packet.

In another possible embodiment, learning packets are assigned to one or more groups, and members of the group are permitted to view the learning packet, while users that are not members of the group are prevented from viewing the learning packet. In some embodiments a user that is not a member of a group can still view the learning packet, such as by purchasing access to the learning packet or to preview the groups learning packets.

Selectable control 1512 allows the user to define access control settings associated with discourse windows (e.g., 512 and 522 shown in FIG. 5). More specifically, in this example selectable control 1512 allows the user to select whether all registered users should be allowed to answer a question posted in the learning packet, or whether only the author should be allowed to answer such questions.

Text field 1514 is provided to define a public URL for the learning packet. The public URL is a unique URL that is associated with learning packet, which a consumer can use to directly access the learning packet from a browser. In some embodiments, the entire public URL can be defined by the author, while in other embodiments only a portion of the URL (e.g., the URL suffix) can be defined by the author (e.g., to provide a unique identifier of the learning packet, or of a user, etc.).

Notifications window 1506 prompts the user to select notification settings associated with the learning packet. In some embodiments, notification settings are stored in subscription and event data 434 (shown in FIG. 4). The notification settings are then used by event management module 334 (shown in FIG. 3) to determine whether or not notifications should be sent when certain events occur relating to the learning packet.

In this example, notification settings include send settings 1520 and receive settings 1522. Send settings 1520 define when a notification should be sent to others within learning system 100. For example, send settings 1520 include an option to send notifications when the author changes the learning packet, or to send notifications when questions or answers are added to the learning packet. Receive settings 1522 define when a notification should be sent to the author. For example, receive settings 1522 include an option to notify the author when another user follows the learning packet, and an option to notify the author when another user shares the learning packet. Other embodiments include other send and receive settings, or other notification settings.

After a user has selected the desired options, save information control 1508 can be selected to store the options to computer readable storage media.

FIGS. 16-19 illustrate learning packet editor page 1400 when information tab 1444 is selected. In this example, learning packet editor page 1400 includes header 602, author information window 1402, toolbox 1404, navigation tabs 1406 (including information tab 1444) title bar 1408, and information window 1600. Information window 1600 includes packet information window 1602, packet categorization window 1604, and save information control 1606. Packet information window 1602 includes cover image window 1608; title window 1610, objective window 1612, summary window 1614, tags window 1616, and citation source window 1618. Packet categorization window 1604 includes navigation tabs 1630. Navigation tabs include subject tabs 1632, course tab 1634, textbook tab 1636, and education level tab 1638.

Information tab 1444 is provided to display an information window 1600 that enables learning system 100 to receive additional information from the author regarding the learning packet that has been created through the content editor shown in FIG. 14. In some embodiments, information tab 1444 displays a status indicator 1601. In this example, status indicator 1601 shows a percentage of completion of the information that has been entered about the learning packet. The percentage of completion can be computed, for example, as the percentage of the total number of available information fields that have been completed by the user.

In this example, information window 1600 includes packet information window 1602, packet categorization window 1604, and save information control 1606. Packet information window 1602 is configured to receive information about the learning packet, such as a cover image in cover image window 1608, a title in title window 1610, an objective in objective window 1612, a summary in summary window 1614, one or more tags in tags window 1616, and one or more citations sources in citation source window 1618. Other embodiments include additional or less information. For example, some embodiments include an estimated time to consume the packet, which provides an estimate of the amount of time a consumer should commit to reviewing the content of the learning packet (e.g., 5 minutes, one hour, etc.). In some embodiments the consumption time is a sum of the play times of the individual content (e.g., audio or video recordings). In some embodiments the consumption time includes an estimated time to consume text. The estimated time to consume text is computed, for example, by multiplying a length of the text (e.g., a number of characters or number of words) by an estimated reading rate (e.g., characters per minute or words per minute). In another possible embodiment, the author provides an estimated consumption time.

The cover image identified in cover image window 1608 is used by learning system 100 as an identifying image for the learning packet. In some embodiments the cover image represents the learning packet, such as in a list of search results or other displayed grouping of learning packets.

In some embodiments, information entered into one or more windows of the packet information window 1602 is required to conform to a predefined taxonomy, such as defined by taxonomy data 442 (shown in FIG. 4). For example, in some embodiments tags in tags window 1616 must be selected from a set of predefined tags. Tags in tags window 1616 are used in some embodiments by search module 314 (shown in FIG. 3) to permit searching for learning modules that include a certain tag or set of tags, or to provide relevant search results (e.g. search module 314 can compare a keyword entered in a search to tags provided in tags window 1616 to identify potentially relevant search results). In other possible embodiments, users can subscribe to tags to be notified, for example, when a learning packet is newly associated with the tag. In addition to the author-defined tags that can be associated with a learning packet through packet information window 1602, consumer users can also tag learning packets with one or more tags.

In some embodiments, learning packets can be associated with one or more citations sources, such as by entering a citation source into citation source window 1618. In one possible example, a citation source is associated with an entire learning packet. In another possible example, citation sources are associated with individual sections to which they pertain. In yet another possible embodiment, citation sources are associated with the specific information that has been cited, such as a quotation, sentence, image, multimedia item, etc. This information can then be used by learning system 100 in a variety of manners. For example, in some embodiments, citation sources are identified in the public view of the learning packet to acknowledge the contribution of ideas or content from a given source. In some embodiments, a citation source is another user of the learning system 100. In this case, learning system 100 can utilize the citation source information to, for example, increase the cited user's reputational score, credit the cited user's account with points as a reward, or to update one or more statistics associated with the cited user. In some embodiments, citation source information is automatically associated with the learning packet by the learning system 100, without the user having to specifically enter the information. For example, in some embodiments, learning system 100 includes the capability to allow an author to create a derivative work based at least in part off of learning packet created by another user. In such a case, learning system 100 can be configured to automatically associate the new learning packet with the original author, such as to credit the original author with the original contributions.

In some embodiments, learning packets are associated with a copyright notice or a copyright license notice. Learning system 100 is configured, in some embodiments, to automatically manage copyright license requirements, such as to conform with a Creative Commons license defined by a user for a learning packet. If a user wants to create a derivative work, for example, the learning system 100 stores the learning packet as a new learning packet, but automatically attributes content from the original author to that author according to the Creative Commons license. In some embodiments derivative works can be created based on an entire learning packet, a section of a learning packet, or a particular media item of a learning packet. In some embodiments, citation sources are stored for an entire learning packet, each section of a learning packet, and/or each media item.

Packet categorization window 1604 enables a learning packet to be associated with classroom data, such as a subject, a course, a textbook, or an education level. In this example packet categorization window 1604 includes navigation tabs 1630, which can be selected by the user for entry of different types of classroom data.

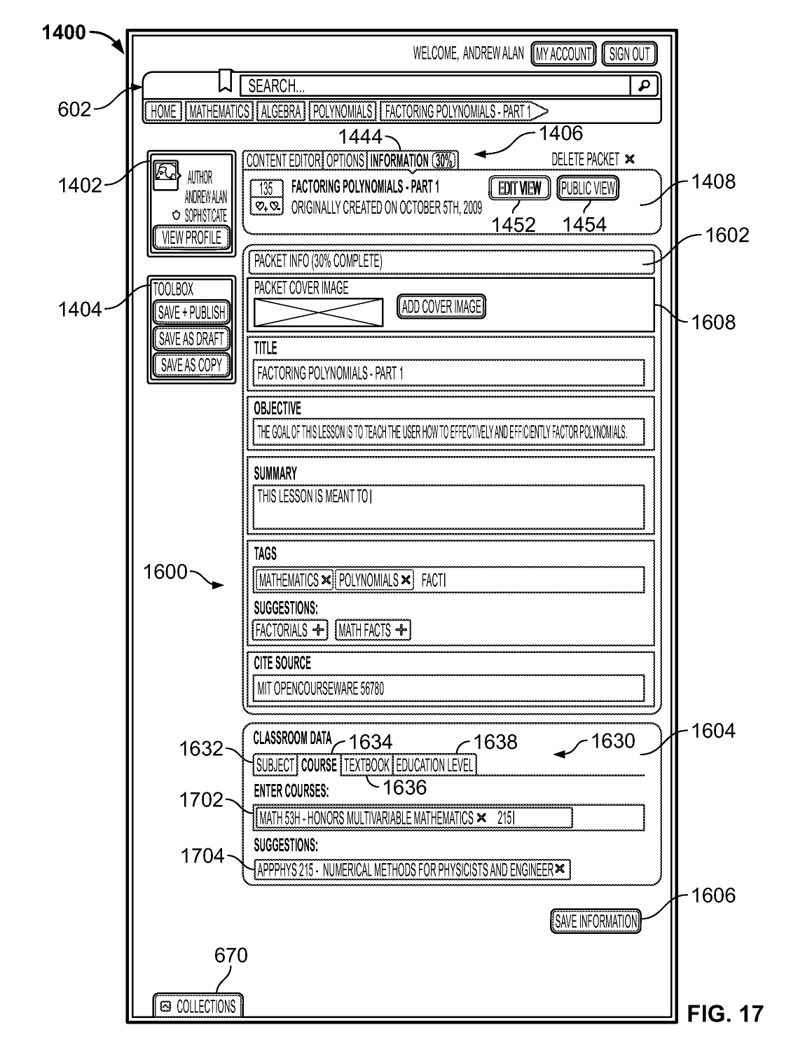

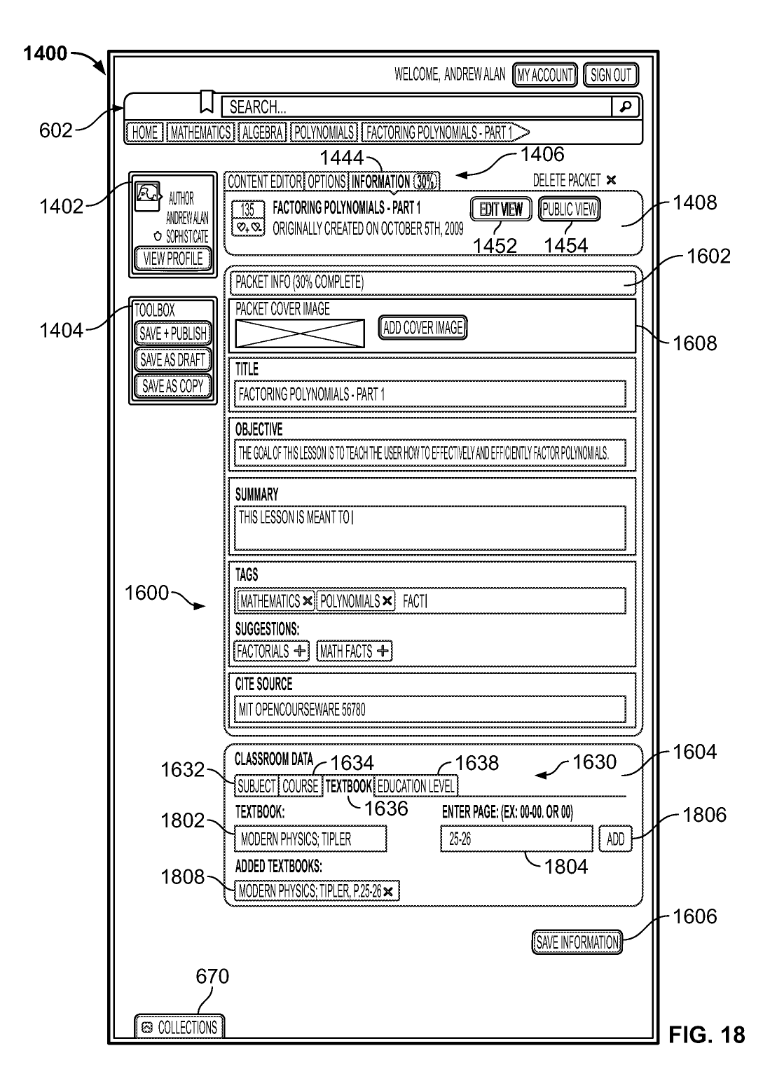

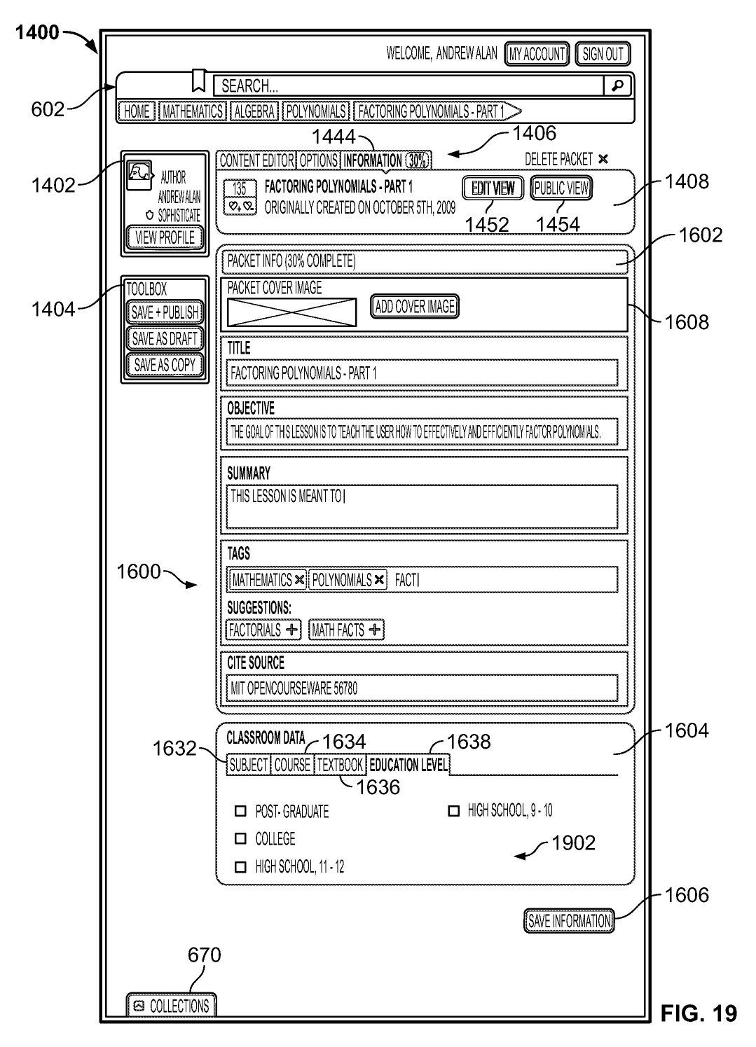

FIG. 16 illustrates learning packet editor page 1400 when subject tab 1632 is selected within the packet categorization window 1604. FIG. 17 illustrates learning packet editor page 1400 when course tab 1634 is selected within packet categorization window 1604. FIG. 18 illustrates learning packet editor page 1400 when textbook tab 1636 is selected within packet categorization window 1604. FIG. 19 illustrates learning packet editor page 1400 when education level tab 1638 is selected within packet categorization window 1604.

To associate the learning packet with a particular subject, for example, subject tab 1632 is selected. The subject can then be entered into subject field 1640. In some embodiments, the subject is required to conform to a predefined taxonomy, such as defined by taxonomy data 442 (shown in FIG. 4), or otherwise be included in a list of available subjects. As the subject is being entered, possible matches found in the predefined taxonomy are shown as suggestions 1642, which can be selected to accept the suggested subject. Several examples of subjects include mathematics, literature, music, art, science, etc. In some embodiments, subjects are academic subjects. In some embodiments, learning packets are associated with zero, one, or more subjects. In another possible embodiment, each learning packet is associated with at least one subject.

FIG. 17 illustrates learning packet editor page 1400 when course tab 1634 is selected. To associate the learning packet with a course, for example, course tab 1634 is selected. The course can then be entered into course field 1702. As with the subject information, discussed above, some embodiments require that the course conform to a predefined taxonomy or otherwise be included in a list of available courses. In some embodiments, learning packets are associated with zero, one, or more courses. In another possible embodiment, each learning packet is associated with at least one course.

In addition, in some embodiments learning packet is also, or alternatively, associated with a particular educational institution where the course is being taught. An additional input field, and/or window, is provided in some embodiments to receive educational institution information and to associate that information with the learning packet.

Course information can be used by learning system 100 in a variety of different manners. For example, in some embodiments course information is used to provide search results based on a query that requests learning packets associated with a given course, educational institution, or course at a specific educational institution. In some embodiments, when the learning packet is published that includes course information, a notification is sent to users that have subscribed to that course, or to users who are identified within learning system 100 as taking (or teaching) the course. In some embodiments, a list of users that are currently taking a course is provided by the educational institution, while in other embodiments individual users must identify themselves as taking the course, such as through a personal profile page.

FIG. 18 illustrates learning packet editor page 1400 when textbook tab 1636 is selected.

To associate the learning packet with the textbook, for example, textbook tab 1636 is selected. Identifying information about the textbook can then be entered into textbook field 1802. Examples of textbook identifying information include a title, an author, a publisher, a volume, an edition, a publication date, etc.

Further, some embodiments are configured to associate a learning packet with a particular portion of a textbook. To do so, for example, identifying information about the particular portion, or portions, of the textbook is entered into portion field 1804. Examples of textbook portions include pages, paragraphs, chapters, sections, subsections, volumes, graphics (e.g., images, tables, charts, etc.), lines, words, or any other identifiable portion of a textbook. In some embodiments, the learning packet is associated with an electronic book, or portion of an electronic book. In some embodiments, learning packets are associated with zero, one, or more textbooks. In another possible embodiment, each learning packet is associated with at least one textbook.

In some embodiments, textbooks or textbook portions are required to conform to a predefined taxonomy or otherwise be included in a list of available textbooks or textbook portions. For example, when textbook identifying information is entered into textbook field 1802, suggested matches 1808 are displayed, which can be selected to associate the learning packet with the selected textbook. In some embodiments, data store 112 contains publisher-provided information about various textbooks, such as the tables of contents of various textbooks. In some embodiments, a user can view the table of contents for a selected book, and select the relevant portion of the book from the table of contents. The learning packet is then associated with that portion of the book.

An add control 1806 is provided in some embodiments, which can be selected by the user to associate the textbook and/or textbook portion entered into field 1802 and 1804 with the learning packet. In some embodiments, a learning packet that is associated with a particular textbook or textbook portion, is referred to as being keyed to the particular textbook.

As discussed herein, associations with textbooks or textbook portions can be used for a variety of purposes, such as to provide relevant search results, or for other purposes.

FIG. 19 illustrates learning packet editor page 1400 when education level tab 1638 is selected. To associate the learning packet with an education level, for example, education level tab 1638 is selected. The education level can then be entered or selected. Examples of education levels include high school, college, and postgraduate levels. Some embodiments include other educational levels, such as preschool, elementary school, middle school, and/or junior high school. In another embodiment, education levels are a particular grade (e.g. sixth grade, eighth grade, 10th grade, 12th grade, freshman, sophomore, junior, senior, etc.). Other educational levels are used in other embodiments. As discussed herein, educational levels can be used for a variety of purposes, such as to provide relevant search results, or for other purposes.

After the desired information has been entered into information window 1600, save information control 1606 can be selected to save the information to computer readable storage media. In other possible embodiments, information is automatically saved upon entry.

As discussed above, the examples shown in FIGS. 14-19 illustrate an example edit view of a learning packet, which can be accessed by selecting edit view control 1452. Some embodiments further include a public view, which can be accessed by selecting public view control 1454, such as illustrated in FIG. 20.

FIG. 20 (including FIGS. 20A and 20B) is a screenshot of an example learning packet as displayed in an author's public view page 2000. As noted above, the author's public view page 2000 can be accessed by the author of the learning packet, for example, by selecting public view control 1454 from any page of the learning packet creation module (such as shown in FIGS. 14 through 19). The author's public view page 2000 displays the current learning packet to the author in substantially the same format as it will be displayed to a consumer after publication. However, in some embodiments the author's public view page 2000 includes additional tools that are available only to the author, to allow the author to edit, adjust, moderate, or otherwise change the content, layout, or appearance of the learning packet.

In this example, author's public view page 2000 displays learning packet 2002, including title bar 2012, section 2020, and section 2022. Title bar 2012 includes title 2014, timestamp 2016, and rating display 2018. Section 2020 includes content window 2030 and discourse window 2032. Content window 2030 includes video content 2040. Discourse window 2032 includes discourse 2042 in the form of a question. Section 2022 includes content window 2034 and discourse window 2036. Content window 2034 includes text content 2044 and graphical content 2046. Discourse window 2036 includes discourse 2048 in the form of a question and several answers.

Title bar 2012 provides introductory information about the learning packet that assists a consumer in quickly identifying whether or not the learning packet is likely to teach information of interest to the consumer. For example, title bar 2012 includes title 2014, timestamp 2016, and rating display 2018. Examples of titles and timestamps are discussed elsewhere herein. Some embodiments include additional information within title bar 2012, such as a packet summary, one or more objectives of the learning packet, one or more tags associated with the learning packet, and one or more categories associated with the learning packet.

Rating display 2018 is also provided in some embodiments to identify a rating, score, point value, or other quality indicator for learning packet 2002. One example of a rating display 2018 is an average rating given to the learning packet on a given scale. For example, a star rating is associated with the learning packet based on an average of all prior ratings (e.g., ratings on a scale from 1 to 5 stars, ratings from 1 to 10, etc.) that have been given to the learning packet by consumers that have previously viewed the learning packet.

In some embodiments, information about a learning packet, such as points, scores, ratings, or historical information (such as number of times the learning packet has been accessed) is displayed in a graph, such as a sparkline. A sparkline is, for example, a small, high-resolution graphic embedded in a context of words, numbers, or images. Sparklines are, for example, data-intense, design-simple, and word-sized graphics. In some embodiments, sparklines are also used to display information in other user interface displays of learning system 100.

Another example of a rating display 2018 is a point score for learning packet 2002, which displays a number of points that have been accumulated by the learning packet 2002. Points can be accumulated in a variety of different ways in the various possible embodiments. For example, in some embodiments each consumer is given one opportunity to adjust the point score of the learning packet 2002 upon review of the learning packet 2002. As illustrated in FIG. 20, some embodiments include an increase point score control 2080 and a decrease point score control 2082. When the increase point score control 2080 is selected by the consumer, the point score associated with learning packet 2002 is incremented by one (or another value). When the decrease point score control 2080 is selected by the consumer, the point score associated with learning packet 2002 is decremented by one (or another value).

In another possible embodiment, point scores are computed according to a predetermined formula. In some embodiments, the point score is based on at least one of the following: inputs by consumers (such as ratings); point or monetary remuneration earned in the learning packet; number of times a learning packet has been viewed by consumers; number of times the learning packet has recently been viewed by consumers; a score, rating, or point value of the author; the percentage of completion of the learning packet or associated information; a number of discourse elements received in the learning packet (e.g., number of comments, number of questions, number of questions and answers, number of answers); a score, rating, or point value of one or more users that submitted discourse elements within the learning packet; a number of different types of content sections included as content within the learning packet; a number of authors; a number of references (e.g., links) to the learning packet from other learning packets; assessment scores received by users who have used this learning packet; or a variety of other possible factors.

In some embodiments, the learning packet point score shown in rating display 2018, provides an indication of the quality of the learning packet. In some embodiments, the learning packet point score provides an indication of the overall or average quality of the content provided by the author within the content windows (e.g., content windows 2030 and 2034). In some embodiments, the learning packet point score provides an indication of how well the learning packet achieved an objective, such as to teach the consumer about the topic identified in the title of the learning packet, or the objective identified in objective window 1612. In other possible embodiments, the point score is based at least in part on the popularity of the learning packet; number of references to the learning packet by others; a point score of authors or learning packets that reference the learning packet; and/or grades, rankings, or comments provided through assessments taken by previous consumers of the packet.

In order to obtain focused feedback from consumers in the form of ratings, points, or scores, some embodiments of learning system 100 ask the user to provide feedback regarding a particular aspect of the learning packet. Typically, the primary focus of points, scores, or ratings is to help a consumer to know how well the learning packet teaches a given topic. As a result, consumers may be prompted to provide feedback on one or more aspects of the learning packet that can be used to identify the learning packet's ability to teach the consumer. Examples of such aspects of the learning packet include the quality of the learning packet, the quality of content, the ability of the learning packet to achieve an objective, etc.

Some embodiments associate learning packets with adjectives that describe an aspect of the content. For example, in some embodiments a set of adjectives are displayed to a consumer along with a prompt to select the adjectives that accurately describe the learning packet. Examples of suitable adjectives can include: inspirational, persuasive, ingenious, educational, fascinating, informative, funny, clever, entertaining, worthwhile, thoughtful, poor, bad, and boring. In some embodiments, a user has a number of votes (e.g., three) that can be applied to one or more adjectives. The user can then decide whether to use those votes to select multiple adjectives, or to apply multiple votes to the same adjective to weight that adjective more heavily. The votes or selections from all users can then be compiled and those adjectives that have received the most votes or selections are then associated with the learning packet.

The learning system 100 performs operations in some embodiments to guide the user to provide feedback on one or more aspects of the learning packet. For example, some embodiments include a mouse-over display 2084 that guides the user to provide the desired feedback. In this example, the user has positioned a pointer over a feedback control associated with discourse 2042, causing learning system 100 to generate mouse-over display 2084. In this example, display 2084 suggests that the controls are to be used to evaluate the quality of or an appropriateness of a question, such as by providing an input stating that the question was a “Great Question” or another input indicating “Poor Question.” Other displays are provided in other embodiments to guide the user to provide the appropriate feedback.

In addition to an overall learning packet rating display 2018, some embodiments store and display ratings for portions of a learning packet. Examples include the question rating display 2088 and the answer rating displays 2090. Question rating display 2088 displays a rating associated with a question, and answer rating display 2090 displays a rating associated with an answer. Other embodiments include other rating displays, such as a content window rating display. All ratings displayed by the ratings displays 2018, 2088, and 2090 are stored in computer readable storage media, and can be used for other purposes, such as to provide relevant search results or to perform sorting. For example, ratings are used in some embodiments to order questions and answers, with highest rated questions and answers being located at or toward the top, and lower rated questions being located below. In some embodiments question and answer ratings are not displayed.

Referring to discourse window 2036, some embodiments of author's public view page 2000 include controls configured to receive input from the author based on discourse provided by others. For example, some embodiments allow the user to indicate that a particular answer or comment is a correct answer or comment. This can be used by learning system 100, for example, to adjust the order in which answers are displayed (e.g., to display the correct answer(s) first) or to highlight, star, or otherwise more prominently display the associated answer.

In some embodiments discourse windows 2032 and 2036 include minimize controls that can be selected by the user to minimize the discourse, such as shown in discourse window 2032. When minimized, for example, the discourse window 2032 displays only questions and hides answers to the question. This allows more questions to be displayed on a single display, for example, to allow the user to more quickly review the set of questions that have been asked, or to reduce the amount of information displayed in learning packet 2002. In another possible embodiment, a summary of the discourse is displayed, such as a number of discourse elements and/or an excerpt of one or more discourse elements.

When a learning packet sparks a large amount of activity, it is possible that the discourse sections could get rather long and more difficult to navigate. To assist a user in more quickly reviewing discourse, some embodiments include an alternate discourse view of a learning packet in which all discourse for the current learning packet are shown in a single list-type view. For example, content windows are removed in this view such that only discourse is displayed. In addition, in some embodiments each discourse element is limited to a given length (e.g., number of character or number of words), but may be expanded by clicking on the discourse element. Further, in some embodiments a search bar is provided to provide a quick searching capability through the discourse (e.g., find-as-you-type), such as to limit the discourse display to those that include particular keywords or meet one or more identified criteria (e.g., name of author, date, etc.).

In addition to learning packet 2002, some embodiments include tools within the author's public view page 2000 that are displayed on both the author's and the consumer's public view pages. For example, public view page 2000 includes toolbar 2060. Other tools on author's public view page 2000 are only displayed to the author, and are not included on a consumer's public view page. Examples of these tools are the delete controls 2062.

In this example, toolbar 2060 includes follow packet control 2064, drag to collect control 2066, e-mail control 2068, and third-party controls 2070. Follow packet control 2064 can be selected by a user to add the packet to that user's subscription list, such as to be notified when an event occurs in the future relating to learning packet 2002.

Drag to collect control 2066 allows a user to add learning packet 2002 to the current user's collection, such as in collections tab 670. For example, the user clicks on the drag to collect control 2066 and drags the pointer to the collections tab 670 or into a collection window, such as described in more detail herein.

E-mail control 2068 can be selected to initiate an e-mail module of learning system 100. The e-mail module prompts the user to enter an e-mail address or user name for a recipient and a brief note. The e-mail module then sends an e-mail (or other electronic message, such as an instant message, text message, etc.) to the identified recipient including information about learning packet 2002. For example, the e-mail includes a link to the public URL of the learning packet 2002.

Third-party controls 2070 are provided to initiate an operation involving a third-party system, such as to send a message or notification to a third-party system relating to learning packet 2002. Examples of third-party systems are described herein, such as event listeners 136 and third-party educational systems 138, shown in FIG. 1. One specific example of a possible third-party control 2070 is a post to personal page control 2072. Upon selection of the control 2072, a notification is sent to the associated third-party system, which causes information about the learning packet to be posted on a user's personal page. In some embodiments, upon posting to the personal page, the third-party system further sends out notifications of the update to the personal page to friends or subscribers. An example of a personal page is a blog, a home page, or a wall (such as in the Facebook® system). Another example of a third-party control 2070 is a control 2074 that sends a notification to a third-party bookmark management system, such as the Delicious® system owned by Yahoo!, Inc. The notification can include, for example, the public URL to learning packet 2002. Another example of a third-party control 2070 is an educational system control 2076. In one example, activation of the third-party control causes a notification to be generated and sent to educational system 138. For example, the notification can identify the learning packet and one or more courses associated with the learning packet. Third-party educational system 138 then updates a course page for the identified course to identify or link to the learning packet. Other embodiments include other notifications and perform other operations upon activation of a third-party control 2070.

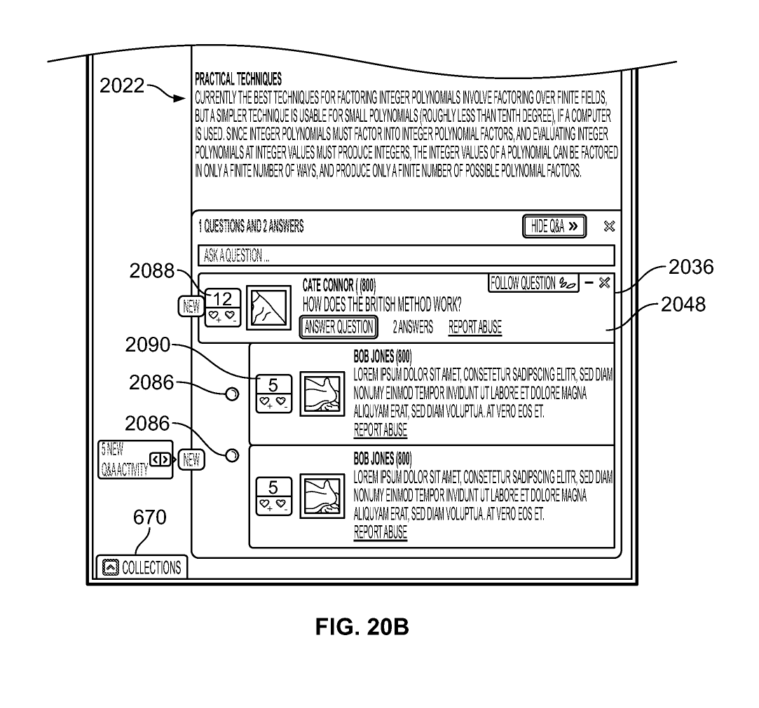

FIG. 21 (including FIGS. 21A and 21B) is a screenshot of an example learning packet 2002 as displayed in a consumer public view page 2100. The consumer public view page 2100 is displayed when a current user (e.g., “Bob Barnes” shown in user display 2102) is not the same as the author (e.g., “Andrew Alan” shown in author information window 1402).

In this example, consumer's public view page 2100 includes header 602, author information window 1402, learning packet 2002, and collections tab 670. As discussed with reference to FIG. 20, the example learning packet 2002, includes title bar 2012, section 2020, and section 2022. Section 2020 includes content window 2030 and discourse window 2032. Content window 2030 includes video content 2040. Discourse window 2032 includes discourse 2042 in the form of a question. Section 2022 includes content window 2034 and discourse window 2036. Content window 2034 includes text content 2044 and graphical content 2046. Discourse window 2036 includes discourse 2048 in the form of a question and several answers.

In some embodiments, the consumer public view page 2100 is similar to the author's public view page 2000, except that the consumer public view page 2100 does not permit the consumer to edit the content or permanent layout of the learning packet 2002. More specifically, in some embodiments the consumer public view page 2100 does not include various tools that were shown in FIG. 20, such as an edit view control 1452, public view control 1454, delete controls 2062, correct controls 2086, or other editing controls.

Consumer public view page 2100, including learning packet 2002, is displayed to the user to permit the user to view learning packet 2002. The user can then review, study, watch, or otherwise interact with the learning packet to learn about the topic of the learning packet.

In some embodiments, before consumer public view page 2100 is displayed to a consumer, the consumer must purchase a license to view the contents. In some embodiments a purchase price is associated with each learning packet, a set of learning packets, or with all learning packets in learning system 100. After locating a desired learning packet, the learning system 100 asks the consumer to purchase the content. If the user is willing to purchase the content, the transaction is recorded and the consumer is then granted access to the learning packet. For example, in some embodiments each user must provide a method of payment, such as a credit card number or a student identification number (associated with an educational institution) when the payment may be charged, or must have an established billing account within learning system 100. The cost of the learning packet is then debited from the user's account or otherwise charged to the user.

After reviewing some or all of information within learning packet 2002, the user can provide feedback or engage in discourse with the author or other users of learning system 100. Feedback can be provided, for example, through one or more rating controls that receive a rating or other feedback from the user. Discourse can be provided, for example, in the form of a question or an answer to a question. However, a wide variety of other types of discourse are also possible, such as comments, live chat, text messaging discussions, whiteboard interactions or other group collaboration sessions, etc. In some embodiments a live tutorial session can be initiated between two users (which can be free or for a fee). In some embodiments the live tutorial session is recorded and then stored as an additional discourse element in the learning packet 2002. The tutorial session can then be viewed by subsequent consumers, in some embodiments. This could be helpful for example, to address commonly asked questions relating to the topic of the learning packet. In some embodiments, an additional fee or contract upgrade is required to use group features within the learning system 100.

In some embodiments, users of learning system 100 can be registered as tutors within learning system 100, such as to provide tutoring services for a given subject area, topic, course, course at a particular educational institution, grade level, etc. In some embodiments, a user's profile includes a tag that identifies the user as a tutor. In some embodiments, learning system 100 provides search results identifying users that may be able to provide tutoring to a consumer. Tutoring is provided through learning system 100, in some embodiments, such as through a live tutorial session in a discourse section of a learning packet, or in a separate tutoring section of learning system 100. In some embodiments, the tutoring section provides for one-on-one (or one-to-many) communication, such as through a text chat, audio or video conference, instant messaging, e-mail communication, etc. After a tutoring session, the tutoring section prompts the consumer to provide feedback on the tutoring session, such as in the form of comments, rating, etc. In some embodiments tutors can purchase advertisements within learning system 100, or can pay to be listed as a featured tutor in search results. Tutoring services are free or for a fee. In some embodiments, a consumer can award the tutor points for their assistance, and the points can be redeemed, for example, for cash or merchandise (such as through points manager 134).

In some embodiments, a link to or list of tutors that are available for live instruction on the topic of the learning packet is displayed in a sidebar of (or elsewhere in) the learning packet. The user can select the link or list to begin to initiate a live tutorial session to receive additional training relating to the topic, or to ask specific questions about something that the user does not understand in the learning packet. In another embodiment, a link to or list of tutors that are available to provide tutoring on a subject different from that of the current learning packet is provided, such as to a subject that the user has previously shown an interest in, or a need for extra assistance, etc. In some embodiments, a tutorial session requires the payment of an additional fee. The fee may be processed by a third party payment processing system, for example, and can be allocated between the operators of the learning system and the tutor in any desired proportion (including entirely to one or the other). A tutoring session can include any one or more of the following: real-time text-based chat, real-time audio chat, real-time video chat, real-time white-boarding, online audio (i.e., VoIP), or a telephone call. The learning system is also configured, in some embodiments, to schedule an in person tutoring session with a tutor, such as at the user's school. A calendar is provided to allow the user to reserve a time slot in the tutor's schedule in some embodiments.

In some embodiments, a tutoring session is recorded and is saved by the learning system for subsequent review. In some embodiments the recorded session is available only to the user who was originally being tutored, while in other embodiments the tutoring session is made available to other users, such as all users in a class. In some embodiments a tutoring session is embedded into a content window of the learning packet that the user was originally consuming when the tutoring session was requested.

FIG. 22 (including FIGS. 22A and 22B) is a screenshot of the example consumer public view page 2100, and further illustrating an example collections window 2202. In this example, consumer's public view page 2100 includes header 602, author information window 1402, learning packet 2002, toolbar 2060 (including drag to collect control 2066), collections tab 670, and collections window 2202.

In this example, consumer's public view page 2100 displays learning packet 2002, including title bar 2012, section 2020, and section 2022. Section 2020 includes content window 2030 and discourse window 2032. Content window 2030 includes video content 2040. Discourse window 2032 includes discourse 2042 in the form of a question. Section 2022 includes content window 2034 and discourse window 2036. Content window 2034 includes text content 2044 and graphical content 2046. Discourse window 2036 includes discourse 2048 in the form of a question and several answers.

In some embodiments, collections window 2202 is displayed when collections tab 670 is displayed. In this example, the current consumer (identified in user display 2102) has already created several collections, including an algebra 101 collection and look at later collection 2212. The consumer can define any number of collections, as desired. Each collection 2210, 2212 forms a repository of links to learning packets so that the user can quickly locate the collections again in the future. Collections 2210, 2212 also allow the user to group learning packets that share a common characteristic. For example, collection 2210 includes links to learning packets that share a common topic—they are all related to the topic of algebra 101. In another possible embodiment, collection 2210 includes links to learning packets that are related to or associated with a particular course, such as the algebra 101 course taught at a particular educational institution. As another example, collection 2212 includes links to learning packets that the user would like to come back to again later or review in more detail in the future.

To create a new collection, the user can select the new collection control 2214. Learning system 100 then prompts the user to enter a name for the new collection, and generates a new icon in collection window 2202 representing the new collection.

To add a learning packet to the collection, the drag to collect control 2066 of toolbar 2060 can be used in some embodiments. For example, if the user wants to save a link to the current learning packet 2002 in collection 2210, the user clicks on the drag to collect control 2066 and drags and drops the control into collection 2210.

In some embodiments, collections and collection displays (such as collection window 2202) are managed by content collections management module 308 (shown in FIG. 3). The underlying data, such as the names of the collections, and links to the learning packets within the collection, are stored in content collections data 424, in some embodiments. In some embodiments, a user's collection is private, but in some embodiments the collection is public, or can be set to be publicly available by the user to share the collection with other users.

Collection window 2202 can be minimized by selecting collections tab 670, when the collection window 2202 is open.

If the user wants to see the learning packets contained within a given collection, the user selects the icon for that collection, such as the algebra 101 collection 2210. The collection is then displayed, such as shown in FIG. 23.

FIG. 23 is a screenshot of an example collection page 2300, which displays summaries of learning packets contained within a collection 2210. In this example, collection page 2300 includes header 602, collector information window 2302, collection display window 2304, and collections tab 670.

Collector information window 2302 displays information about the user that has assembled the collection of learning packets. In some embodiments, the collector identified in collector information window 2302 is not the same as the current user (shown in user display 2102). For example, in some embodiments collections can be made public, so that they are accessible to other users in addition to the collector. In some embodiments the collection is indexed and searchable. In another embodiment, the collection can be accessed from a list of collections provided in the collector's public profile page. In the example illustrated in FIG. 23, the current user is the same as the collector. In another possible embodiment, a user can subscribe to a collection, such as to be notified when the collection is updated.

In the example collector information window 2302, the name of the collector 2310 is displayed, along with various additional controls, such as a view profile control 2312, follow collector control 2314, and follow collection control 2316. View profile control 2312 can be selected to display additional information about the collector, such as the collector's public profile page. Follow collector control 2314 can be selected to subscribe to the collector's event feed. Follow collection control 2316 can be selected to subscribe to the collection's event stream, such as to be alerted when the collection 2210 is updated by the collector.

Collection display window 2304 displays a summary of each learning packet contained in the collection 2210, or a subset of the learning packets. Each learning packet is summarized in a summary display window, including learning packet summaries 2320, 2322, 2324, 2326, and 2328. Move control 2332 is provided in some embodiments to permit a user to rearrange or reorder learning packet summaries within collection display window 2304. Each of learning packet summaries 2320, 2322, 2324, 2326, and 2328 are selectable and are linked to their respective learning packets. Selection of one of summaries 2320, 2322, 2324, 2326, and 2328 causes the learning system 100 to display the public view page 2000 or 2100 associated with the learning packet.

In some embodiments, collections are associated with a value. A consumer that desires to view collection page 2300 must pay (or agree to pay) the value before the collection page 2300 is displayed.

In some embodiments, collections can be ranked or rated, or a point value can be adjusted by consumers. A rating, score, or point value is generated for the collection based on the ranking or rating provided by feedback from consumers, or on other factors. In some embodiments the rating, score, or point value is displayed in collection display window 2304. In some embodiments, the rating, score, or point value is used for other purposes, such as to provide relevant search results.

In some embodiments, learning packets are arranged within a collection in a particular order. The first learning packet is identified as being the first in the collection, the next is identified as being the second in the collection, etc. In this way a collector can identify the desired order that learning packets should be viewed, such as to teach information in a sequence by building on the concepts taught in prior learning packets. In some embodiments, the collection is associated with a course or other academic activity (a class, a homework assignment, etc.). In some embodiments, a collection includes learning packets that are all associated with a particular topic, such as a narrowly defined academic subject, which can be identified on the collection page, such as in the title of the collection, or in a separate narrative. A collection can represent a recommended group of learning packets, an endorsed set of learning packets, or an assigned set of learning packets (such as a homework assignment).

In another possible embodiment, learning packets can be grouped into (or mapped to) a defined competency, such that upon review of the learning packets assigned to the given competency, the user will have obtained the information necessary to achieve the defined competency. An example of a competency is “how to factor a polynomial,” which defines the learning outcome that should be achieved upon studying the information within the learning packets associated with that competency. In some embodiments, the competencies are then grouped into a curriculum, which itself has a larger objective of teaching a user a larger body of information (i.e., basic algebra). In some embodiments, the curriculum is organized to support and address a learning standard. An example of a learning standard is a mathematics teaching standard as defined by an academic community. In some embodiments, an assessment is provided to the user upon completion of the consumption of the one or more learning packets associated with a given competency, such as to assure that the user has achieved the intended competency after consuming the content of the one or more learning packets.

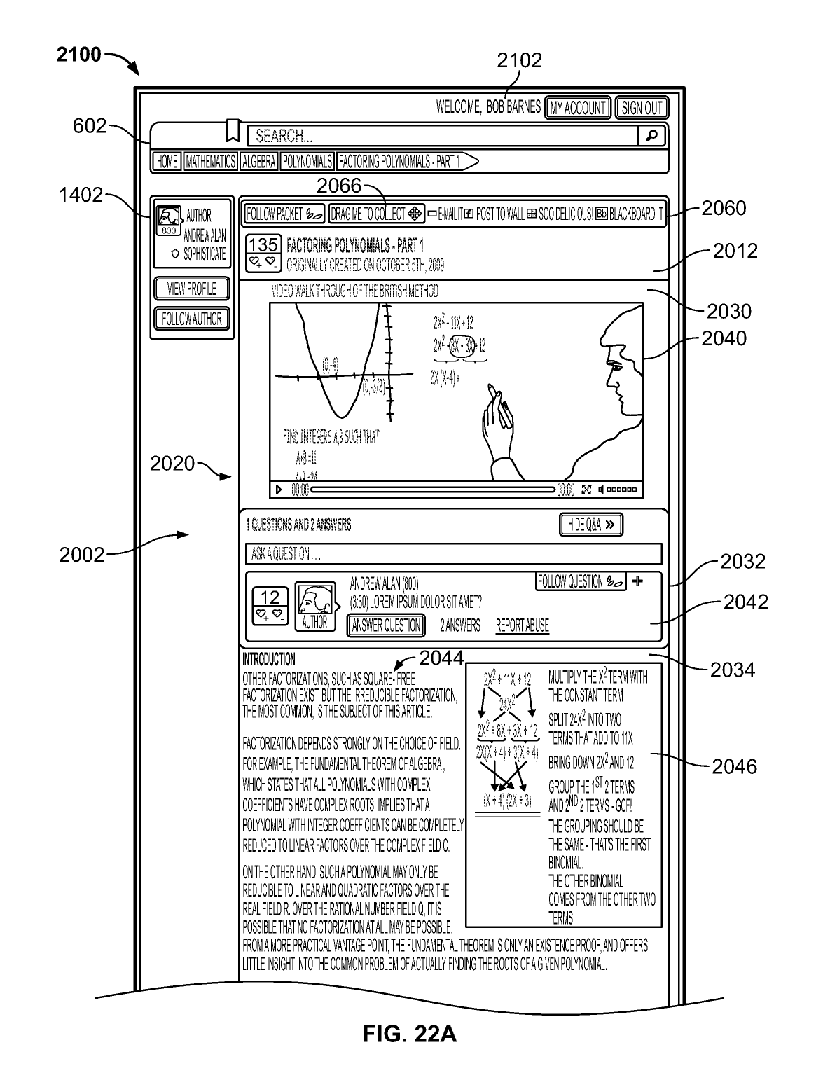

FIG. 24 (including FIGS. 24A and 24B) is a screenshot of the example consumer public view page 2100 (such as shown in FIG. 21), and further including a feedback window 2402 that provides feedback to the user upon occurrence of an event within learning system 100.

In this example, consumer's public view page 2100 includes header 602 (including user display 2102), author information window 1402, learning packet 2002, toolbar 2060, collections tab 670, and feedback window 2402. The example learning packet 2002 includes title bar 2012, section 2020, and section 2022. Section 2020 includes content window 2030 and discourse window 2032. Content window 2030 includes video content 2040. Discourse window 2032 includes discourse 2042 in the form of a question. Section 2022 includes content window 2034 and discourse window 2036. Content window 2034 includes text content 2044 and graphical content 2046. Discourse window 2036 includes an ask question field 2420 and discourse 2048 in the form of new question 2422 posted by the current user.

If, during the review of learning packet 2002, the current user wants to engage in discourse regarding the learning packet, discourse windows 2032 and 2036 are provided in which the user can engage in discourse regarding the respective content in content windows 2030 and 2334. In this example, the current user has a question regarding content 2044 and 2046 within content window 2034. As a result, the user locates the ask question field 2420 located in discourse window 2036, types in the question, and submits the question (such as with an enter key or return key, or by selecting a submit control). In some embodiments, public view page 2100 is immediately updated to show the question 2422. In other embodiments, the question must first be approved by a moderator (such as the author of the learning packet).

Some embodiments include feedback windows that provide feedback to a user upon the occurrence of an event. An example is of feedback window 2402 is shown in FIG. 24. In this example, the feedback window 2402 identifies the event that has just occurred (e.g., the question was successfully posted).

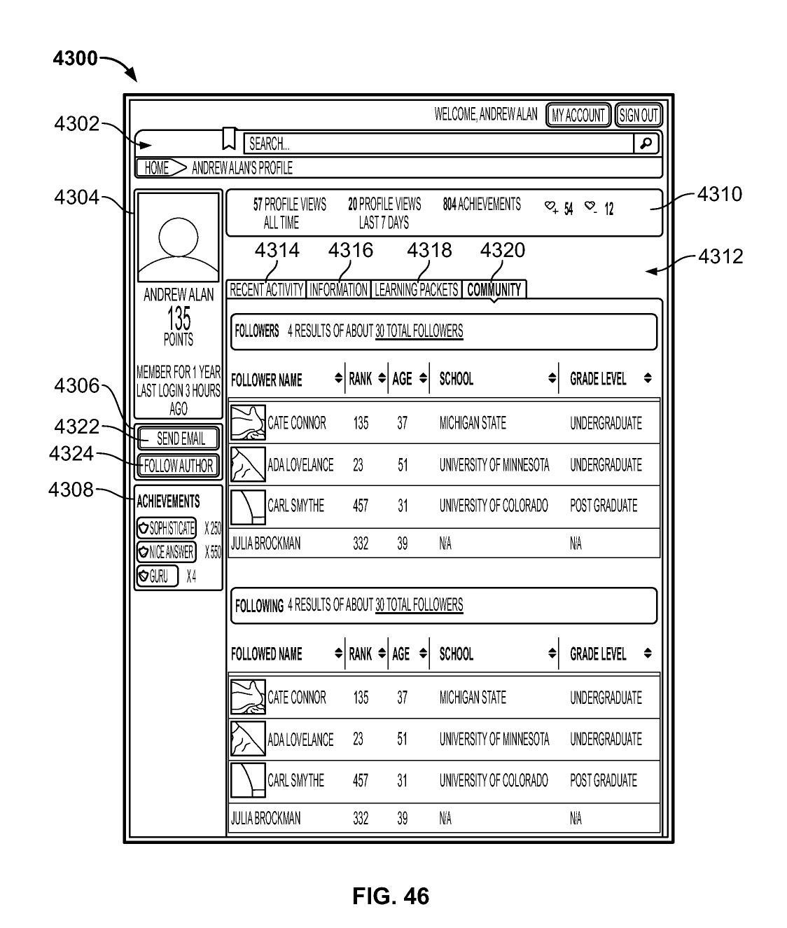

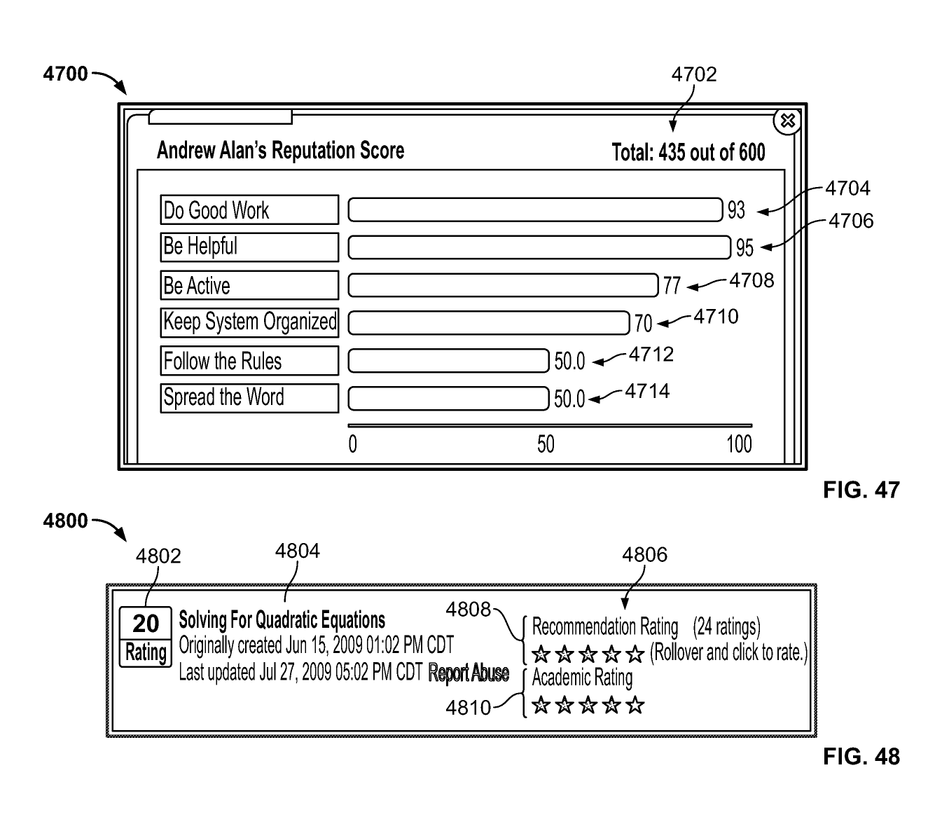

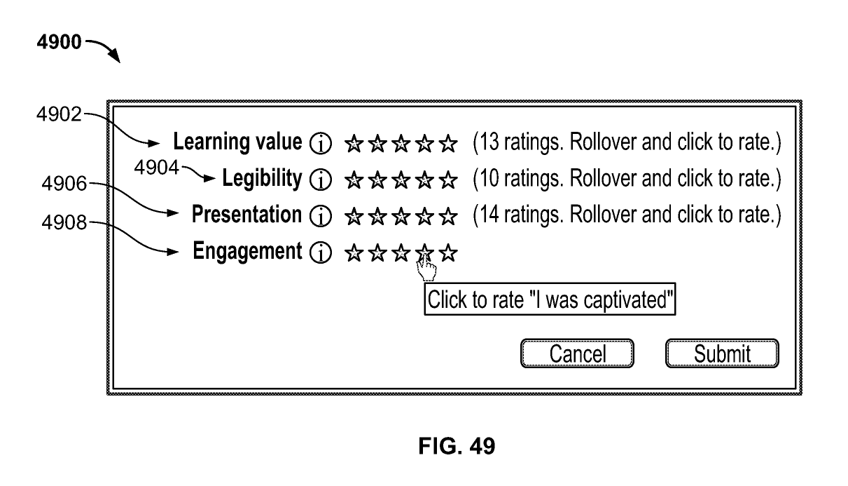

In some embodiments, certain activity within learning system 100 can result in an adjustment of a rating, score, or points value for the current user or another user. Further, in some embodiments activity within learning system 100 can result in the issuance of an award to the current user or another user. In the example shown in FIG. 24, the feedback window 2402 shows that by submitting the question 2422, various additional events occurred, including the earning of an award 2404, and specifically the earning of a sophisticate badge 2408 or other status symbol or recognition. In addition, the submission of the question caused an adjustment 2406 in the points of the current user (e.g., the current user's point value increased by one point), and also an adjustment 2410 in the points of the author of the learning packet (e.g., the current user's point value increased by one point). As another example, the point value of the learning packet can be adjusted, which can be reflected in the feedback window 2402. A more detailed example of a user's reputation score is described herein with reference to FIG. 47. A more detailed example of a learning packet score is described herein with reference to FIGS. 48-49.

Feedback windows, such as feedback window 2402 encourage certain activities within learning system 100, and also encourage users to more actively participate in the learning system 100, in some embodiments.

When a question, or other form of discourse, is provided in question field 2420, some embodiments of learning system 100 operate to compare the entered question with previously entered questions, such as to determine whether or not the question has been previously asked, or to inform the user if a question may have been previously asked. For example, in some embodiments learning system 100 compares keywords from the entered question to keywords of previously asked questions. In some embodiments, taxonomy data is used to normalize keywords. In another possible embodiment, synonyms or other forms of keywords are searched. If a previously asked question matches or is sufficiently similar to the newly asked question, learning system 100 informs the user that the question may have been previously asked. In some embodiments, learning system 100 prevents a user from asking a question that has previously been asked. In another embodiment, previously asked questions that are sufficiently similar to displayed to the user as suggested similar questions, which can be selected by the user to view the question and any associated answers.

FIG. 25 (including FIGS. 25A and 25B) is a screenshot of an example learning packet 2002 as displayed in a consumer public view page 2100, and further illustrating an example search results window 2502. As discussed above, the consumer public view page 2100 is displayed when a current user (e.g., “Bob Barnes” shown in user display 2102) is not the same as the author (e.g., “Andrew Alan” shown in author information window 1402). However, in some embodiments the search results window 2502 is also displayed in other pages, such as in the author's public view page 2000 (shown in FIG. 20), the editor page 1400 (shown in FIG. 14), profile pages (e.g., dashboard page shown in FIG. 600), or a variety of other possible pages.

In this example, consumer's public view page 2100 includes header 602 (including search bar 612, user display 620, text entry field 626, and selectable control 628), author information window 1402, learning packet 2002, and collections tab 670. As discussed with reference to FIG. 20, the example learning packet 2002, includes title bar 2012, section 2020, and section 2022. Section 2020 includes content window 2030 and discourse window 2032. Content window 2030 includes video content 2040. Discourse window 2032 includes discourse 2042 in the form of a question. Section 2022 includes content window 2034 and discourse window 2036. Content window 2034 includes text content 2044 and graphical content 2046. Discourse window 2036 includes discourse 2048 in the form of a question and several answers.

FIG. 25 also illustrates search results window 2502 displayed upon entry of a search query 2504 into text entry field 626. In this example, search results window 2502 includes multiple sets of search results, including learning packet content results 2510, question results 2512, answer results 2514, and user results 2516. Other embodiments include other result types, such as collection results and media results. Search results window 2502 also includes current document results indicator 2520 in some embodiments.

To assist a user in quickly identifying relevant information within learning system 100, learning system 100 includes a search module 314 (shown in FIG. 3). In some embodiments, the search module 314 includes an indexing module 320 that generates and manages a search index 440 (shown in FIG. 4). Information within learning system 100 is indexed within the search index 440. A search engine 322 is also provided to search within search index 440 and to generate a list of search results based upon a search query 2504 defined by a user. The search module 314 operates to receive a search query 2504 from a user and to generate the list of search results that are displayed to the user in search results window 2502.

In this example, the user is interested in locating information relating to factoring polynomials. Accordingly, the user begins to enter the search terms as search query 2504. In some embodiments, search results window 2502 is displayed as soon as the user begins to enter search query 2504, and the search is performed as each character of the search query 2504 is entered. As shown in FIG. 25, the user has entered a portion of the search terms, but has not yet completed the entry of the second term. Specifically, the user has currently entered “Factoring polyno.” In another possible embodiment, the search is not performed until a search control 628 is selected. In yet another possible embodiment, the search is performed when there is a pause in the user's typing that exceeds a predetermined time interval.

Upon entry of search query 2504, search results window 2502 is displayed including lists of search results that satisfy the search query. In some embodiments each of the search terms must be exactly present in the identified search results, while in other embodiments the closest search results are displayed, which may include results that do not include one or more of the search terms, or may include additional forms or synonyms of the search terms. In some embodiments, the search query can include Boolean operators, such as AND, OR, NOT, and other Boolean operators.

In some embodiments, search results displayed in search results window 2502 are displayed in multiple lists of search results. For example, if the match to the search query 2504 was located in a content section (e.g., 2030 or 2034) of a learning packet (e.g., 2002), the result is included in learning packet content results 2510. If the match was found in a question asked within a learning packet, the result is included in question results 2512. If the match was found in an answer provided to a question in a learning packet, the result is included in answer results 2514. If the match was found in a user profile, the result is included in user results 2516. Other embodiments include other arrangements of search results. For example, in some embodiments, all search results are displayed in a single list of search results regardless of where the match was found. In another possible embodiment, if a match is found in any type of discourse of a learning packet, the search results are included in a discourse results list. In some embodiments the discourse results list is further divided into discourse types, such as questions and answers, or other discourse types.

Each result in search window 2502 is selectable and linked to the associated learning packet or user profile where the search result was found. Search results can be sorted in a variety of different manners. In some embodiments, a ranking function is utilized by search engine 322 to associate a relevancy score to each search result. Search results are then arranged in search results window 2502 from the results with the highest relevancy score to search results with the lowest relevancy score. In another example, search results are ranked according to rating or point values associated with the information. For example, if the result is found in a learning packet, the rank or point score of the learning packet is used to sort search results. Similarly, a rank or point score of a portion of a learning packet is used in some embodiments. In another possible embodiment, search results are sorted according to how recent the information is, or how recently the information has been updated. In another possible embodiment, search results are sorted alphabetically by title or user name.

In some embodiments, search window 2502 includes a featured results section. In one example, an author of a learning packet can pay to have that author's learning packet listed among the featured results for a period of time. In another example, an administrator of learning system 100 can identify particular high quality learning packets or learning packets that are receiving a lot of activity as featured results. In some embodiments, featured results are only displayed if they are related to the search query. In another possible embodiment, authors can purchase advertising space within search window 2502, such as to advertise themselves or one or more of the author's learning packets. In another possible embodiment, advertisements of products or services are shown in search window 2502, or in other user interfaces of learning system 100.

In some embodiments, when one or more search results are found in the page that is currently being displayed (such as the public view page 2100), search result window 2502 includes a current document results indicator 2520 that identifies that search results were found in the current page, and in some embodiments the number of search results are also identified.

Some embodiments of search module 314 (shown in FIG. 3) include a taxonomy translation module 324. In some embodiments, a search query is processed using the taxonomy translation module 324. The taxonomy translation module 324 searches, for example, through taxonomy data 442 (shown in FIG. 4) to determine whether the search terms are part of the predefined taxonomy and whether there are any synonymous words (or other forms of the search term) that are within the taxonomy. The taxonomy results are then used to provide additional search results that include the taxonomy results. Alternatively, the taxonomy results are used to suggest alternate search queries to the user. In some embodiments, the alternate search queries are displayed to the user, and can be selected by the user to initiate the execution of the suggested search query.

Some embodiments include guide window 2530 that is displayed in one or more pages of learning system 100 to identify the location of search results within the one or more pages. In some embodiments the guide window operations are performed by guide window module 326, shown in FIG. 3. In some embodiments, guide window 2530 identifies only those results that are in the current page.

In one example, the guide window 2530 is displayed to guide the user through search results within the current page (e.g., public view page 2100). In this example, the user has provided a search query 2504 of “Factoring Polyno.” Five results were found within the current page, as indicated in current document results indicator 2520, including first search result 2532. In some embodiments, each of the results is highlighted within the current page 2100. Highlighting includes, for example, one or more of a change in font (e.g., font size, font style (bold, italics, underline, etc), font type, font color, etc.) or a change in appearance of a background surrounding the matching terms. Some embodiments do not highlight search results.

In some embodiments, guide window 2530 is displayed adjacent to the first search result, such as in the margin of page 2100. In some embodiments, guide window 2530 is displayed at the same height as first search result 2532 within page 2100. This allows a user to quickly identify the position of the search result within the current page 2100.

Some embodiments further include navigation controls, including a back control 2534 and a next control 2536, within guide window 2530. If an input is received from the user to select the back control 2534, the previous search result is displayed, while if the next control 2536 is selected, the next search result is displayed. If the next or prior search result is not visible in the current page view, the current page 2100 is automatically scrolled until the search result is visible in the page. Guide window 2530 is then positioned and displayed adjacent to the search result. If the back control 2534 is selected while the first search result 2532 is displayed, the last search result is then displayed. If the next control 2536 is selected when the last search result is displayed, the first search result 2532 is then displayed. In some embodiments, a prompt is provided to let the user know that the first or last search result is currently being displayed, and to request confirmation that the user wants to proceed to the last or the first search result before such result is displayed.

In another possible embodiment, guide window 2530 is displayed to guide the user through search results that may be on multiple different pages, such as the search results displayed in search results window 2502. For example, page 2100 is first displayed and includes guide window 2530, which is displayed adjacent to first search result 2532. Selection of next control 2536 then causes learning system 100 to display the second search result, which may be on the same page 2100 or to display another page where the search result is located. The guide window 2530 is then displayed adjacent to the second search result. Similarly, when the back control 2534 is selected, the prior search result is displayed along with the page that the search result is located within.

In this way, the guide window allows a user to very quickly advance between various pages and various search results in search of the desired information.

Some embodiments include guide window 2540 that identifies new content within a learning system 100, and allows the user to quickly review the new content. In some embodiments guide window 2540 displays content that has been added to a page since the current user last visited the page. In other embodiments, guide window 2540 displays content that has been added within a given period of time, such as the past hour, day, week, month, year, etc. In some embodiments, guide window 2540 displays new content in a single page and allows the user to navigate among that content using back and next controls 2542 and 2544, such as to display search results found in a given page. In other embodiments, guide window 2540 displays new content among multiple pages, such as to guide the user to multiple pages that generated notifications that showed up in the user's event feed. As one example, the guide window is initiated when the user indicates a desire to review new content, such as by selecting a new content control of the user's dashboard page 600 (shown in FIG. 6) or other login or welcome page. Upon selection of the control, the guide window 2540 is displayed on the page including the first new content. The next control 2544 is then selected to advance through all new content among the multiple pages. In some embodiments, the new content is limited to new content that the user has subscribed to.

In other possible embodiments, guide windows are used to guide a user through other information within learning system 100. For example, in some embodiments, a guide window is used to guide a user through notifications in the event feed (shown in FIG. 6), such as to show the user where activity occurred within learning system 100 that caused the generation of each notification in the event feed.

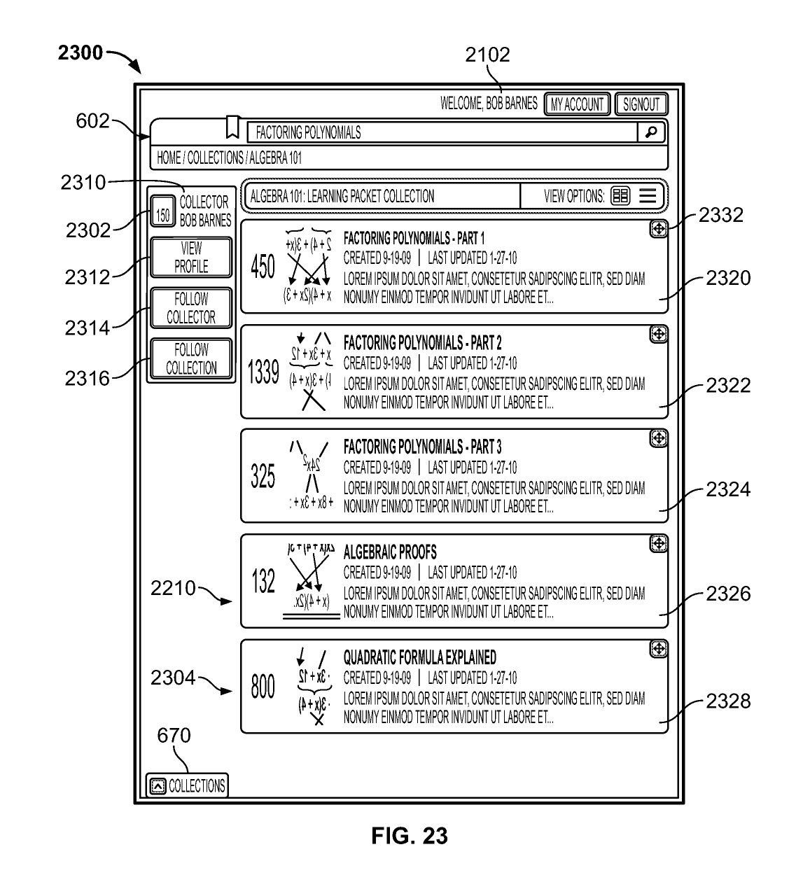

Some embodiments include an advanced search feature. The advanced search feature is initiated, for example, upon selection of search control 628, or upon selection of another advanced search control. In some embodiments, upon selection of the search control 628, a new search results page 2600 is displayed, such as shown in FIG. 26. In another possible embodiment, search results page 2600 is displayed instead of search window 2502.

The example shown in FIG. 25 includes a text entry field 626 that is used to perform a search for information within the current learning packet 2002, and also information contained in other learning packets (or elsewhere within learning system 100). In another possible embodiment, separate text entry fields are provided. For example, text entry field 626 is provided to permit searching through all learning packets, while a second text entry field (which may be, for example, positioned below and to the right of text entry field 626) is provided to permit searching only within the current learning packet. Labels can be used to distinguish between the two tools, such as “What do you want to learn about?” can be used to indicate that text entry field 626 is used to perform a global search for information with the learning system 100, while a label “Search within this packet” can be used to indicate that the text entry field is used to perform a search only within the current learning packet.

FIG. 26 is a screenshot of an example search results page 2600. In this example, search results page 2600 includes refine search window 2602, recent searches window 2604, and search results window 2606. In some embodiments, search results window 2606 includes learning packet content results 2608, and discourse results 2610.

In some embodiments search results are displayed in search results page 2600, such as within search results window 2606. As with search results window 2502 (shown in FIG. 25), some embodiments organize search results in multiple sections according to where the search result was identified. In this example, a search query 2504 was received from a user, and search results were identified as being located in learning packet content and in learning packet discourse of various learning packets. Search results that were found to be within learning packet content are displayed in learning packet content results 2608. Search results that were found to be within the discourse of a learning packet are displayed in discourse results 2610. Each search result listing is linked to a learning packet where the search result was identified. In some embodiments, search result listings are selectable. Upon selection of a search result, the learning system 100 displays the public view page (e.g., 2100) including the learning packet (such as shown in FIG. 21) to display the search result. In some embodiments, search results include media items and/or collections that match the search query.

Additional filtering of search results can be performed in some embodiments. In this example, refine search window 2602 displays a plurality of filter controls that operate to refine search results according to one or more identified criteria. In this example, refine search window 2602 includes education level control 2612, subject control 2614, textbook control 2616, course control 2618, media control 2620, and rating control 2622.

Filter controls are used in some embodiments to define one or more criteria for limiting the scope of search results identified in search window 2606. As previously discussed herein, learning packets can be stored with additional data, such as metadata, that identifies characteristics of the learning packet or defines criteria to be associated with the learning packet. An example of metadata that can be associated with a learning packet is shown and described herein with reference to FIGS. 16-19. Search scope limitations can be defined based on the content of such metadata.

Several examples of filter controls are shown in refine search window 2602. Education level control 2612 is selected to define an education level filter. The education level filter includes only those learning packets that are associated with a selected education level or set of education levels as being within the search scope. Examples of education levels are shown in FIG. 19.

Subject control 2614 is selected to define a subject filter. The subject filter includes only those learning packets that are associated with a selected subject or set of subjects as being within the search scope. Examples of subjects are shown in FIG. 16.

Textbook control 2616 is selected to define a textbook filter. The textbook filter includes only those learning packets that are associated with a selected textbook or portion of a textbook as being within the search scope. Examples of textbook associations are shown in FIG. 18.

Course control 2618 is selected to define a course filter. The course filter includes only those learning packets that are associated with a selected course or set of courses as being within the search scope. Examples of courses are shown in FIG. 17. Some embodiments also or alternatively include an educational institution filter to limit search results to those associated with a given educational institution. In some embodiments, the learning system 100 first prompts the user to select the educational institution, and then prompts the user to select a course that is offered by the school from a list of courses. Some embodiments prompt a user to select a state, region, type, or other grouping of educational institutions prior to selecting the educational institution.

Media control 2620 is selected to define a media type filter. The media type filter includes only those learning packets that include content of a selected media type as being within the search scope. Examples of media types include text, images, audio, video, third-party tools or media types, etc.

Rating control 2622 is selected to define a rating filter. The rating filter includes only those learning packets that have a selected rating as being within the search scope. For example, a rating filter can be all learning packets having a rating greater than a selected value. Other embodiments include ranges of ratings, or ratings lower than a given value.

In some embodiments after selection of a filter control, another dialog window (such as a pop-up window, pull-down menu, text-entry field, etc.) or other prompt is displayed to receive additional input from the user, such as to prompt the user to input or select the parameters (e.g., education level(s), subject(s), textbook, course, etc.) for the filter. Some embodiments also or alternatively search through tags (e.g., such as defined in tags window 1616, shown in FIG. 16) associated with a learning packet to determine whether a given learning packet is within the defined search scope and should be included within the search results. Additional or fewer filter controls are provided in some embodiments. For example, in some embodiments an activity control is provided to allow filtering of search results according to a level of activity associated with each search result.

In some embodiments a user can define customized search preferences, such as through the user's settings page 1000 (shown in FIG. 10). For example, the user can specify a current or favorite school, subject, area of expertise, course, or other information. This information is then used by search engine to define custom search results in which relevancy ratings are adjusted based on the user's settings, such as to increase the relevancy rating of learning packets that are associated with the user's school.

Recent searches window 2604 is provided in some embodiments to display a list of recent searches that the user has entered, such as to allow the user to quickly rerun a previously entered search by selecting the recent search.

In another possible embodiment, suggestions of other related searches that may provide better or different search results of interest to the user are displayed in a related searches window similar to window 2604.

In another possible embodiment, learning system 100 stores anonymous usage statistics. Examples of usage statistics include data regarding the frequency in which search terms are entered as a search query, the frequency at which a user accesses learning packets based on a given search query, and other usage statistics. The usage statistics are used in some embodiments to suggest search queries that have been frequently used or successful for other users. In some embodiments, related searches window 2604 displays a search term cloud, including a list of possible search terms. Each search term in the search term cloud is displayed in a font size proportional to one or more usage statistics associated with the term. For example, a very frequently used term is displayed in a large font size, while a less frequently used term is displayed in a smaller font size. The search terms are selectable in some embodiments to execute a search query including the selected search term.

In some embodiments, learning system 100 saves search queries for subsequent use. For example, a user can save a list of common search queries, and select a search query from the list to re-run the search query, such as to check for updates. In another possible embodiment, learning system 100 provides notifications based upon a saved search query, such as to alert the user when the search results associated with the saved search query have changed.

Some embodiments provide suggested or recommended content to a user automatically. For example, in some embodiments a user is provided with an online learning approach assessment, and the results of the survey are processed to determine the user's learning style. Examples of learning styles are linguistic and kinesthetic. The learning style is then used by the system as one factor in considering what learning packets may be the most helpful and useful to the user. In other embodiments, other assessments are used to assess a user's learning approach. In another possible embodiment, the user records learning preferences, such as an education level, a list of subjects or topics that the user is particularly interested in, or other information. The system then compares this information to learning packet data to determine what learning packets to recommend to the user. Recommended learning packets or users can be displayed in search results, for example, as links on a learning packet (“Click here to view our other recommended learning packets relating to this subject,” in a sidebar display, or in other locations. When displayed in search results, the recommended content can be promoted to a prominent location in the search results (e.g., the first result), highlighted to indicate that it is a recommended result, or displayed in a separate recommendation section of the search results.

In some embodiments, the system monitors the user's activities within the learning system to predict how the user learns best, such as by recording previously consumed content, topics that have been searched, etc. The system is operated to carefully protect all such user data, and to use all such data according to a clearly defined terms of use agreement and privacy policy. Based on the information that is gathered, the learning system 100 can recommend particular learning packets that are appropriate to the user's preferences, assessments, and/or previous behavior. Additional information that can be used by the learning system to provide a recommendation includes: other packets that the user has consumed, other packets that the user's friends like, packets that were liked by others who have similar characteristics to the user; and packets based on self described interests, demographics, etc.

FIGS. 27-28 illustrate an example media bucket window 2702, such as for storing media items in learning system 100 for subsequent use. Media bucket window 2702 provides a user with a convenient location to store media items in learning system 100. The media items may include, for example, media items that the user enjoys or found helpful, media items that the user wants to keep for inclusion in a future learning packet, media items that the user wants to share with others, etc. In some embodiments, each media item is tagged as being either public or private. In some embodiments, private media items are not publicly searchable within learning system 100, while public media items are publicly searchable. In some embodiments the user that provides the media identifies the media item as being public or private. In some embodiments, a copyright notice or disclaimer is associated with the media item. In some embodiments, a copyright license notice is associated with the media item, such as a Creative Commons license notice. In some embodiments, the copyright license notice is displayed with the media item in learning system 100.

In this example, media bucket window 2702 includes separate pages for storing different types of media, such as videos, images, or audio. The video tab is currently selected in FIG. 27. Within the video page of media bucket window 2702 are icons 2710, 2712, etc. representing each video media item. In other embodiments, media bucket window 2702 displays a list of media items. Each media item is selectable, in some embodiments, to open the media item, such as to initiate a media player (such as an audio or a video player) or otherwise output the media item (e.g., display an image) for the user to review. In some embodiments the icons 2710 and 2712 are associated with a copy of the respective media item, such as stored in user data 422 (shown in FIG. 4) or elsewhere in learning system 100.

In some embodiments, icons 2710, 2712, representing media items, can be edited. An editing operation is initiated, for example, by selecting edit control 2720. In some embodiments, the editing operation receives information from the user that is saved as metadata (e.g., title, description, access control, etc.). Other possible examples of editing operations include trimming, cutting, or inserting portions of a video media item, cropping an image, annotating a media item, adjusting a quality or resolution of a media item, or a wide variety of other possible editing operations. In some embodiments, editing capabilities are provided by or are performed by functional add-on provider 132 (shown in FIG. 1).

A preview of a media item 2710, 2712 is provided by selecting preview control 2722, in some embodiments.

To add a new media item, an add media item control 2730 is selected. The user is then prompted to identify the media item, such as by browsing a local drive to identify the media item, or by entering a URL or other identifier of the media item.

FIG. 28 is a screenshot of the example media bucket window 2702 while a media item is being uploaded to learning system 100. In this example, media bucket window 2702 includes an upload page that shows the progress of the uploading media item, and provides fields where the user can provide additional information about the media item. For example, the upload page of media bucket window 2702 includes status bar 2802, video title field 2804, caption field 2806, save control 2808, and upload controls 2810. Status bar 2802 shows the progress of the current upload, such as with a progress bar and indicates how much of the media item has been uploaded (e.g., a percentage). Video title field 2804 associates a title with the media item. Caption field 2806 associates a caption with the media item. Save control 2808 saves the information to computer readable storage media. If the user wants to upload another media item, upload controls 2810 are used to identify the next media item.

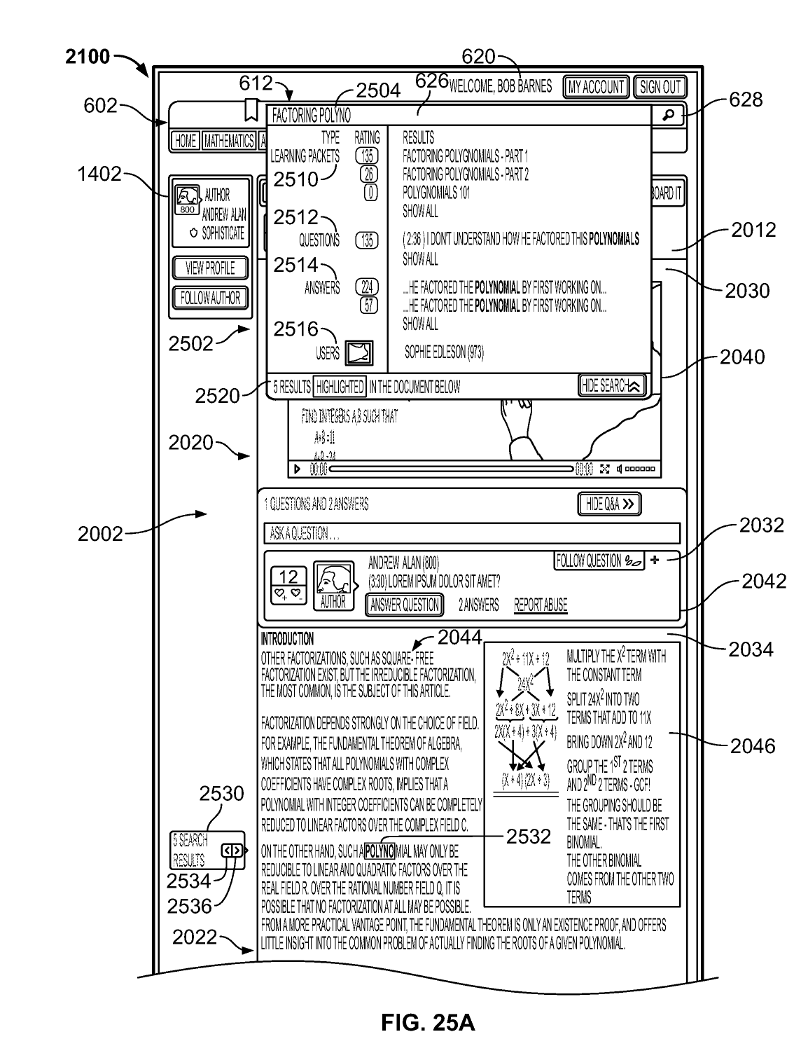

FIGS. 29-37 illustrate other exemplary screenshots of various possible user interfaces of learning system 100. In some embodiments, the user interfaces are displayed on a mobile computing device 106 to the mobile consumer U3 (shown in FIG. 1), and receives input from the mobile consumer U3.

FIG. 29 is a screenshot of an example login page 2900 that prompts a user to enter a username and password, or other identifying information.

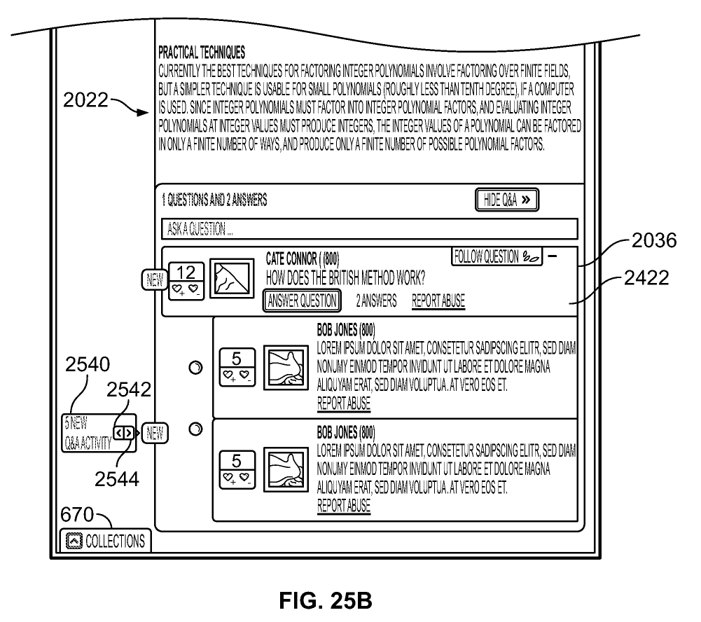

FIG. 30 is a screenshot of an example search page 3000 that receives a search query from a user.

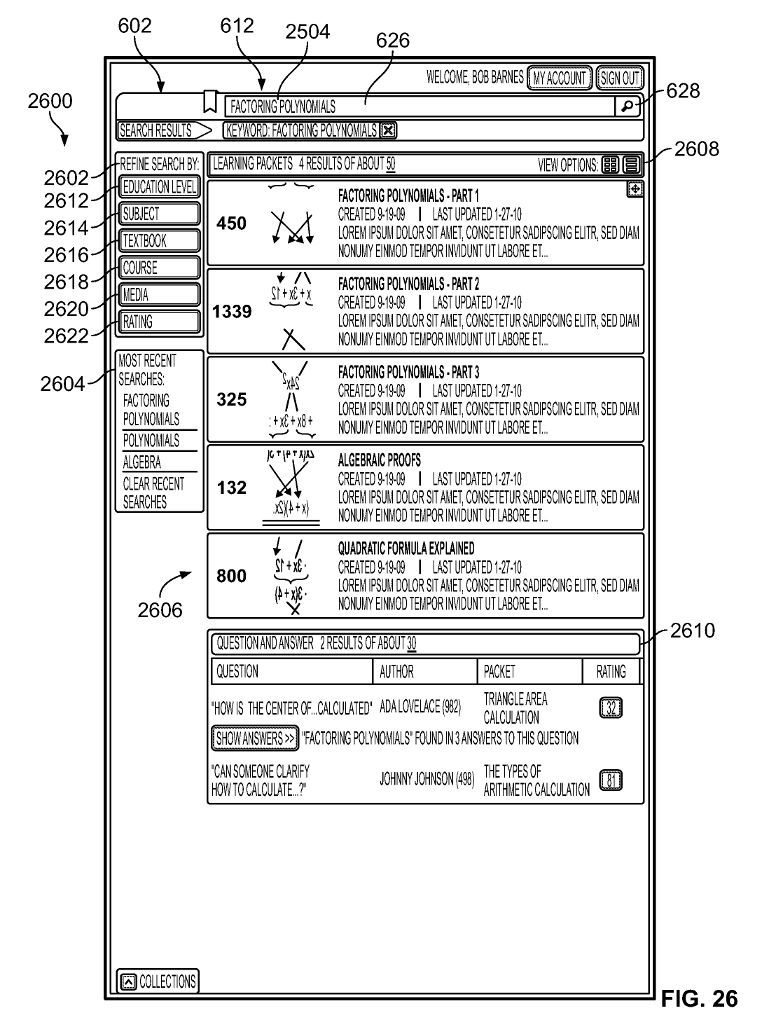

FIG. 31 is a screenshot of an example search results page, such as displaying search results in a similar manner to the search results window 2502 that is described herein with reference to FIG. 25.

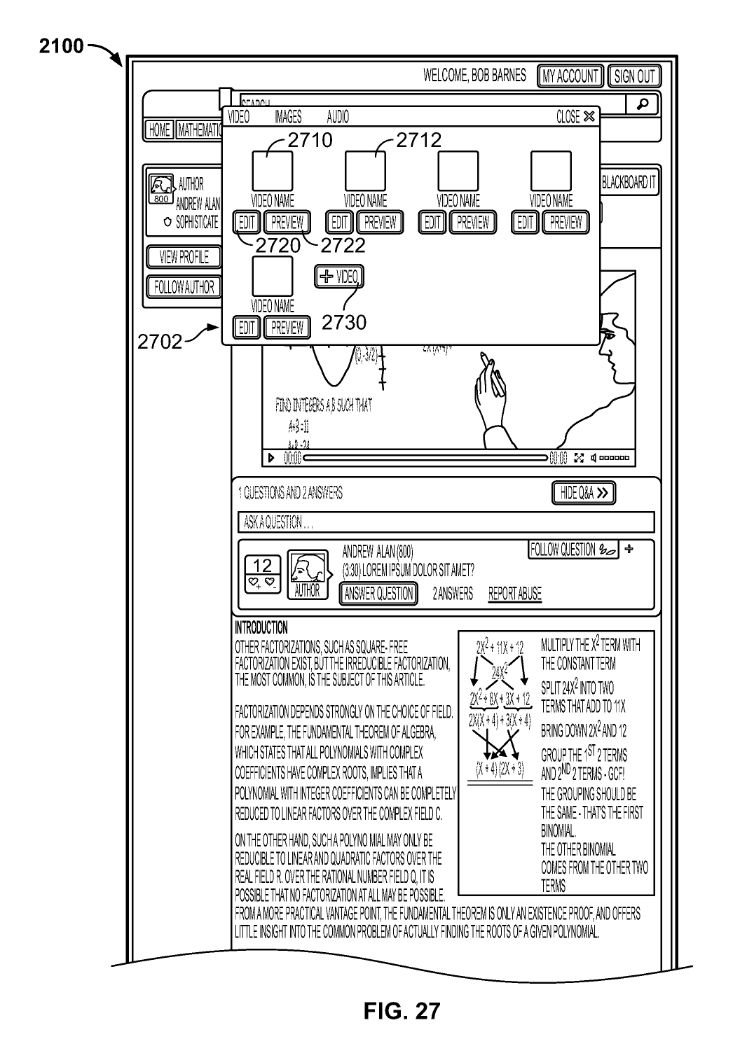

FIG. 32 is a screenshot of an example user profile page 3200, similar to profile page 1200, shown in FIG. 12. User profile page 3200 can display information about the current user or about another user of learning system 100.

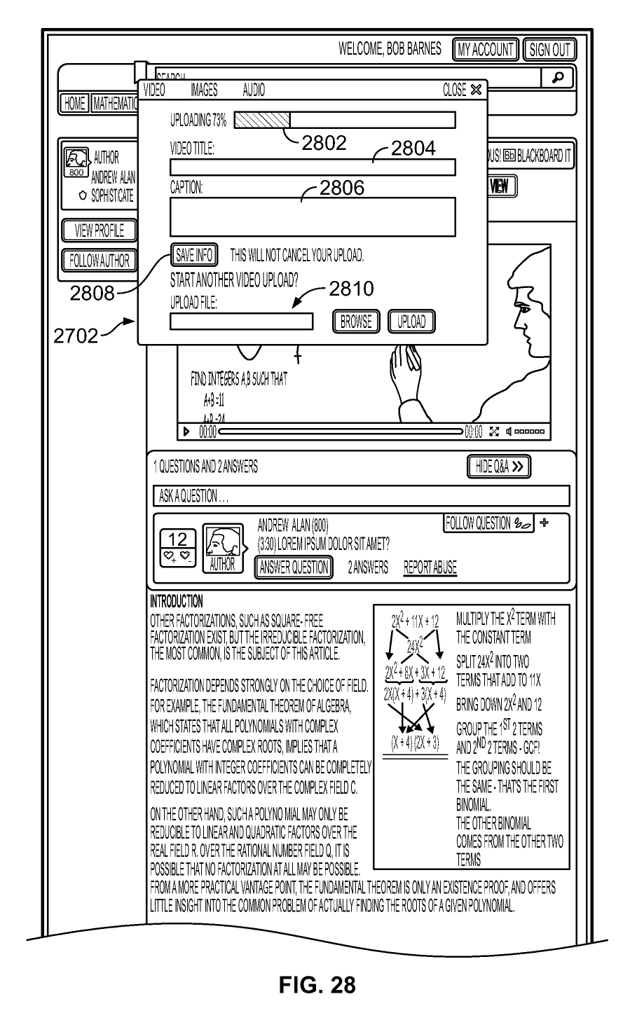

FIG. 33 is a screenshot of an example collections page 3300, similar to collections window 2202, shown in FIG. 22B. The collections page 3300 displays collections of learning packets that can be browsed by the user to locate specific learning packets of interest.

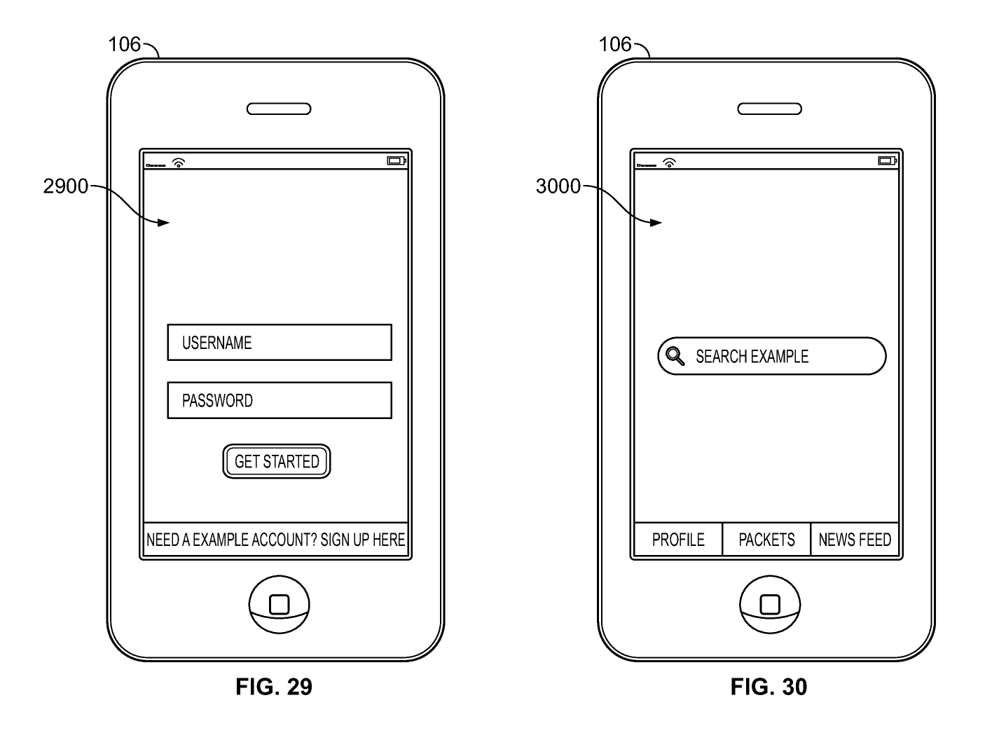

FIG. 34 is a screenshot of another example packets list page 3400, similar to packets page 800, shown in FIG. 8. In another possible embodiment, packets list page 3400 displays lists of packets (such as those contained within a collection selected in collections page 3300) that can be browsed by the user to locate specific learning packets of interest.

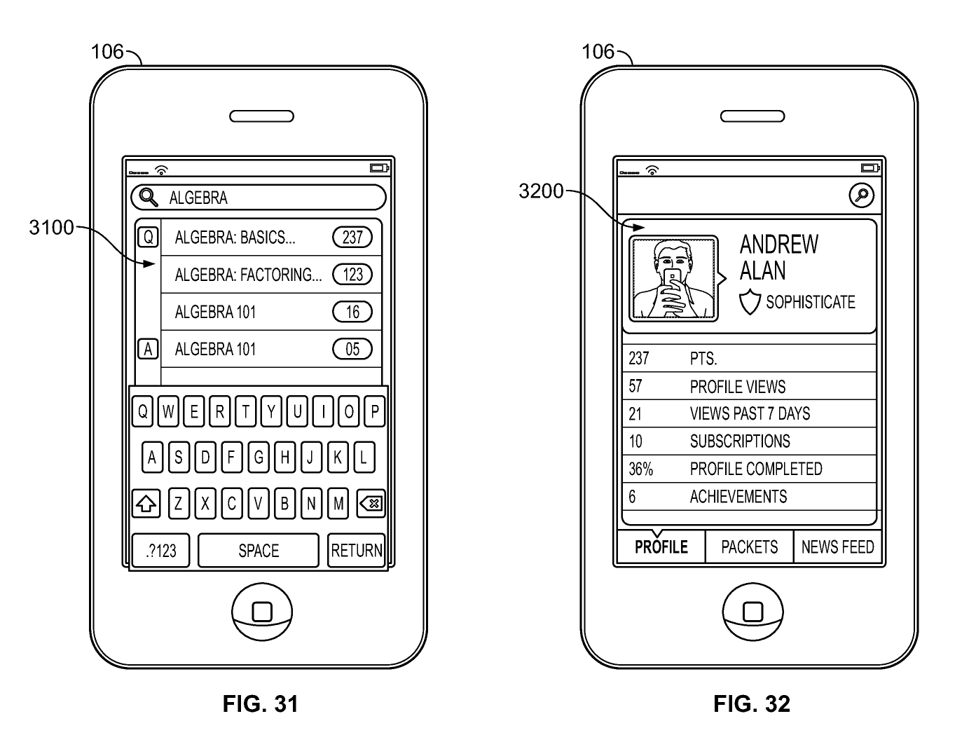

FIG. 35 is a screenshot of an example consumer public view page 3500 for a learning packet. In this example, consumer public view page 3500 includes icons representing each section of the learning packet, and a brief title or description of each section. The user can then select a section to view that section. In some embodiments, the learning packet is downloaded to a mobile computing device and available for later display through consumer public view page 3500 even if the mobile computing device is not connected to a communication network (e.g., even if the mobile computing device is “offline”).

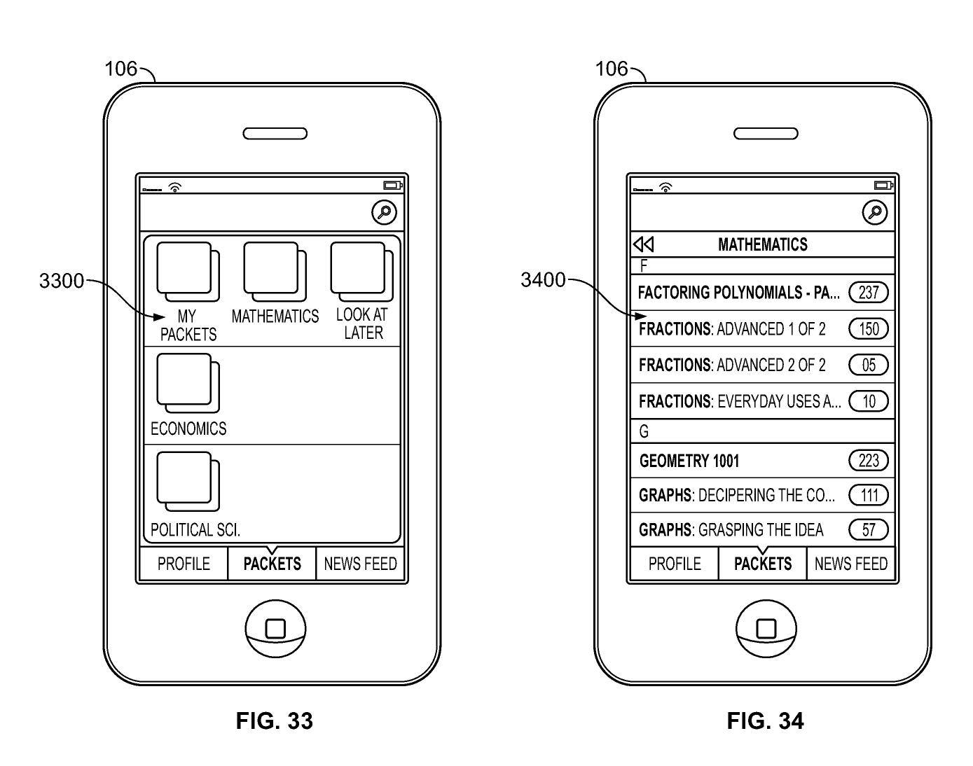

FIG. 36 is a screenshot of an example section view page 3600 that displays a section of a learning packet, such as the section selected from the consumer public view page 3500 shown in FIG. 35. In this example, a video content section is displayed, such as including a media player to play a video content element. Discourse associated with the content is also displayed in some embodiments of section view page 3600.

In some embodiments, learning packets or other information can be downloaded to the mobile computing device while the mobile computing device has a network connection, to permit the content to be viewed in an offline state. The downloaded information can then later be viewed at a convenient time, regardless of whether or not the mobile computing device has network access at that time. In some embodiments, feedback or other input provided by the user (e.g., discourse such as questions asked or answers provided) are stored by the mobile computing device until the mobile computing device is again connected to the network, at which time the information is uploaded to the learning packet server.

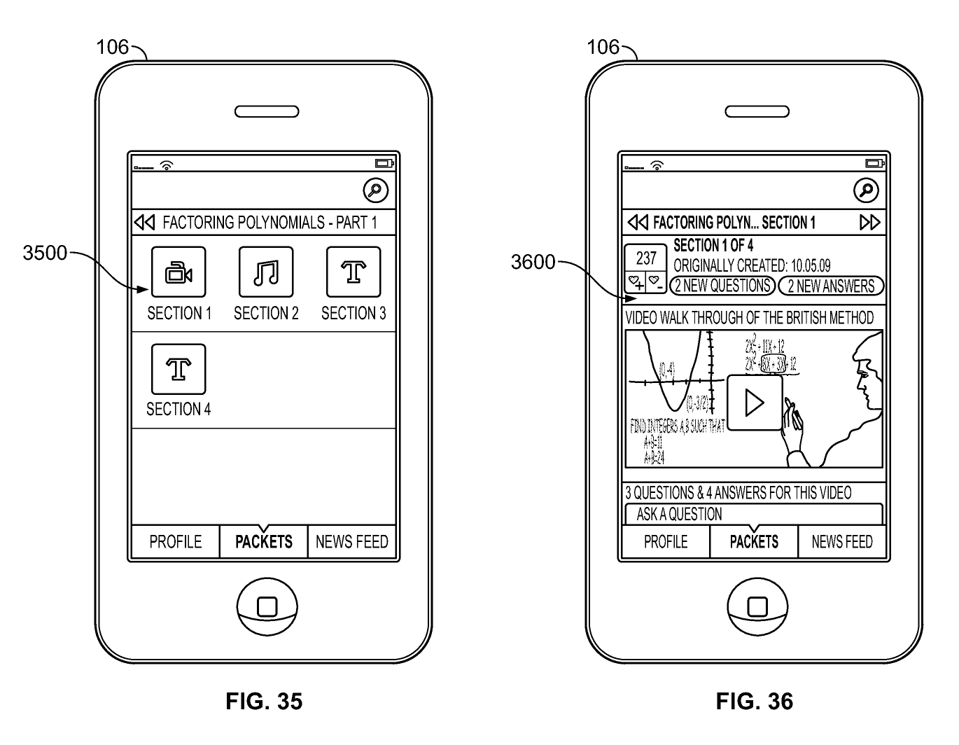

FIG. 37 is a screenshot of an example event feed page 3700, similar to the event feed portion of dashboard page 600, shown in FIG. 6, that displays notifications relating to the current user's subscriptions. In another possible embodiment, event feed page 3700 is a dashboard page.

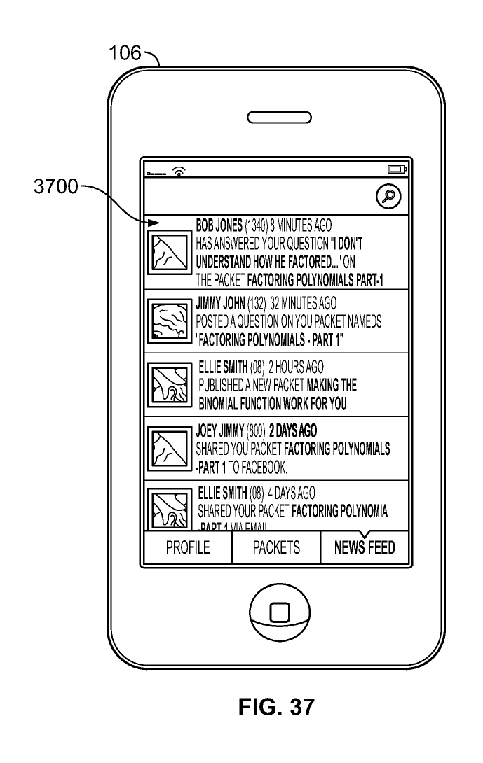

FIG. 38 is a screenshot of an example page 3802 of an example event listener 136 (shown in FIG. 1). More specifically, the example event listener 136 is a feed aggregator 3800. Before discussing the screenshot shown in FIG. 38 in detail, an explanation of the interaction between learning system server 110 and an example event listener 136 is provided below.

In some embodiments, learning system server 110 includes event management module 334 (shown in FIG. 3) that operates to detect when events occur within learning system 100, and to communicate information about the events to subscribers, such as through web syndication. In some embodiments, subscribers include third-party event listeners 136, such as feed aggregator 3800.

For example, in some embodiments the event management module 334 operates to publish Really Simple Syndication (“RSS”) feeds that are accessible to event listener 136 (shown in FIG. 1) across network 120. Other data communication standards are used in other embodiments. In some embodiments, the RSS feed includes full or summarized text (or other content) along with metadata, such as the relevant timestamp(s), author identification(s), ratings, reputations, and one or more links (e.g., URL's) to the learning system server. Some embodiments utilize an XML language for web feeds, such as the Atom Syndication Format.

In some embodiments, at least some units of information within learning system 100 are associated with a separate RSS feed. Examples of units of information include learning packets, portions of learning packets (e.g., a section, content, discourse, etc), sets of learning packets sharing a common characteristic (e.g., common subject, title, author, media type, etc.) a user profile, contributions of a particular author, etc. or combinations of these. In some embodiments, event management module 334 generates an RSS feed for each unit of information. When a request for a unit of information is received from an event listener, for example, the event management module responds with the requested feed.

In some embodiments, requests are submitted to event management module (through network interface module 302) in the form of a URL. The URL is received by the event management module 334 and interpreted to identify the unit of information that is being requested. As one example, if a user of feed aggregator 3800 had subscribed to the event feed for the user Cate Connor, the feed aggregator 3800 can utilize the URL “www.example.com/feeds/user/cateconnor/” to periodically check for new updates. Event management module 334 would then, for example, respond to feed aggregator 3800 with the author's event feed, such as including a summary or full text of the author's recent activities within learning system 100. As another example, a URL “www.example.com/feeds/subject/mathematics/factoringpolynomials/” is used to check for updates within learning system 100 involving the subject of mathematics, and more specifically regarding factoring polynomials. Event management module 334 response, for example, with an event feed identifying all new contributions associated with the given subject. In this example, the URL of “www.example.com” is a hypothetical URL to learning system server 110 (shown in FIG. 1).

In some embodiments, each learning packet is associated with an RSS feed, which is accessible through a URL. An example of a learning packet URL is www.example.com/feeds/learningpacket/62548921, where 62548921 is a unique identifier of the learning packet. Another example of a learning packet URL is www.example.com/user/cateconnor/learningpacket/factoring_polynomials_part1/.” Other units of information are also associated with URLs in some embodiments. A wide variety of protocols can be used in other embodiments to identify feeds associated with units of information within learning system 100.

Returning now to the example feed aggregator page 3802, shown in FIG. 38, of an example feed aggregator 3800. The feed aggregator page 3802 includes an event feed 3810 of the user Bob Jones (as shown in user identifier 3804).

Feed aggregator 3800 generates event feed 3810 that combines information from a variety of different sources, based on a set of subscriptions defined by the user. In this example, the user has subscribed to the event feed of the user Cate Connor in learning system 100. As a result, events generated by the subscription are routed to feed aggregator 3800 by learning system server 110. Feed aggregator 3800 receives the event notifications for Cate Connor from learning system 100 as one of the sources of information for event feed 3810. The event feed 3810 displays notifications received from each source as separate items 3812, 3814, 3816, and 3818. In this example, item 3812 includes information from learning system 100, and specifically identifies a new answer that was recently posted by Cate Connor to a question within a learning packet.

In some embodiments, a user's event feed 606 within learning system 100 (such as shown in FIG. 6) is also associated with its own RSS feed. In this way, a user can choose to receive event feed 606 through a third-party event listener 136, such as feed aggregator 3800.

FIG. 39 is a screenshot of an example event feed page 3902 of another example event listener 136 (shown in FIG. 1). More specifically, the example event listener 136 is a social networking system 3900.

Event feed page 3902 is provided by a third-party social networking system 3900, such as for a user Bob Jones (as indicated by user display 3904). An example of a third-party social networking system 3900 is the Facebook® social networking system. The event feed includes multiple news items, such as items 3910, 3912, 3914, etc.

In this example, news item 3912 illustrates how information from learning system 100 can be shared with friends on social networking system 3900. For example, when a user Cate Connor finds a learning packet that she finds helpful, the user can select the post to personal page control 2072 of third-party controls 2070, shown in FIG. 20. Upon selection of control 2072, a message is communicated to the event listener 136 to generate a post in the event listener 136, which in this case is social networking system 3900, about the learning packet. In some embodiments the user is prompted to provide a description or note to be associated with the post. In this example, event feed page 3902 of the user Bob Jones (indicated in user display 3904) displays event item 3912, which states that his friend Cate Connor found a learning packet in learning system 100 that was helpful for her algebra homework this week. Event item 3912 includes a selectable link to the learning packet, in some embodiments.

In some embodiments, learning system 100 includes a single signon option to allow a user to log into learning system 100 as well as one or more third-party systems at the same time. For example, learning system 100 prompts the user to provide login information (such as a username and password) for one or more third-party systems. The information is then stored, such that learning system 100 can automatically log in the user to the third party system upon the user's successful login to learning system 100. Learning system 100 and the third-party system can then operate, for example, to sharing information relating to the current user.

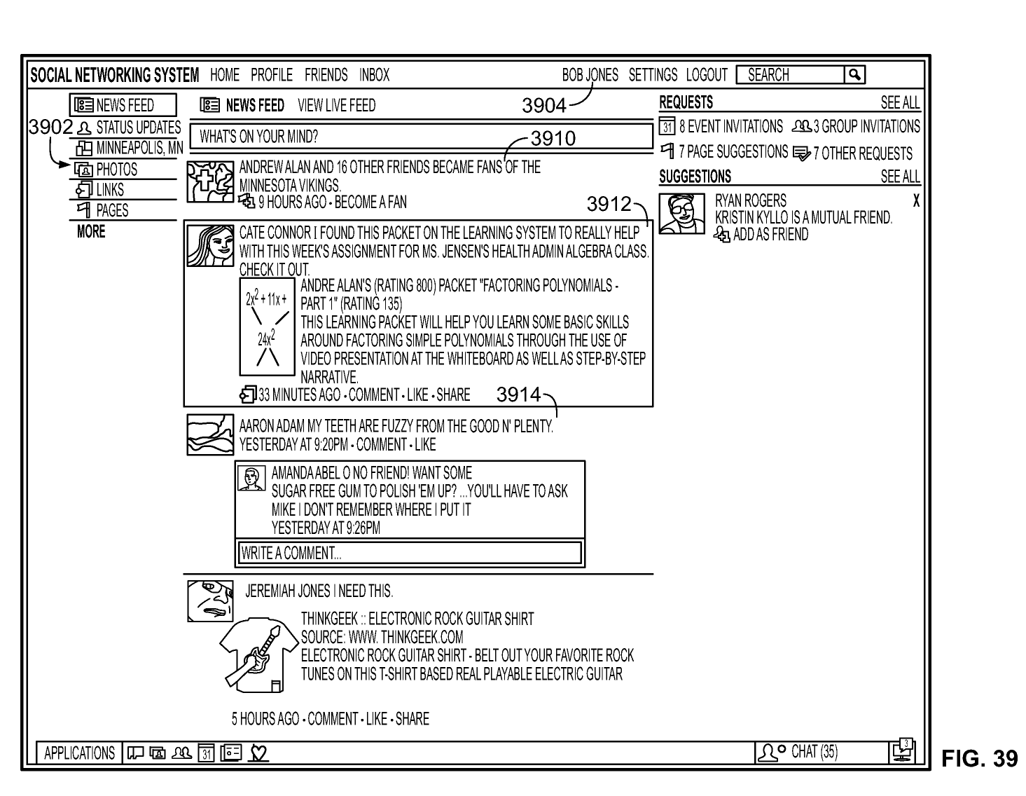

FIG. 40 is a screenshot of an example course page 4002 of an example third-party educational system 138 (shown in FIG. 1). In some embodiments, learning system 100 interacts with one or more third-party educational systems 138, such as through educational system interface module 336. In this example, course page 4002 is a page of the educational system that is associated with a particular course (e.g., BUS4013). The page includes a course table of contents window 4004 and a unit details window 4006. The table of contents window 4004 identifies, for example, the various units of the course, and provides links to particular information for each unit, such as homework assignments, discussion forums, online quizzes, etc. When particular information is selected in table of contents window 4004, that information is displayed in unit details window 4006. In this example, the objectives and learning activities for Unit 1 of the course are shown in details window 4006.

In some embodiments, the course page 4002 also displays related content window 4008. As one example, the information within related content window 4008 is provided to third-party educational system 138 by educational system interface module 336. In some embodiments, the related content window 4008 identifies learning packets within learning system 100 that are related to a particular course, or otherwise may be helpful or of interest to a student of the course. For example, content window 4008 includes items 4010, 4012, 4014, and 4016. Each item identifies a learning packet that provides additional information on a given topic.

In some embodiments, the learning packets are selected by a course instructor, teacher, professor, or educational institution administrator. For example, the course instructor searches for relevant content and then tags the content using an educational system control 2076 (shown in FIG. 20). As another example, the course instructor or teachers assistant generate learning packets, and then associate the learning packets with the course through the information tab of the learning system. In another embodiment, learning packets displayed in content window 4008 are associated with the course, unit of the course, or other portion of the course, such as through the course field 1702 of the learning packet (shown in FIG. 17), a unit field, etc. In yet another possible embodiment, students or other users tag learning packets as being associated with the course, or a portion of a course, such as with an educational system control 2076 (shown in FIG. 20). In another possible embodiment, relevant learning packets are automatically identified by learning system 100, such as by performing keyword searches based upon keywords present in course page 4002, and/or keywords present in another section, such as the course learning objectives. In some embodiments a ranking function is used by learning system 100 to identify a set of learning packets considered to be most relevant to course page 4002.

Some embodiments of content window 4008 include a view more results control 4020, which displays additional results to the user. Some embodiments of content window 4008 include a create learning packet control 4022, which causes learning system 100 to display editor page 1400 for creation of a new learning packet. Other embodiments include other controls.

Other embodiments include other possible windows 4008. For example, some embodiments include a word cloud including possible search terms. The search terms are selectable. When a search term is selected, learning system 100 performs a keyword search and displays a list of search results, such as through search results page 2600 (shown in FIG. 6), or another user interface. In some embodiments, words included in the word cloud are present or similar to words in course page 4002.

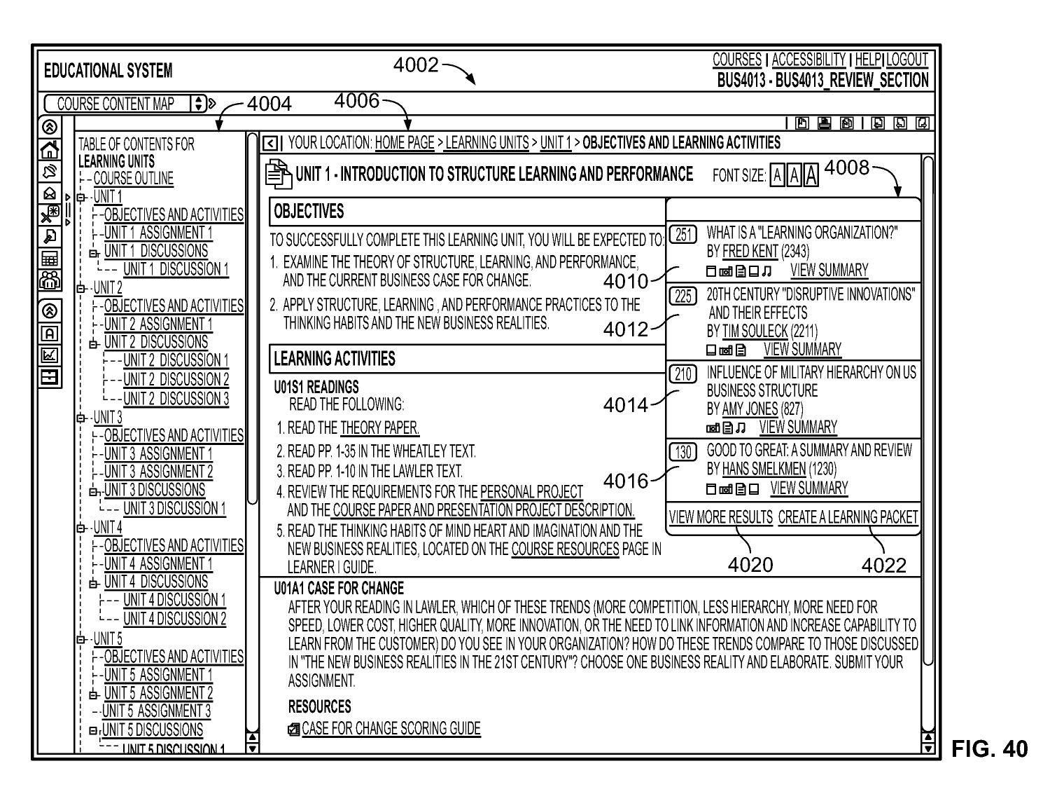

FIG. 41 is a screen shot of an example home page 4100 of learning system 100. In this example, home page 4100 includes search bar 4102, filter menu 4104, statistics window 4106, learning packets window 4108, introduction window 4110, recent activity window 4112, and blog window 4114.

Search bar 4102 provides a prominent location at or near the top of home page 4100 where the user can enter a search query to quickly begin searching for learning packets on a given topic. Upon entry of a search query, the learning packet performs a search and displayed the results in a search results window (such as shown in FIG. 23) or a search result page (such as shown in FIG. 26).

Filter menu 4104 provides various controls for filtering the set of learning packets displayed in learning packets window 4108. In this example, filter menu 4104 includes filter by category control 4120, featured packets control 4122, highest rated packets control 4124, highest earnings control 4126, most shared packets control 4128, and most followers control 4130. Filter by category control 4120 can be used to apply a category filter to the learning packets shown in learning packets window 4108. In this example, the selected category is all. Upon selection of the filter by category control 4120, one or more categories can be selected. An example of a category is a subjects (e.g., biology, mathematics, etc.). Any other information tagged to or otherwise associated with a learning packet can be used as categories in other embodiments. Once the category has been applied, learning packets window 4108 is updated to show only learning packets within the category.

In addition to category control 4120, one of controls 4122, 4124, 4126, 4128, and 4130 can be selected in some embodiments to adjust the set of learning packets displayed in learning packets window 4108 to show featured learning packets, highest rated learning packets, learning packets that have earned the most money or points, learning packets that have been shared the most frequently with others, or learning packets that have the most users following them.

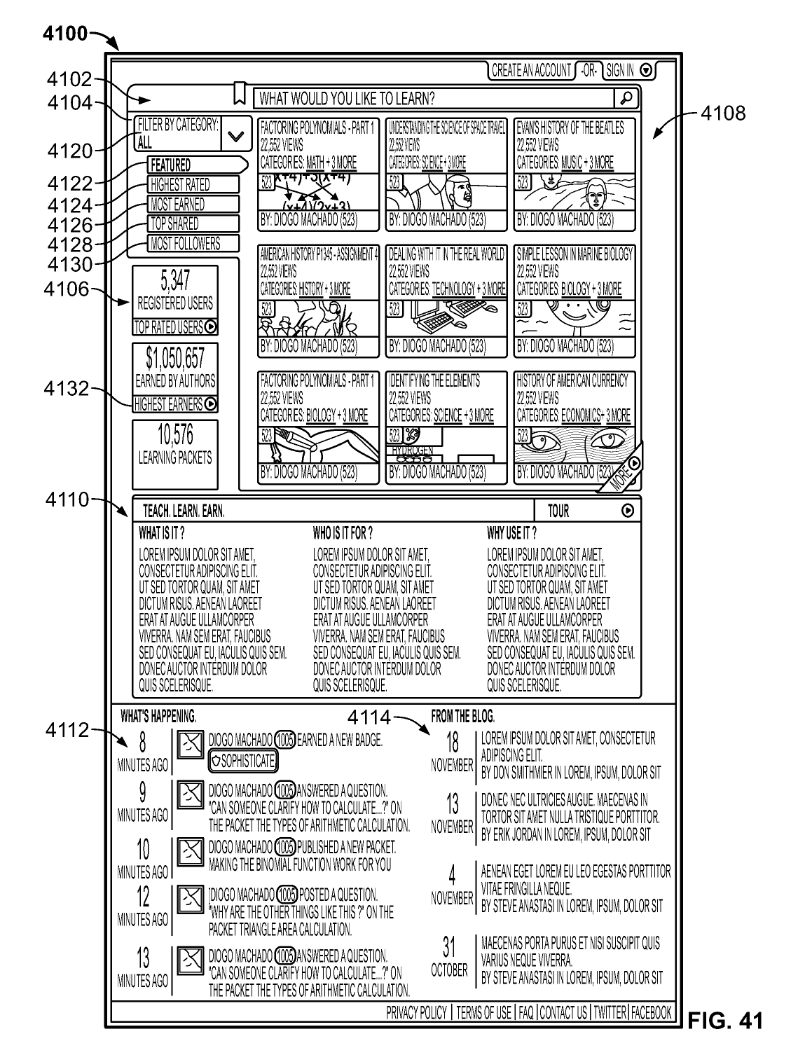

Various statistics can be displayed in statistics window 4106 in some embodiments. In this example, statistics window 4106 displays the number of currently registered users in the learning system, the amount of money that has been collectively earned by authors through the learning system, and the number of learning packets that are in the learning system. Links to additional information (e.g., a list of the top rated users or highest earning users) are also provided in some embodiments. For example, link 4132 is provided in some embodiments. Link 4132 is associated with a leader board page 4200 (shown in FIG. 42) that displays a list of the users that have earned the most money through the learning system. In other possible embodiments, however, the leader board displays those users that have obtained a highest rating or points total.

In some embodiments, home page 4100 includes introduction window 4110. Because home page 4100 will often be the first page of learning system 100 that a new user encounters, a brief introduction to the system is provided in introduction window 4110. For example, introduction window 4110 describes what the learning system is, who it is for, and why a user would want to use it. In some embodiments a link to a tour is provided. The tour provides a more detailed overview of the system in a written and/or graphical form. In some embodiments the tour is a video or animation that educates the user on various aspects of the learning system.

In some embodiments, home page 4100 includes a recent activity window 4112 that displays several of the most recent activities that have occurred within the learning system. Activities can include, for example, a user being granted a new achievement award, a user answering a question in a learning packet, the publication of a new learning packet, publication of an updated learning packet, posting a question to a learning packet, or other activities within the learning system. The recent activity window 4112 provides a glimpse into the activity that has recently occurred within the system, and may suggest to the user that a lot of activity is going on within the system.

Home page 4100 also includes, in some embodiments, a blog window 4114 that displays posts, or portions of posts, from a blog associated with the learning system. The blog can be authored, for example, by a system administrator, president or leader of the learning system (or associated institution), etc. In some embodiments blog window 4114 is linked to the primary blog web page.

FIG. 42 is a screen shot of an example leader board page 4200. In some embodiments, leader board page 4200 is a home page, as an alternative to home page 4100, shown in FIG. 41. In other embodiments, leader board page 4200 is another page of learning system 100. In this example, leader board page 4200 includes search bar 4202, sort controls 4204, statistics window 4206, users window 4208, introduction window 4210, recent events window 4212, and blog window 4214. In some embodiments search bar 4202, statistics window 4206, introduction window 4210, recent events window 4212, and blog window 4214 are the same or similar to search bar 4202 and windows 4106, 4110, 4112, and 4114 illustrated and described with reference to FIG. 41, and are therefore the descriptions of these components are not repeated below.

Sort controls 4204 are selectable by the user to identify a sorting order for users identified in user window 4208. In the example shown in FIG. 42, the highest earners control 4220 is selected, which causes users window 4208 to display a set of the users that have earned the most money or points within the learning system. Other sort controls 4204 are provided in some embodiments, such as to identify the top rated users, the most active users, the users that have asked the best questions, and the users that have provided the best answers to questions. Upon selection of a sort control 4204, users window 4208 is updated to show an updated set of users sorted in the identified order.

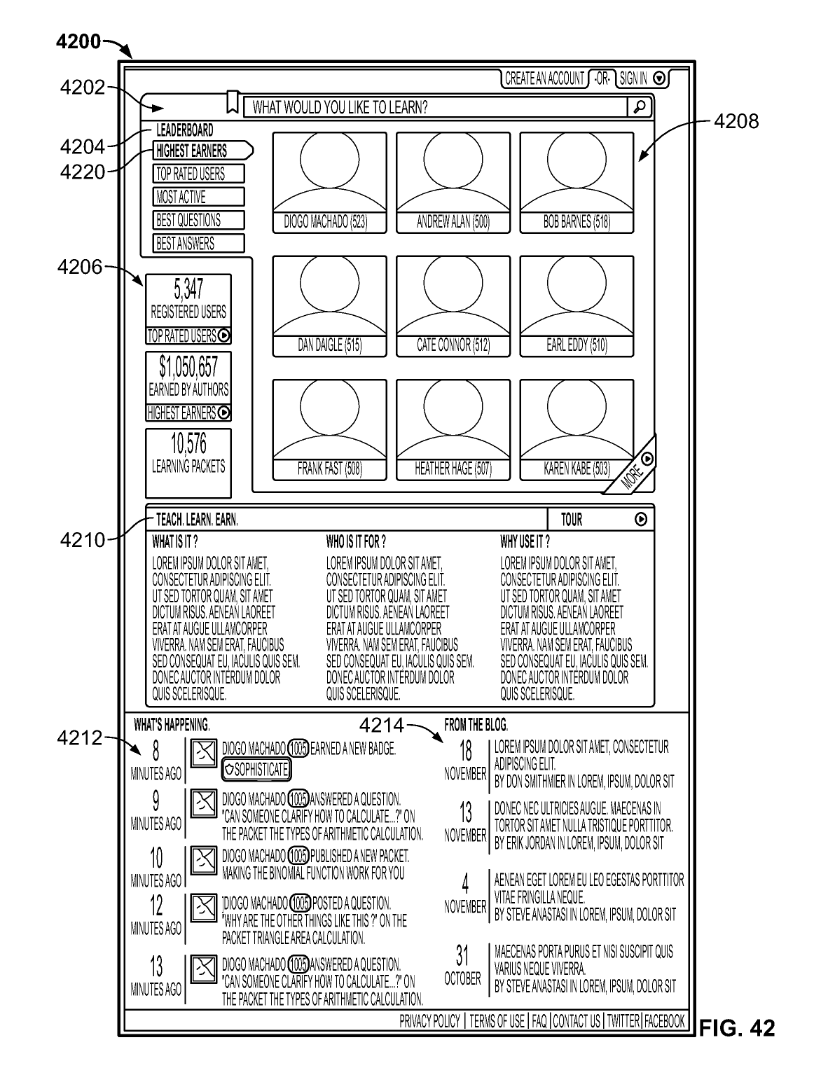

FIGS. 43-46 illustrate an example of a user's public profile page 4300. In some embodiments, public profile page 4300 is an alternative to the public profile page 1300, shown in FIG. 13. Public profile page 4300 allows users to view information about other users (or themselves) in learning system 100, and to quickly access learning packets associated with that user.

In this example, public profile page 4300 includes search bar 4302, user statistics window 4304, contact window 4306, achievements window 4308, statistics window 4310, and tabbed windows 4312.

Search bar 4302 is provided to receive a search query to search for learning packets or other information within learning system 100, as discussed herein.

User statistics window 4304 displays some brief statistics about the user, or other information. In this example, the user statistics window 4304 includes a thumbnail image, the user's name, the reputation points score of the user, the length of time that the user has been a member of the learning system, and when the user last logged in or otherwise interacted with learning system 100. As always, all personal information stored within learning system 100 is maintained and managed according to a clear terms of use agreement and privacy policy, which are presented to the user prior to gathering such information. In addition, in some embodiments the information that can be viewed by the public must be approved by the user, such as by selecting publication settings for the public user profile. In some embodiments, therefore, the user can opt out or otherwise instruct learning system 100 not to display some or all of the user's information publicly. In some embodiments the user can instruct the learning system not to store certain information relating to the user, as desired. These and other precautions are taken in various embodiments to permit the user to choose whether or not information should be displayed publicly by learning system 100.

In some embodiments, contact window 4306 provides controls connecting with the user. In this example, contact window 4306 includes a control 4322 to e-mail the user. Upon selection of control 4322, an e-mail dialog window is opened where the consumer can enter a message to be delivered to the user. In some embodiments the user's actual e-mail address is not displayed. Instead, the message is delivered through learning system 100 to the user, or by learning system 100 sending the e-mail to the user's e-mail address without displaying the e-mail address to the consumer. In yet another possible embodiment, the e-mail address is displayed so that the consumer can send an e-mail to the consumer directly without sending the message through learning system 100. A follow author control 4324 is also provided in some embodiments. Upon selection of the follow author control 4324, the consumer is subscribed to the event feed of the user whose profile is currently being viewed, such as to notify the consumer when the user authors a new learning packet, etc.

Achievements window 4308 displays, for example, graphical representations of or descriptions of achievements that the user has obtained through learning system 100.

Statistics window 4310 displays additional statistics. Examples of statistics include the total number of times the users profile has been viewed by another user, the number of profile views during a recent period of time (e.g., hour, day, week, month, etc.), the number of achievements that have been received, and a summary of the feedback that the user has provided to other learning packets, content, or discourse, such as the number of positive or negative votes or comments provided. In some embodiments, the summary of the feedback is selectable by a consumer, and upon selection, a list of the learning packets, content, or discourse that was positively or negatively rated by the user is listed. In some embodiments the statistics window 4310 includes controls that allow the consumer to vote on the current user, such as to indicate whether the user is knowledgeable in a given area, or whether the user has provided high quality information within learning system 100.

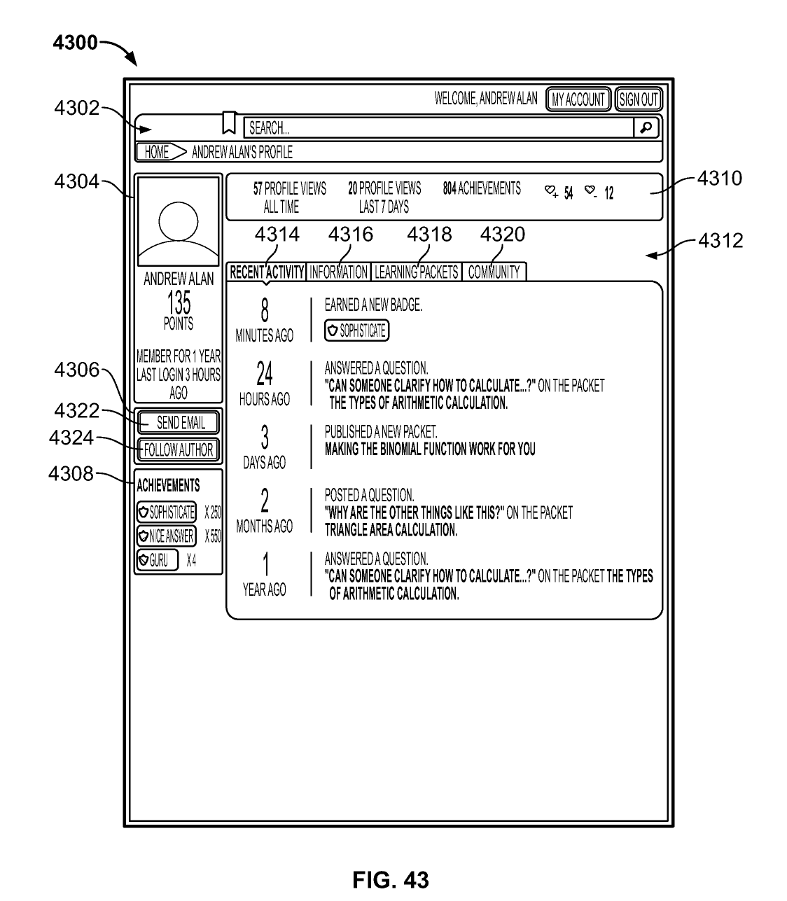

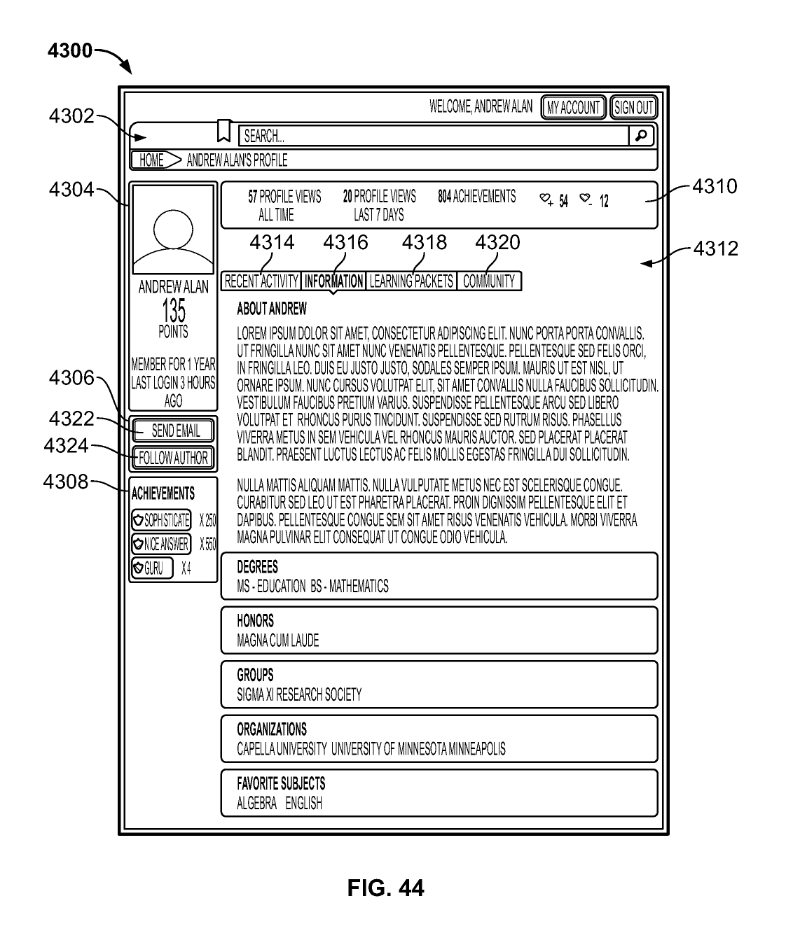

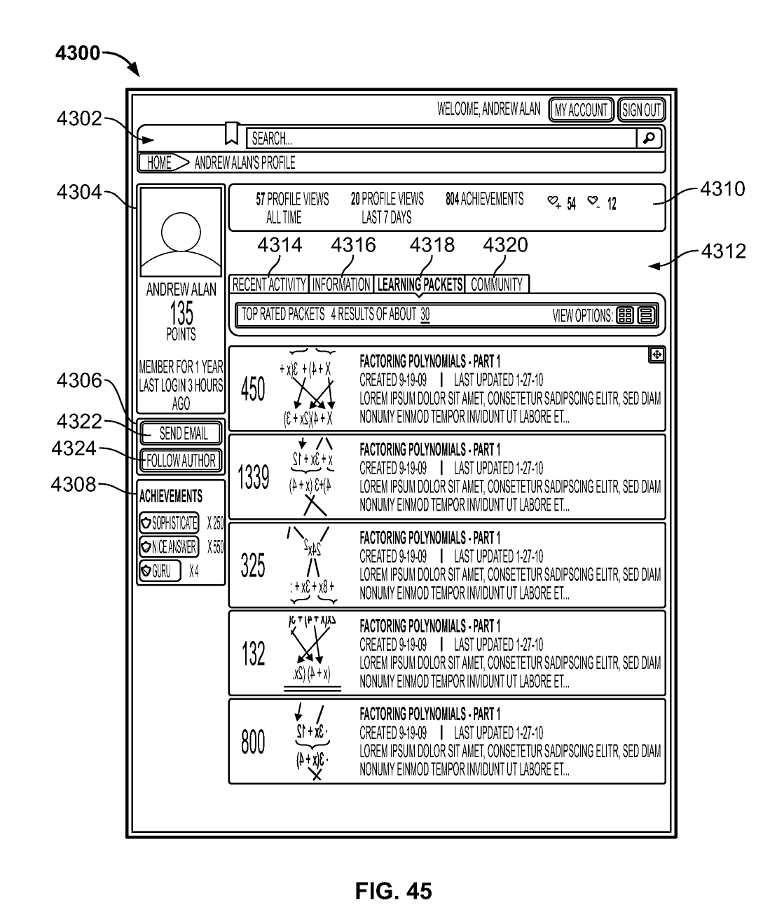

FIGS. 43-46 show various windows of tabbed windows 4312. FIG. 43 illustrates public profile page 4300 when the recent activity tab 4314 is selected. FIG. 44 illustrates public profile page 4300 when the information tab 4316 is selected. FIG. 45 illustrates public profile page 4300 when the learning packets tab 4318 is selected. FIG. 46 illustrates public profile page 4300 when the community tab 4320 is selected.

Recent activity tab 4314 displays the user's recent activity within learning system 100. Examples of recent activity include obtaining an achievement, answering a question, publishing a new packet, posting a question, or other activities discussed herein that have occurred within a recent period of time, or a set of activities that have occurred most recently (e.g., the five most recent activities for the user).

Information tab 4316 (FIG. 44) displays information about the user, such as a brief summary or biographical statement, degrees earned, honors received, group memberships, organizational memberships, and favorite subjects or topics of expertise.

Learning packets tab 4318 (FIG. 45) displays information about learning packets that have been authored by the user. For example, a list of the learning packets is provided in a summary form. In another embodiment, a subset of the most popular or highest ranked learning packets is shown. In some embodiments the learning packets are grouped according to topic, subject, class, or other logical grouping.

Community tab 4320 (FIG. 46) displays information about other users that are associated with this user. In this example, the community tab window displays a list of users that are currently following this user, as well as a list of users that the user is following. In some embodiments the list can be sorted, such as by name, rank, age, school, grade level, or other criteria. In some embodiments, each line in the list is selectable and linked to that user's public profile page to display additional information about the user.

FIG. 47 is a screen shot of an example reputation score window 4700 that displays details about a user's reputation score. In this example, reputation score window 4700 includes the reputation score display 4702, along with a plurality of score dimension displays 4704, 4706, 4708, 4710, 4712, and 14714.

In some embodiments, quality and reputation management module 310 of learning system server 110 (shown in FIG. 3) operates to maintain a reputation score for each user, which is stored in quality and reputation data 426 (shown in FIG. 4). The reputation score can be used by learning system server 110 for a variety of purposes, such as to display the score on learning packets authored by the user (e.g., author information window 1402, shown in FIG. 20A) or on the user's public profile page (user rank 1334, shown in FIG. 13). The reputation score can also be used as a factor in providing relevant search results (e.g., a learning packet that was authored by a user having a high reputation score can be weighted more favorably than a learning packet that was authored by a user having a lower reputation score), or as the basis for granting awards or privileges to users within learning system 100. For example, a user who obtains a threshold reputation score can be given additional privileges within the system, such as to censor content, edit comments, provide academic review of content, etc.

The reputation score window 4700 can be displayed, for example, when a user clicks on the user's reputation score. The reputation score window 4700 is then displayed to provide more information about the reputation score. However, in another possible embodiment the details of the reputation score are visible only to that user that the score is assigned to.

In this example, the reputation score is displayed in the upper right corner of reputation score window 4700. In some embodiments, the reputation score is determined based on a plurality of reputation score dimensions (sometimes alternatively referred to as component scores), which are themselves displayed with score dimension displays 4704, 4706, 4708, 4710, 4712, and 4714. Each reputation score dimension provides a numerical score that represents an aspect of the user's activity within the learning system 100. Typically, each reputation score dimension is tied to a type of activity that has been determined to be beneficial to the learning system 100, and therefore acts to encourage those activities by rewarding the users that engage in those activities with a higher reputation dimension score. In this example, the reputation score is the sum of each of the individual reputation dimension scores (which can alternatively be referred to as “component scores”), and therefore an increased reputation dimension score typically results in an increased reputation score.

As one example, learning system server 110 generates and maintains six reputation dimension scores for each user (although other embodiments can include a different quantity of reputation dimension scores). The first reputation dimension is described as “Do Good Work,” and acts to reward users that provide high quality or useful information. The second reputation dimension is described as “Be Helpful,” and acts to reward users that help others, such as by answering a question with a helpful answer, or by authoring a learning packet that has been requested by another user. The third reputation dimension is described as “Be Active,” and acts to reward users that are actively participating in the learning system, such as by providing feedback on a learning packet, authoring a learning packet, asking a question, answering a question, etc. The fourth reputation dimension is described as “Keep the System Organized,” and acts to reward users that maintain the organization of the learning system 100, such as by completing the learning packet profile for a learning packet that the user has authored, associating a learning packet with a book, completing the user's public profile, etc. The fifth reputation dimension is described as “Follow the Rules,” and acts to reward users who follow the rules and encourage others to, such as by reporting abusive content, and not submitting content that is reported as abusive. The sixth reputation dimension is described as “Spread the Word,” and acts to reward users that spread the word about the learning system 100, such as by sharing content with a third party event listener 136 (shown in FIG. 1).

In some embodiments, each reputation dimension score has a raw score, and a normalized score. The raw score is a value that is the accumulation of all score changes (additions or subtractions) applied by the quality and reputation module based on activities within the system, for each reputation dimension. The raw score has no upper bound and will generally grow larger over the course of time, although it can also go down in some situations.

The reputation dimension score is the normalized score. The normalized score is a percentile ranking of the raw score as compared to the raw scores of the other users of the learning system 100. In some embodiments users that do not have any activity in a particular reputation dimension are not included in the computation of the normalized score. The normalized score is an integer that ranges from 0 to 100.

Once all of the reputation dimension scores have been determined, the overall reputation score is computed as the sum of the reputation dimension scores. In this example, the reputation score ranges from 0 to 600. It is recognized, however, that other embodiments can include other quantities of reputation dimensions, and different ranges of values for each dimension and for the overall reputation score. Further, the result can be scaled by applying additional multipliers, if desired. For example, the scores can be based on a 0 to 6 scale if each reputation dimension scores are each computed on a scale from 0 to 1.

An activity within the learning system that causes an adjustment to a reputation dimension score is sometimes referred to as a score event. The score event causes an increase or a decrease in a reputation dimension raw score, and therefore adjusts the user's normalized reputation dimension score and overall reputation score. Some score events are the result of an action taken by a user, such as voting “yes” on a learning packet in response to the question “was this helpful to you?” Some score events are the result of a threshold being crossed, such as when the user's reputation score exceeds a certain value.

A single score event can cause multiple changes to raw scores for multiple users. For example, when a user votes on a learning packet, the user receives an increment to their second reputation dimension score (“Be Helpful’) as well as to the fourth reputation dimension score (“Keep the System Organized”). In addition, the author of the learning packet receives an increment to the author's first reputation dimension score (“Do Good Work”). Therefore, the single score event causes three separate score transactions to occur. The learning system server maintains a record of all score transactions and resultant score events, such as within the quality and reputation data 426 (shown in FIG. 4).

A more detailed example of possible score events and associated score transactions will now be described, in which the following score events cause the learning system server to perform the following score transactions. This is only one possible example and other embodiments can use other scoring algorithms. As shorthand, the raw first reputation dimension score is referred to as the D-score, the second is referred to as the H-score, the third is the B-score, the fourth is the G-score, the fifth is the G-score, and the sixth is the K-score.

Creating a new account increases the user's B-score by 1. Completing the account profile increases the user's B-score by 1, and the K-score by 1. Publishing a learning packet increases the B-score by 3. Completing public metadata increases the K-score by 1. Voting “yes” (e.g., “this was helpful”) on a learning packet for the first time increases the author's D-score by 0.1, the user's B-score by 0.1 and the K-score by 0.1. Voting “no” (e.g., “this was not helpful”) on a packet decreases the author's D-score by 0.1, but increases the user's B-score by 0.1 and the K-score by 0.1. Voting “yes” on an answer for the first time, increases the author's H-score by 0.1, increases the user's B-score by 0.1. Voting “no” on an answer for the first time, decreases the author's H-score by 0.1, but increases the user's B-score by 0.1. If a user selects one or more reasons that reinforce a “no” vote (as discussed in more detail below), the author's D-score is decreased by 0.1. If a user selects one or more reasons that negate a “no” vote, the author's D-score is increased by 0.1. If a user selects any reason for providing a “yes” or a “no” vote, the user's B-score is increased by 0.1 and the K-score is increased by 0.2. Selecting a best answer increases the authors H-score by 1. Sharing a learning packet with a third-party listener or forwarding information about a learning packet in an e-mail, causes the user's G-score to increase by 1. When an invited user achieves a reputation score of 20 for the first time, the user that invited that user is awarded an increase to the G-score of 1. When a question, answer, or other discourse is removed for abuse (e.g., a violation of the terms of service), the author's F-score is decreased by 1, and the reporting user's score is increased by 1. When a learning packet is removed for abuse, the author's F-score is decreased by 5, and the reporting user's F-score is increased by 1. When a user is disabled for abuse (such as for violating the terms of service), the reporting user's F-score is increased by 1. When a user follows a learning packet for the first time, the author's D-score is increased by 0.1. Other score events can be used in other embodiments, and different score transactions (and values of score transactions) can be used in other embodiments.

Some embodiments perform further processing on the scores, such as the following. A gravity function can be applied to the scores to accelerate normalized reputation dimension scores early to move them more rapidly toward 50, and then slow the progress, requiring the user to do more work to advance the score further. The gravity function returns a multiplier that ranges from a constant M to a value 1/M, exponentially. M is a system wide constant, initially set to a value, such as 5, in which case the multiplier ranges from 5 to ⅕.

The gravity function takes one parameter, S_{N}, which is the normalized reputation dimension score. S_{N} ranges from 0 to 100. An example of the gravity function is as follows:

G(S_{N})=M^{(50-S}^{_{N}}^{)/50}

For example, if a user has a normalized D-score of 30, and the learning system needs to add a raw increment of 0.1 with gravity, the gravity multiplier is computed based on the normalized D-score of 30, resulting in a multiplier of 5̂0.4=1.9. The multiplier is applied to the raw increment of 0.1, resulting in 0.19.

If the normalized score was 60, and the base increment was 0.1, then the gravity multiplier is 5̂−0.2=0.72, when applying to the raw score increment results in an increment of 0.072, thus slowing the score increase.

Some embodiments include a decay function. The decay function can be applied to decrease a benefit to a user over a period of time. When the decay function is applied, the benefit to the user fades away to zero over a decay period. The decay is specified for certain scoring events where the desired affect is to initially reward the user, then slowly reduce the benefit to the user.

The decay frequency is how often the learning system computes decay. This is an arbitrary value initially set to 1 day. The decay period is the time that passes before the benefit drops to zero. Decay period is initially set to 30 days. Decay is applied to the actual increment that was added to the component score.

If gravity was applied to the increment, then the value that decays is the value after gravity is applied.

If I is a raw score increment, and P is the decay period, and F is the decay frequency, then at every interval F the system will subtract I/P from the raw score.

For example, if 10 is added to a raw score and decay is applied, and given a decay period of 20 weeks and a decay frequency of 1 week, then the system would add 10 points to the user's score, and every week after that for 20 weeks it would subtract 10/20=0.5.

Some embodiments include a time bonus multiplier function, in which the user receives an additional reward for a fast response. For example, if a user provides an answer to a question, the author of the answer gets an extra benefit if the answer was provided soon after the question was asked.

The time bonus multiplier is a value between 1 and 2. The multiplier is applied to a raw score increment. Time bonus should only be applied when the raw score increment is positive. Time bonus is not intended to magnify a reduction when a quick answer is voted down.

There is a system-wide time bonus limit. This is the maximum time that can elapse before the time bonus multiplier causes no increase to the increment, i.e., the multiplier goes to 1. Initially, the system will set the time bonus limit to 24 hours.

If h is the elapsed time in hours since a question was asked, and m is the time bonus limit, the time bonus multiplier can be given by:

$$T ( h ) = \{ \begin{matrix}if h < m , 1 + \frac{m - h}{h} \\ if h \geq m , 1\end{matrix}$$

For example, if the elapsed time between when a question was asked and the answer provided was 6 hours, and the answer is selected as best at some point later, then the multiplier is 1 plus (24−6)/24=1.75.

Some embodiments include a Delta R function. For example, in some embodiments, some of the score increments can be expressed as Δr/20. The system should calculate Δr by computing the difference between the object's rank after the vote is cast and the rank before the vote is cast. The difference is multiplied by 100.

For example, if the rank of a question is 0.40 before a yes vote is cast and 0.45 after the vote, then Δr equals 0.05. Therefore Δr/20 is 0.05×100/20=0.25.

Note that Delta R can be negative when a no vote lowers an object's rank.

In some embodiments, score events can be flagged as tainted. For example, if a learning packet, question, or user is removed from the system for abuse, the score events associated with the abuse can be flagged as being tainted. In some embodiments a tainted score can be manually reviewed and adjusted by an administrator. In another embodiment, all or a portion of the score transactions associated with a tainted score event are automatically reversed. A portion can be reversed, for example, by adjusting only 50% of the score transaction values, or a different portion of the value.

In view of the foregoing, the raw score can be adjusted using the following formulas. If a scoring transaction includes gravity, the raw score is computed as follows, where S_{R} is the raw score, S_{N} is the normalized score, and i is the base raw score adjustment:

S_{R}=S_{R}+iG(S_{N})

If a scoring transaction includes gravity and a time bonus, the raw score is computed as follows, where T(e) is the time bonus multiplier, and e is the elapsed time:

S_{R}=S_{R}+iG(S_{N})T(e)

If the scoring transaction includes decay, a number of scoring transactions (equal to the decay period divided by the decay frequency) must be created, with a value equal to the increment amount, divided by the decay frequency, multiplied by negative one.

As discussed in more detail herein, such as with reference to FIG. 20, additional information within the learning system can be associated with a score. One specific example is that an answer provided to a question can be given an answer rank. In some embodiments, the answer rank is a value between zero and one, and is computed using an answer rank formula. The answer rank formula includes two inputs, including n, which represents the sum of the yes vote total (e.g., “this was helpful”, or alternatively “the answer is correct,” “I like it,” or “thumbs up”) and the no vote total (e.g., “this was not helpful,” or alternatively, “the answer is incorrect,” “I do not like this answer,” or “thumbs down”), and p, which is the proportion of yes votes (yes votes divided by total votes).

In some embodiments a constant X is added to the yes vote count and a constant Y is added to the no vote count before computing the answer rank. For example, X=13, and Y=9. Other embodiments use other constants. These initial values set the answer rank of a new answer to about 0.5.

A constant z is also used, which may be set to, for example, 0.83 (which is the normal distribution given a confidence 0.95). Rank is then computed using the Wilson lower bound interval according to the following answer rank formula:

$$Rank ( p , n ) = \frac{p + \frac{{z}^{2}}{2 n} - z \sqrt{\frac{p ( 1 - p ) + {z}^{2} / 4 n}{n}}}{1 + \frac{{z}^{2}}{n}}$$

In some embodiments, the answer rank is used to determine an answer sort order, and the answers are then displayed according to this order. For example, the answer that has the highest answer rank is listed first, followed by the answer with the next highest answer rank, etc. However, in some embodiments the author is permitted to select the best answer. In this case, if the author has selected the best answer, that answer is displayed first, regardless of the answer rank, followed by the answer with the highest answer rank.

Questions can be similarly scored with a question rank, in the same manner as the answer rank discussed above. Questions can also be sorted according to the question rank. In some embodiments, a question having no answers is displayed differently than a question having an answer, to permit a user to easily visually determine whether a question has been answered. For example, a different font or background can be used to display the question, or other display differences can be used. When a question is provided as a search result, the sort order can be based on a combination of a search relevance score (e.g., based on how closely the words in the question match the search terms) and the question rank.

In some embodiments, learning packets are also assigned a learning packet rank. As an example embodiment, the packet rank is also computed using the Wilson lower bound formula, discussed above. The initial values can be different than those of the question or answer ranks, however, if desired. For example, the initial constant (X) for yes votes is 10 and the initial constant (Y) for no votes is 30, resulting in a new packet ranking of about 0.2.

The overall packet score is, in some embodiments, the packet rank multiplied by 10, and rounded down to the nearest tenth, such that the packet score ranges from 0 to 100. Other embodiments include other scoring functions.

FIG. 48 is a screen shot of an example portion 4800 of a learning packet page, illustrating an alternative learning packet rating feature. The example portion 4800 includes a learning packet score display 4802, learning packet title display 4804, and rating display region 4806. In this example, the rating display region 4806 includes a recommendation rating 4808 and an academic rating 4810.

In some embodiments, the learning packet page includes a portion, such as at the top of the page, which includes the learning packet score display 4802. The learning packet score display 4802 displays the packet rank that is currently recorded for the learning packet.

The title of the learning packet is displayed by learning packet title display 4804, which identifies the topic of the learning packet content. Additional information can also be included in the portion of the learning packet, as shown.

The rating display region 4806 displays rating information to the user to permit the user to see what other users that have previously reviewed the learning packet have thought about it. In this example, rating display region 4806 includes multiple rating displays, including a recommendation rating display 4808 and an academic rating display 4810.

The recommendation rating is, for example, based on inputs provided from any user that has viewed the learning packet and has provided feedback. For example, if the current user wanted to provide feedback, the user could move the mouse over recommendation rating display 4808, at which time the recommendation rating display 4808 becomes an input control. The user can then select a feedback rating to give to the learning packet, such as 3.5 stars, on a scale from 1 to 5 stars, with 1 being poor and 5 being excellent. Other rating scales and rating displays are used in other embodiments. The average feedback rating of all users that have provided feedback for the learning packet is displayed in recommendation rating display 4808, and the user's particular rating can be displayed in text adjacent to the recommendation rating display 4808 (e.g., “You rated this 3.5”). Therefore, the recommendation rating display 4808 provides an indication of what the average user of the learning system 100 has thought of the learning packet.

The academic rating is, for example, the average academic score that has been given to the learning packet by a subset of the users of the system, where the subset is less than all of the users. For example, in one embodiment the subset of users includes all users that have obtained a threshold score or rating themselves. In another embodiment, the subset includes users who have been selected as official reviewers of learning packets. In another embodiment, the subset includes users who have certain academic credentials. The academic rating gives an indication of what a more trusted, or select, group of users thought about the learning packet. In addition, in some embodiments a user is asked a different question when providing an academic rating, than when providing a recommendation rating. For example, the question for an academic rating may be to rate the accuracy of the content, or the effectiveness of the content at achieving the objective stated in the title display 4804. In contrast, the question for a recommendation rating may be to rate the overall impression of the learning packet, including whether it was entertaining, enjoyable, aesthetic, recommended, etc.

When viewed together, the recommendation rating and the academic rating provide the user with a more complete impression of the learning packet. The recommendation rating and academic rating can also be used by the learning system 100 for other purposes, such as to provide more relevant search results, or for sorting lists of learning packets. When providing search results, the ratings can be combined with a relevance score, which indicates how closely the learning packet matches search terms or other search criteria.

FIG. 49 is a screen shot of an example recommendation details window 4900, which receives further details from the user about the user's impression of the learning packet. Recommendation details window 4900 includes a plurality of rating component controls. In this example, the recommendation details window 4900 includes four rating component controls, including a first component control (“Learning Value”) 4902, a second component control (“Legibility” or “Organization”) 4904, a third component control (“Presentation”) 4906, and a fourth component control (“Engagement”) 4908.

In some embodiments the rating component controls initially display the average rating provided by other users, and can also show the total number of users that have provided a rating for that rating component. When the user moves the pointer over the rating component control, and then selects a location within the component rating control, the control receives the input from the user and records the user's feedback for the rating component. The various rating components can then be used by the learning system 100 for various purposes, such as to provide relevant search results, adjust the sort order in a search, and also to provide feedback to the author to enable the author to learn from the user's feedback. In some embodiments, specific phrases are displayed when the pointer is hovered over a rating component control to guide the user to provide a specific type of input. For example, each star of the Engagement rating component control 4908 is associated with a different phrase ranging from “It was boring” to “Exciting!”

The recommendation details window 4900 can be displayed, for example, after a user has provided a recommendation rating as discussed with reference to FIG. 48, or upon the user's indication that the user wants to provide detailed feedback, such as by selecting a control displayed on the learning packet.

Some embodiments described herein include learning packets, content, discourse, or other information that is related to an academic topic. An example of an academic topic is a topic taught in a traditional academic environment. Another example of an academic topic is a topic that is listed in a taxonomy of academic terms, such as the Classification of Instructional Programs (e.g. the third revision published in 2000), or Bloom's Taxonomy originally published by Benjamin Bloom with subsequent revisions, variations, and addenda by various authors, such as A Taxonomy for Learning, Teaching, and Assessing: A Revision of Bloom's Taxonomy of Educational Objectives by D. R. Krathwohl and L. W. Anderson (2001). In some embodiments, academic topics are related to or subsets of a topic that is listed in a taxonomy of academic terms. For example, a topic of “how to factor a polynomial” is related to, or a subset of, the topic of mathematics. Some embodiments also, or alternatively, include information that relates to non-academic topics.

In the foregoing description, reference is made to particular user interface displays generated by a server and displayed on a client computing device, such as through a browser software program. The user interfaces are provided as just one example of the many possible embodiments of such user interfaces, and embodiments including minor changes to such user interfaces are intended to be within the scope of this disclosure. As one example, the present disclosure makes reference to various web page controls, such as buttons, fields, selectable controls, check boxes, tabs, menus, and the like. Other embodiments can be made by selecting alternative web page controls. As another example, the present disclosure makes reference to various types of web page displays, such as windows, pages, lines, and the like. Other embodiments can be made by selecting alternative web page displays.

The various embodiments described above are provided by way of illustration only and should not be construed to limit the claims attached hereto. Those skilled in the art will readily recognize various modifications and changes that may be made without following the example embodiments and applications illustrated and described herein, and without departing from the true spirit and scope of the following claims.

What is claimed is:

1. A teaching and learning system comprising:
a data store encoding data therein; and
a server computing device programmed to retrieve digital data from the data store and to generate and transfer digital data across a network to user computing devices associated with users, wherein the digital data is configured to be interpreted by the user computing devices to display to the users an interactive web site, the web site including a plurality of learning packets, each learning packet being authored by one or more of the users and including:
a title including a text description of a topic, the topic being associated with an academic topic; and
multiple content sections, each content section including at least one content window and each content window including content having a content type, the content type being selected by the author of the learning packet from a plurality of different available content types, wherein the content of each content section includes information to teach the user about the topic identified in the title.

2. The teaching and learning system of claim 1, the learning packet further comprising at least one discourse window configured to receive input from users, including users other than the author, and to display the input in the discourse window of the learning packet.

3. The teaching and learning system of claim 2, wherein the discourse window is included in each content section, providing a location for discourse between users about the content contained in the content section.

4. The teaching and learning system of claim 2, wherein the discourse window is configured to provide a live tutoring session between two users.

5. The teaching and learning system of claim 1, wherein the plurality of different available content types includes at least video, audio, text, and image content types.

6. The teaching and learning system of claim 1, wherein each learning packet further comprises a rating display, a rating shown in the rating display being based at least in part upon feedback provided by users, other than the author.

7. The teaching and learning system of claim 6, wherein the rating display includes a recommendation rating and an academic rating, the recommendation rating being based at least in part on feedback provided by any user, other than the author, and the academic rating being based at least in part on feedback provided by a subset of the users that have provided feedback.

8. The teaching and learning system of claim 6, wherein each learning packet includes a plurality of rating component scores, each of the rating component scores being based on feedback provided by users directed to different aspects of the learning packet.

9. The teaching and learning system of claim 1, wherein the server maintains a reputation score for each user, the reputation score being stored in the data store.

10. The teaching and learning system of claim 9, wherein the reputation score is the sum of a plurality of reputation component scores that are each directed to a different aspect of activity within the teaching and learning system, each reputation dimension score being an integer based on a normalized raw reputation component score.

11. The teaching and learning system of claim 9, wherein the server applies a gravity function and a decay function to generate the reputation score.

12. The teaching and learning system of claim 1, wherein the learning packet is associated with an academic course.

13. The teaching and learning system of claim 1, wherein the server maintains a list of users of a group in the data store, and wherein the server limits access to a set of learning packets associated with the group to those users that are included on the list of users, such that users that are not in the list of users cannot access the learning packets.

14. The teaching and learning system of claim 13, wherein the web site further includes a group page, the group page including at least information about learning packets, and a discourse window to permit users of the group to communicate with each other through the group page.

15. The teaching and learning system of claim 14, wherein the server permits a user to request that a learning packet be imported into a group upon payment of a fee.

16. The teaching and learning system of claim 1, wherein the server manages collections of learning packets and stores collection data in the data store, the collections of data packets being arranged in a predefined order.

17. The teaching and learning system of claim 16, wherein the collection is associated with a course.

18. A method of providing information to a third party educational system, the method comprising:
storing units of information in computer readable storage media with a computing device, each unit of information being associated with academic topics;
associating at least some of the units of information with a course at an educational institution;
receiving a request from a third party educational system, the request identifying the course; and
sending data with the computing device, the data identifying at least some of the units of information that are associated with the course to the third party educational system for display of the data within the third party educational system.

19. The method of claim 18, wherein the unit of information is a learning packet, and wherein the data comprises a summary of at least some of the learning packets associated with the course.

20. The method of claim 19, wherein associating at least some of the units of information with a course further comprises associating at least some of the units of information with a portion of a course, and wherein receiving a request identifying the portion of the course.

21. A method of alerting a user of a teaching and learning system to the occurrence of an event, the teaching and learning system including information relating to a plurality of academic topics to educate consumers on the academic topics, the method comprising:
generating and storing a subscription list for the user in computer readable storage media with a computing device, the subscription list including a plurality of items, each item identifying at least one of: a learning packet, a portion of a learning packet, and another user of the teaching and learning system; and
upon occurrence of an event within the teaching and learning system, sending a notification with the computing device, the notification including information describing the event and including a link to at least one of the learning packet and a user profile.

22. The method of claim 21, wherein sending the notification further comprising sending the notification to a third-party event listener across a network.

23. The method of claim 21, wherein sending the notification further comprises: adding the notification to an event feed associated with the user.

24. The method of claim 21, wherein the occurrence of the event is selected from the group consisting of: a publication of the learning packet, an update of a content element of the learning packet, an addition of one or more discourse elements in the learning packet, an award of a user achievement, a posting of a comment in the user profile, and a change in a point value.

25. The method of claim 21, wherein sending a notification comprises sending a notification to a mobile computing device.
